(19) United States
(12) Patent Application Publication
(10) Pub. No.: US 2025/0108566 A1
(43) Pub. Date: Apr. 3, 2025

(54) STITCHING IN THREE-DIMENSIONAL PRINTING

(71) Applicant: Velo3D, Inc., Fremont, CA (US)

(72) Inventors: William David Chemelewski, San Jose, CA (US); Carl Christopher Borgstrom, Lakewood, CO (US); Hoa Xuan Nguyen, San Jose, CA (US); Benyamin Buller, Cupertino, CA (US)

(73) Assignee: Velo3D, Inc., Fremont, CA (US)

(21) Appl. No.: 18/899,792

(22) Filed: Sep. 27, 2024

Related U.S. Application Data
(60) Provisional application No. 63/541,418, filed on Sep. 29, 2023.

(51) Int. Cl. B29C 64/393; B29C 64/153; B33Y 10/00; B33Y 30/00; B33Y 40/20

(52) U.S. Cl. CPC B29C 64/393; B29C 64/153; B33Y 10/00; B33Y 30/00; B33Y 40/20

(57) ABSTRACT

The present disclosure provides three-dimensional (3D) printing systems, devices, apparatuses, methods, and non-transitory computer readable media for 3D printing comprising closures of 3D object portions that are vertically directly unsupported during their printing.

### CROSS-REFERENCE TO RELATED PATENT APPLICATIONS

This application is a U.S. Non-provisional Patent application claiming priority to, and the benefit of, U.S. Provisional Patent Application No. 63/541,418, filed on Sep. 29, 2023, the disclosure of which is incorporated herein by reference in its entirety for all purposes.

### BACKGROUND

Three-dimensional (3D) printing (e.g., additive manufacturing) is a process for making a three-dimensional object of any shape from a design. The design may be in the form of a data source such as an electronic data source or maybe in the form of a hard copy. The hard copy may be a two-dimensional representation of a 3D object. The data source may be an electronic 3D model. 3D printing may be accomplished through an additive process in which successive layers of material are laid down one on top of another. This process may be controlled (e.g., computer controlled, manually controlled, or both). A 3D printer can be an industrial robot.

3D printing can generate custom parts. A variety of materials can be used in a 3D printing process including elemental metal, metal alloy, ceramic, an allotrope of elemental carbon, or polymeric material. In some 3D printing processes (e.g., additive manufacturing), a first layer of hardened material is formed (e.g., by welding powder), and thereafter successive layers of hardened material are added one by one, wherein each new layer of hardened material is added on a pre-formed layer of hardened material, until the entire designed three-dimensional structure (3D object) is layer-wise materialized.

3D models may be created with a computer aided design package, via 3D scanner, or manually. The manual modeling process of preparing geometric data for 3D computer graphics may be similar to plastic arts, such as sculpting or animating. 3D scanning is a process of analyzing and collecting digital data on the shape and appearance of a real object (e.g., real-life object). Based at least in part on this data, 3D models of the scanned object can be produced.

A number of 3D printing processes are currently available. They may differ in the manner layers are deposited to create the materialized 3D structure (e.g., hardened 3D structure). They may vary in the material or materials that are used to materialize the designed 3D object. Some methods melt, sinter, or soften material to produce the layers that form the 3D object. Examples for 3D printing methods include selective laser melting (SLM), selective laser sintering (SLS), direct metal laser sintering (DMLS) or fused deposition modeling (FDM). Other methods cure liquid materials using different technologies such as stereo lithography (SLA). In the method of laminated object manufacturing (LOM), thin layers (made inter a/ia of paper, polymer, or metal) are cut to shape and joined together.

At times, the 3D object comprises a cavity. The cavity can be an open cavity or a closed cavity. The cavity may comprise a hanging structure supported at one or more distant sides, the hanging structure comprising a portion that is vertically (directly) unsupported. For example, the cavity may comprise a bridge, a dome, a cone, a pyramid, or a ledge. The cavity may comprise a hanging structure that (e.g., during the printing) is supported at its distant side(s). For example, the cavity may comprise a bridge, a dome, a cone, or a pyramid. At times, the 3D object may require printing of a portion that should not and/or cannot be vertically (e.g., directly) unsupported, e.g., since: (a) such auxiliary supports (if generated) may be enclosed in a closed cavity and if created-will be unremovable, or (b) it may be difficult to remove such auxiliary supports (if generated) without damaging the printed portion. At times, the 3D object may require printing of the portion that is vertically (e.g., directly) unsupported, e.g., for the aforementioned reasons. The 3D object portion may be printed layerwise. As the printing process prints the closure of the cavity, each successive layer may comprise a larger layer portion devoid of (direct) vertical support. Such print may cause instability of the melt pools generated, e.g., causing them to deform such as to ball. Such defect formation may cause the 3D object to be dysfunctional according to its intended purpose and/or be noncompliant with its specifications.

At times, the 3D object comprises a hanging structure. The hanging structure may be comprised in a ledge, or a cavity. The cavity, e.g., a hollow structure. The cavity can be an open cavity or a closed cavity. The hanging structure may be directly vertically unsupported during the printing, e.g., unsupported by auxiliary supports. The hanging structure may be generated by successive layer deposition generating 3D object portions that successively approach each other horizontally and are intended to horizontally merge during the 3D printing, to generate the requested hanging structure. At times, such horizontal approach entails printing an extended layer portion that is directly vertically unsupported. Such printing efforts may cause generation of large meltpools. The large meltpools may become unstable and/or ball. Without wishing to be bound to theory, such instability and/or balling may be caused due at least in part to various surface tension effects. The melt pool instability (MPI) may cause a deviation from the specification (e.g., structural and/or material) of the requested 3D object. The MPI may cause the defects such as the balling. It may be advantageous to, during the printing, circumvent generation of MPIs, or cure such MPI generation, e.g., to print the requested 3D object that is usable for its intended purpose, e.g., according to specification.

### SUMMARY OF THE INVENTION

In some aspects, the present disclosure resolves the aforementioned hardships.

In some aspects, the 3D object is printed using various printing methodologies. The printing methodologies may comprise a methodology aimed at curing and/or preventing formation of MPIs. The printing methodology can be aimed at horizontal coupling of 3D printed portions that are horizontally separated by a gap. The printing methodology may be a stitching methodology, e.g., using a stitch coupling such as a stitch closure. The Stritch coupling may comprise generation of a stitch in a direction, the stitch comprising elongated melt pools that vary (e.g., alter) in their directionality along the direction of the stitch.

In another aspect, an apparatus for three-dimensional (3D) printing of a 3D object, the apparatus comprises: at least one controller configured to: (A) operatively couple to a transforming agent; and (B) direct the transforming agent to execute stitch coupling to couple portions of the 3D object as part of the 3D printing, the stitch coupling being a 3D printing methodology, the at least one controller being configured to direct the transforming agent to propagate along a path to transform a first material to a second material, the path alternatingly contacting each of at least two of the portions, the first material comprising (a) a starting material for the 3D printing or (b) sections of the portions of a 3D object, the portions being printed during the 3D printing by at least one other methodology different from the stitch coupling. In some embodiments, the second material includes (i) a melt pool type different from at least one other melt pool type generated respectively by the at least one other methodology, (ii) a microstructure type different from at least one other microstructure type generated respectively by the at least one other methodology, or (iii) any combination of (i) and (ii). In some embodiments, the sections are disposed at a target surface, or are covered by a later of the starting material beneath the target surface, the target surface being a target of the transforming agent. In some embodiments, the at least one controller is configured to facilitate deposition of the starting material on the target surface at least in part by layerwise deposition. In some embodiments, the at least one controller is configured to direct deposition of the starting material comprising powder material. In some embodiments, the at least one controller is configured to direct deposition of the starting material comprising elemental metal, metal alloy, ceramic, or an allotrope of carbon. In some embodiments, the at least one controller is configured to direct deposition of the starting material comprising a polymer or a resin. In some embodiments, the at least one controller is configured to direct the 3D printing that takes place under a positive pressure atmosphere relative to an ambient pressure of an ambient atmosphere external to an enclosure in which the 3D printing is conducted. In some embodiments, the at least one controller is configured to direct the 3D printing under an atmosphere depleted of a reactive agent relative to its concentration in an ambient atmosphere external to an enclosure in which the 3D printing takes place, the reactive agent being configured to react at least during the printing with (i) the starting material and/or (ii) a byproduct of the 3D printing. In some embodiments, the reactive agent comprises oxygen, water, or hydrogen sulfide. In some embodiments, the at least one controller is configured to facilitate printing the 3D object in an atmosphere maintained to be different from an ambient atmosphere external to an enclosure in which the 3D object is printed, difference being by at least one characteristic, the ambient atmosphere being external to the enclosure. In some embodiments, the 3D printing comprises arc welding. In some embodiments, arc welding is at least in part by an arc welder, the arc welding comprises: generating a powder stream and focusing an energy beam at the powder stream, the energy beam being the transforming agent. In some embodiments, the at least one controller being configured to operatively coupled with the arc welder. In some embodiments, the at least one controller is configured to direct the 3D printing comprising connecting particulate matter to facilitate printing the 3D object. In some embodiments, at least a portion of the particulate matter is disposed in a material bed during the three-dimensional printing. In some embodiments, the particulate matter comprises a super alloy. In some embodiments, the super alloy comprises Inconel (e.g., In718, In-625), M300, Ti64, F357, Haynes282, GRCop-42, C22, CA6NM, or Hastelloy-X. In some embodiments, the 3D printing comprises a fusing process. In some embodiments, the fusing process comprises (i) sintering, (ii) melting, (iii) smelting, or (iv) any combination of (i)-(iii). In some embodiments, (a) at least two of the sections stitched by the stitch coupling are horizontally disconnected from each other by a gap and/or (b) at least two of the portions stitched by the stitch coupling are horizontally disconnected from each other by a gap. In some embodiments, at least two of the sections stitched by the stitch coupling comprise melt pool deformations cured by the stitch coupling. In some embodiments, the melt pool deformations comprise a non-requested melt pool that is an enlarged melt pool. In some embodiments, the stitch coupling comprises reducing (e.g., alleviating and/or curing) one or more material defects in the sections and/or in the portions. In some embodiments, the stitch coupling comprises reducing (e.g., measurably eliminating) a porosity level in the sections. In some embodiments, the path propagates along a direction, the path having two sides that alternatingly contact each of the at least two of the portions, and where each side of the path is disposed on a different portion of two of the portions, the side of the path being normal to the direction of propagation of the path. In some embodiments, the alternating path comprises a zigzag path or a sinusoidal path. In some embodiments, the path comprises a zigzag path or a sinusoidal path. In some embodiments, the zigzag comprises a one point zigzag stitch. In some embodiments, the path alternatingly contacts each portion of a pair of the portions. In some embodiments, the portions were previously printed by the 3D printing comprising fusing the starting material. In some embodiments, wherein fusing comprises melting or sintering. In some embodiments, the starting material is disposed in a material bed during the 3D printing. In some embodiments, the material bed has a weight of at least about 1000 kilograms. In some embodiments, the material bed generated above a build platform comprising at least one fundamental length scale having a value of at least about 300 mm, 350 mm, 400 mm, 600 mm, 1000 mm, 1200, 1500, or 1750 mm. In some embodiments, the at least one controller is operatively coupled with the build platform and is configured to direct the build platform to vertical translate with an error in vertical positioning of the vertical translation at most about 10%, 5%, or 2% of the vertical translation of the build platform. In some embodiments, the portions were printed in the material bed as part of the 3D printing of the 3D object. In some embodiments, the starting material comprises powder. In some embodiments, the starting material comprises an elemental metal, a metal alloy, a ceramic, an allotrope of elemental metal, a polymer, or a resin. In some embodiments, the starting material comprises an elemental metal, a metal alloy, a ceramic, or an allotrope of elemental metal. In some embodiments, the starting material comprises an elemental metal, or a metal alloy. In some embodiments, the at least one controller is configured to direct the transforming agent to execute a stitch coupling methodology at least in part by directing (a) an energy source to generate the transforming agent comprising an energy beam and/or (b) a scanner to direct the energy beam to a target surface and translate long the path at the target surface. In some embodiments, the energy beam comprises a laser beam or an electron beam. In some embodiments, the target surface is an exposed surface of a material bed. In some embodiments, the portions are disposed in the material bed such that they are devoid of direct vertical auxiliary support. In some embodiments, the portions are anchored to a build plate at respective positions that are horizontally distant from the stitch. In some embodiments, horizontally distant is by a horizontal distance of at least about 1 millimeter (mm), 2 mm, 5 mm, or 10 mm. In some embodiments, the portions are printed layerwise, the layers having an average layering plane; and where at least one of the portions and/or at least one of the sections, comprises a bottom skin forming an angle of at most about 30 degrees, 20 degrees, 10 degrees or 5 degrees relative to the average layering plane. In some embodiments, the portions are printed layerwise, the layers having an average layering plane; and where at least one of the portions and/or at least one of the sections, comprises a bottom skin, and where a normal at a point at the bottom skin pointing into the 3D object forms an angle of at least about 60 degrees, 70 degrees, 80 degrees or 85 degrees relative to the average layering plane. In some embodiments, the portions are separate from each other by a gap bridged by the stitch coupling printing methodology. In some embodiments, a horizontal distance of the gap is at least about 0.1 millimeter (mm), 0.5 mm, 1 mm, 1.5 mm, or 2 mm. In some embodiments, a horizontal distance of the gap is at most about 5 millimeter (mm), 3 mm, 2 mm or 1 mm. In some embodiments, the second material has a porosity of at most about five percent, two percent, one percent, or half a percent, the percentage being volume per volume. In some embodiments, the second material has a density of at least about 95 percent (%), 98%, 99%, or 99.5%, the percentage being volume per volume. In some embodiments, as part of the stitch coupling, the at least one controller is configured to direct transforming the first material along to the second material, the first material disposed in the at least two of the portions printed by at least one 3D printing methodology comprising (a) a bulk core printing methodology, (b) a shallow core printing methodology, (c) a liquid phase manipulation (LPM) printing methodology, (d) a high aspect ratio melt pool (HARMP) printing methodology, or (e) a rim printing methodology. In some embodiments, as part of the stitch coupling, the at least one controller is configured to direct the transforming agent to propagate along the path using a propagation scheme similar to that of (a) a bulk core printing methodology, (b) a shallow core printing methodology, (c) a high aspect ratio melt pool (HARMP) printing methodology, or (d) a rim printing methodology. In some embodiments, as part of the stitch coupling, the at least one controller is configured to direct the transforming agent to propagate along the path using a propagation scheme different from tiling. In some embodiments, as part of the stitch coupling, the at least one controller is configured to direct the transforming agent to propagate along the path using a hatching propagation scheme. In some embodiments, as part of the stitch coupling, the at least one controller is configured to direct the transforming agent to propagate along the path using a propagation scheme similar to that of the liquid phase manipulation (LPM) printing methodology. In some embodiments, the propagation scheme of the LPM comprises tiling. In some embodiments, as part of the stitch coupling, the at least one controller is configured to direct the transforming agent to propagate along the path using a propagation scheme similar to that of (a) a bulk core printing methodology, (b) a shallow core printing methodology, (c) a high aspect ratio melt pool (HARMP) printing methodology, and/or (d) a rim printing methodology. In some embodiments, as part of the stitch coupling, the at least one controller is configured to direct the transforming agent to propagate along the path at a speed slower than during (a) the bulk core printing methodology, (b) the shallow core printing methodology, and/or (c) the rim printing methodology. In some embodiments, as part of the stitch coupling, the at least one controller is configured to direct the transforming agent to propagate along the path at a speed similar to or faster than (i.e., at least as) during (a) the liquid phase manipulation (LPM) printing methodology, (b) the high aspect ratio melt pool (HARMP) printing methodology, and/or (c) the rim printing methodology. In some embodiments, as part of the stitch coupling, the at least one controller is configured to direct the transforming agent to propagate along the path, the transforming agent being an energy beam generated by an energy source having a power lower than that used during (a) the bulk core printing methodology, (b) the shallow core printing methodology, (c) the high aspect ratio melt pool (HARMP) printing methodology, (d) the liquid phase manipulation (LPM) printing methodology and/or (e) the rim printing methodology. In some embodiments, as part of the stitch coupling, the at least one controller is configured to direct the transforming agent to propagate along the path, the transforming agent being an energy beam generated by an energy source having a power similar to or higher than (i.e., at least as) that used during the liquid phase manipulation (LPM) printing methodology. In some embodiments, as part of the stitch coupling, the at least one controller is configured to direct the transforming agent to propagate along the path, the transforming agent being an energy beam having a cross section larger than that used during (a) the bulk core printing methodology, (b) the shallow core printing methodology, (c) the high aspect ratio melt pool (HARMP) printing methodology, and/or (c) the rim printing methodology. In some embodiments, the apparatus herein as part of the stitch coupling, the at least one controller is configured to direct the transforming agent to propagate along the path, the transforming agent being an energy beam having a cross section of similar to or smaller than (i.e., at most as) that used during (a) the liquid phase manipulation (LPM) printing methodology and/or (b) the high aspect ratio melt pool (HARMP) printing methodology. In some embodiments, at least one of the portions as part of the stitch coupling, the at least one controller is configured to direct transforming the first material along to the second material, the first material disposed in the at least two of the portions printed by at least one 3D printing methodology comprising (a) a liquid phase manipulation (LPM) printing methodology, or (b) a high aspect ratio melt pool (HARMP) printing methodology. In some embodiments, at least one of the portions as part of the stitch coupling, the at least one controller is configured to direct transforming the first material along to the second material, the first material disposed in the at least two of the portions printed by at least one 3D printing methodology comprising (a) a liquid phase manipulation (LPM) printing methodology, or (b) a high aspect ratio melt pool (HARMP) printing methodology. In some embodiments, at least one of the portions as part of the stitch coupling, the at least one controller is configured to direct transforming the first material along to the second material, the first material disposed in the at least two of the portions printed by at least one 3D printing methodology comprising (a) a liquid phase manipulation (LPM) printing methodology, and (b) a high aspect ratio melt pool (HARMP) printing methodology. In some embodiments, at least one of the portions was printed by at least one 3D printing methodology comprising (a) a liquid phase manipulation (LPM) printing methodology, or (b) a high aspect ratio melt pool (HARMP) printing methodology. In some embodiments, at least one of the portions was printed by at least one 3D printing methodology comprising a liquid phase manipulation (LPM) printing methodology. In some embodiments, as part of the stitch coupling, the at least one controller is configured to direct transforming a first material along the path to the second material, the first material comprising a starting material for the 3D printing. In some embodiments, as part of the stitch coupling, the at least one controller is configured to direct deposition of the starting material for the 3D printing. In some embodiments, the 3D object is supported by a build platform during the printing, and where as part of the stitch coupling, the at least one controller is configured to direct deposition of the starting material for the 3D printing while keeping a previous vertical position of the build platform, the previous vertical position being (a) before initiation of the stitch coupling and/or (b) a vertical position of the platform the printing of the portions completed. In some embodiments, as part of the stitch coupling, the at least one controller is configured to direct deposition of the starting material for the 3D printing at least in part by using a layer dispensing mechanism. In some embodiments, as part of the stitch coupling, the at least one controller is configured to direct transforming a first material along the path to the second material, the first material comprising (a) a starting material for the 3D printing and (b) the portions of a 3D object. In some embodiments, the at least one controller is configured to direct the execution of the stitch coupling to generate the second material comprising the melt pool type that is different from any other melt pool type generated by the at least one other methodology. In some embodiments, the at least one controller is configured to direct the execution of the stitch coupling to generate the second material comprising the melt pool type being larger in at least one fundamental length scale (FLS) than the at least one other melt pool type generated respectively by the at least one other methodology. In some embodiments, the at least one controller is configured to direct the execution of the stitch coupling to generate the second material comprising the melt pool type being larger in the at least one fundamental length scale (FLS) comprising a length or a height. In some embodiments, the at least one controller is configured to direct the execution of the stitch coupling to generate the second material comprising the melt pool type being larger in vertical cross sectional area than the at least one other melt pool type generated respectively by the at least one other methodology. In some embodiments, the at least one controller is configured to direct the execution of the stitch coupling to generate the second material comprising the melt pool type being larger in volume than the at least one other melt pool type generated respectively by the at least one other methodology. In some embodiments, the at least one controller is configured to direct the execution of the stitch coupling to generate the second material comprising the melt pool type vertically spanning more than one layer, or spanning two or more layers, of the 3D object (e.g., of previously generated melt pools). In some embodiments, the at least one controller is configured to direct the execution of the stitch coupling to generate the second material comprising the melt pool type vertically spanning two or more layers of the 3D object, the first two layers of the two or more layers having different melt pool types different from the melt pool type generated by the stitch coupling. In some embodiments, the at least one controller is configured to direct the execution of the stitch coupling to generate the second material comprising the melt pool type vertically spanning more than one layer, or spanning two or more layers, of the 3D object (e.g., of previously generated melt pools). In some embodiments, the at least one controller is configured to direct the execution of the stitch coupling to generate the second material comprising the microstructure type that is different from any other microstructure type generated by the at least one other methodology. In some embodiments, the at least one controller is configured to direct the execution of the stitch coupling to generate the second material comprising the microstructure type being larger in at least one fundamental length scale (FLS) than the at least one other microstructure type generated respectively by the at least one other methodology. In some embodiments, the at least one controller is configured to direct the execution of the stitch coupling to generate the second material comprising the microstructure type indicative of slower microstructure growth as compared to the at least one other microstructure type. In some embodiments, the microstructure comprises metallurgical microstructure. In some embodiments, the microstructure comprises a single crystal. In some embodiments, the microstructure comprises a dendrite. In some embodiments, the at least one controller is configured to direct the execution of the stitch coupling to generate the second material comprising the microstructure type being larger in volume than the at least one other microstructure type generated respectively by the at least one other methodology. In some embodiments, the at least one controller is configured to direct the execution of the stitch coupling to generate the second material comprising (i) the melt pool type different from at least one other melt pool type generated respectively by the at least one other methodology, and (ii) a microstructure type different from at least one other microstructure type generated respectively by the at least one other methodology. In some embodiments, the at least one controller being configured to operatively couple to a power source. In some embodiments, the at least one controller being configured to operatively couple to a power source at least in part by (I) having a power socket and/or (II) being configured for wireless power transfer using inductive charging. In some embodiments, the at least one controller is included in, or comprises, a hierarchical control system. In some embodiments, the hierarchical control system comprises at least three hierarchical control levels. In some embodiments, the at least one controller is configured to direct operation of at least one other component of the 3D printer at least in part for participation of the other component in the 3D printing. In some embodiments, the at least one controller is a plurality of controllers, and where at least two of (A) and (B) are directed by, or are executed by, different controllers of the plurality of controllers. In some embodiments, the apparatus further configured to facilitate the 3D printing at least in part by being configured to control deposition of the starting material on a target surface. In some embodiments, the at least one controller is configured to operatively couple to a remover, and direct the remover to remove a second portion of the deposited the starting material to generate a planar layer of the starting material as part of a material bed. In some embodiments, the remover is operatively coupled with an attractive force source sufficient to attract the pre-transformed material from the target surface. In some embodiments, the attractive force comprises a magnetic, electric, electrostatic, or vacuum source. In some embodiments, the attractive force comprises a vacuum source. In some embodiments, the at least one controller is configured to operatively couple with a recycling system, and to direct the recycling system to: (i) recycle at least a fraction of a portion of the starting material removed by the remover and/or (ii) provide at least a portion of the starting material utilized by the dispenser in subsequent deposition. In some embodiments, the portion removed by the remover is at least about 70%, 50% or 30% of the deposited pre-transformed material. In some embodiments, the fraction recycled is at least about 70% or 90% of the portion removed by the remover. In some embodiments, the at least one controller is operatively coupled with at least about 900 sensors, or 1000 sensors, operatively coupled with the three-dimensional printer. In some embodiments, at least during the 3D printing, the at least one controller is configured to control a pressure in an enclosure to be above ambient pressure external to the enclosure in which the 3D printing takes place. In some embodiments, the at least one controller is configured to control an internal atmosphere of an enclosure to be depleted of at least one reactive agent relative to its concentration in an ambient atmosphere external to the device, the reactive agent being configured to react at least during the printing with (i) a starting material of the three-dimensional objects and/or (ii) a byproduct of the printing, the 3D printing being conducted in the enclosure. In some embodiments, the byproduct of the printing comprises soot, spatter, or splatter. In some embodiments, during the printing, the at least one controller is configured to direct gas flow away from one or more optical windows and in a direction towards a build platform supporting the 3D object during the printing, the one or more optical windows being disposed at a ceiling of an enclosure in which the 3D printing takes place. In some embodiments, the at least one controller is controllers, and where at least two of (A) and (B) are directed by, or are executed by, a same controller of the controllers.

In another aspect, non-transitory computer readable program instructions that, when executed by one or more processors operatively coupled with the apparatus of any of the above apparatus causes the one or more processors to execute one or more operations associated with the apparatus comprising directing the apparatus to print the 3D object at least in part by using the stitch coupling. In an example, non-transitory computer readable program instructions that, when executed by one or more processors operatively coupled with a transforming agent, causes the one or more processors to execute operations comprises: directing the transforming agent to execute stitch coupling to couple portions of the 3D object as part of the 3D printing at least in part by directing the transforming agent to propagate along a path to transform a first material to a second material as part of the stitch coupling, the stitch coupling being a 3D printing methodology, the path alternatingly contacting each of at least two of the portions, the first material comprising (a) a starting material for the 3D printing or (b) sections of the portions of a 3D object, the portions being printed during the 3D printing by at least one other methodology different from the stitch coupling. In some embodiments, the second material includes (i) a melt pool type different from at least one other melt pool type generated respectively by the at least one other methodology, (ii) a microstructure type different from at least one other microstructure type generated respectively by the at least one other methodology, or (iii) any combination of (i) and (ii). In some embodiments, the non-transitory computer readable program instructions where the one or more processors are included in, or comprise, a hierarchical control system. In some embodiments, the non-transitory computer readable program instructions where the hierarchical control system comprises at least three hierarchical control levels. In some embodiments, the non-transitory computer readable program instructions where the apparatus is a component of a 3D printing system, and where the one or more processors are operatively coupled with an other component of the 3D printing system and where the one or more operations comprise directing the other component. In some embodiments, the non-transitory computer readable program instructions where directing the other component is for participation of the other component in the 3D printing. In some embodiments, the non-transitory computer readable program instructions where the program instructions are inscribed in one or more non-transitory media, or in one or more data carriers. In some embodiments, the non-transitory computer readable program instructions where the program instructions are included in one or more computer products. In some embodiments, the non-transitory computer readable program instructions where the one or more operations are operations, where the one or more processors are processors, and where at least two of the operations are executed, or are directed, by different processors. In some embodiments, the non-transitory computer readable program instructions where the one or more processors are processors, and where the one or more operations is operations, and where at least two of the operations are executed, or are directed, by the same processor of the one or more processors.

In another aspect, a method of 3D printing of a 3D object, the method comprises: (I) providing the apparatus of any of the above apparatuses; and (11) performing one or more operations associated with the apparatus comprising using the apparatus to print the 3D object at least in part by using the stitch coupling. In an example, a method of 3D printing of a 3D object, the method comprises: (a) providing a transforming agent, portions of a 3D object and optionally a stating material; and (b) using the transforming agent to execute stitch coupling to couple the portions of the 3D object at least in part by directing the transforming agent to propagate along a path to transform a first material to a second material, the stitch coupling being a 3D printing methodology, the path alternatingly contacting each of at least two of the portions, the first material comprising (a) the starting material for the 3D printing or (b) sections of the portions of a 3D object, the portions being printed during the 3D printing by at least one other methodology different from the stitch coupling. In some embodiments, the second material includes (i) a melt pool type different from at least one other melt pool type generated respectively by the at least one other methodology, (ii) a microstructure type different from at least one other microstructure type generated respectively by the at least one other methodology, or (iii) any combination of (i) and (ii). In an example, a method of 3D printing of a 3D object, the method comprises: (A) providing a transforming agent and at least one controller operatively coupled with the transforming agent, and (B) using the at least one controller to direct the transforming agent to execute stitch coupling to couple portions of the 3D object as part of the 3D printing, the stitch coupling being a 3D printing methodology, the at least one controller directing the transforming agent to propagate along a path to transform a first material to a second material, the path alternatingly contacting each of at least two of the portions, the first material comprising (a) a starting material for the 3D printing or (b) sections of the portions of a 3D object, the portions being printed during the 3D printing by at least one other methodology different from the stitch coupling. In some embodiments, the second material includes (i) a melt pool type different from at least one other melt pool type generated respectively by the at least one other methodology, (ii) a microstructure type different from at least one other microstructure type generated respectively by the at least one other methodology, or (iii) any combination of (i) and (ii).

In another aspect, a system for 3D printing of a 3D object, the system comprises: the apparatus of any of the above apparatuses; and an energy source configured to irradiate an energy beam, the transforming agent comprising the energy beam. In an example, a system for 3D printing of a 3D object, the system comprises: a transforming agent; and at least one controller configured to: (A) operatively couple to a transforming agent, and (B) direct the transforming agent to execute stitch coupling to couple portions of the 3D object as part of the 3D printing, the stitch coupling being a 3D printing methodology, the at least one controller being configured to direct the transforming agent to propagate along a path to transform a first material to a second material, the path alternatingly contacting each of at least two of the portions, the first material comprising (a) a starting material for the 3D printing or (b) sections of the portions of a 3D object, the portions being printed during the 3D printing by at least one other methodology different from the stitch coupling. In some embodiments, the second material includes (i) a melt pool type different from at least one other melt pool type generated respectively by the at least one other methodology, (ii) a microstructure type different from at least one other microstructure type generated respectively by the at least one other methodology, or (iii) any combination of (i) and (ii). In some embodiments, the system further comprises a scanner configured to translate the energy beam along the target surface, where the device is operatively coupled with the scanner. In some embodiments, the system further comprises at least one device configured to participate in the 3D printing, the device being different from the apparatus, the at least one controller being configured to (i) be operatively coupled with the device and (ii) direct one or more operations associated with the device.

In another aspect, a 3D object generated by 3D printing, the 3D object comprises: one or more material characteristics indicative of being printed by the apparatus of any of the above apparatuses; the one or more material characteristics comprising (i) a melt pool type different from at least one other melt pool type generated respectively by the at least one other methodology, or (ii) a microstructure type different from at least one other microstructure type generated respectively by the at least one other methodology. In an example, a 3D object generated by 3D printing, the 3D object comprises: one or more material characteristics of stitch coupling that couple portions of the 3D object, the stitch coupling being a 3D printing methodology, the one or more material characteristics of stitch coupling comprising transformed material that transformed a first material to a second material, the first material comprising (a) a starting material for the 3D printing or (b) sections of the portions of a 3D object, the portions being printed during the 3D printing by at least one other methodology different from the stitch coupling, the second material comprising (i) a melt pool type different from at least one other melt pool type generated respectively by the at least one other methodology, or (ii) a microstructure type different from at least one other microstructure type generated respectively by the at least one other methodology.

In another aspect, a system for effectuating the methods, operations of an apparatus, and/or operations inscribed by non-transitory computer readable program instructions (e.g., inscribed on a media/medium), disclosed herein.

In another aspect, a system for effectuating the methods, operations of an apparatus, operation of a device, and/or operations inscribed by non-transitory computer readable program instructions (e.g., inscribed on a media/medium), disclosed herein.

In another aspect, device(s) (e.g., apparatus) for effectuating the methods, operations of an apparatus, and/or operations inscribed by non-transitory computer readable program instructions (e.g., inscribed on a media/medium).

In other aspects, systems, apparatuses (e.g., controller(s)), and/or non-transitory computer-readable program instructions (e.g., software) that implement any of the methods disclosed herein. In some embodiments, the program instructions is inscribed on at least one medium (e.g., on a medium or on media).

In other aspects, methods, systems, apparatuses (e.g., controller(s)), and/or non-transitory computer-readable program instructions (e.g., software) that implement any of the devices disclosed herein and/or any operation of these devices. In some embodiments, the program instructions is inscribed on at least one medium (e.g., on a medium or on media).

In another aspect, an apparatus (e.g., for printing one or more 3D objects) comprises at least one controller that is configured (e.g., programmed) to direct a mechanism used in a 3D printing methodology to implement (e.g., effectuate) any of the method and/or operations disclosed herein, wherein the controller(s) is operatively coupled with the mechanism. In some embodiments, the controller(s) implements any of the methods and/or operations disclosed herein. In some embodiments, the at least one controller comprises, or is operatively coupled with, a hierarchical control system. In some embodiments, the hierarchical control system comprises at least three, four, or five, control levels. In some embodiments, at least two operations are performed, or directed, by the same controller. In some embodiments, at least two operations are each performed, or directed, by a different controller.

In another aspect, an apparatus (e.g., for printing one or more 3D objects) comprises at least one controller that is configured (e.g., programmed) to implement (e.g., effectuate), or direct implementation of, the method, process, and/or operation disclosed herein. In some embodiments, the at least one controller implements any of the methods, processes, and/or operations disclosed herein.

In another aspect, non-transitory computer readable program instructions (e.g., for printing one or more 3D objects), when read by one or more processors, are configured to execute, or direct execution of, the method, process, and/or operation disclosed herein. In some embodiments, the at least one controller implements any of the methods, processes, and/or operations disclosed herein. In some embodiments, at least a portion of the one or more processors is part of a 3D printer, outside of the 3D printer, or in a location remote from the 3D printer (e.g., in the cloud).

In another aspect, a system for printing one or more 3D objects comprises an apparatus (e.g., used in a 3D printing methodology) and at least one controller that is configured (e.g., programmed) to direct operation of the apparatus, wherein the at least one controller is operatively coupled with the apparatus. In some embodiments, the apparatus includes any apparatus or device disclosed herein. In some embodiments, the at least one controller implements, or direct implementation of, any of the methods disclosed herein. In some embodiments, the at least one controller directs any apparatus (or component thereof) disclosed herein.

In some embodiments, at least two of operations (e.g., instructions) of the apparatus are directed by the same controller. In some embodiments, at least two of operations (e.g., instructions) of the apparatus are directed by different controllers.

In some embodiments, at least two operations (e.g., instructions) are conducted by the same processor and/or by the same sub-computer software product. In some embodiments, at least two of operations (e.g., instructions) are conducted by different processors and/or by different sub-computer software products.

In another aspect, a computer software product, comprising a (e.g., non-transitory) computer-readable medium/media in which program instructions are stored, which instructions, when read by a computer, cause the computer to direct a mechanism used in the 3D printing process to implement (e.g., effectuate) any of the method disclosed herein, wherein the non-transitory computer-readable medium is operatively coupled with the mechanism. In some embodiments, the mechanism comprises an apparatus or an apparatus component.

In another aspect, a computer system comprising one or more computer processors and non-transitory computer-readable medium/media coupled thereto. In some embodiments, the non-transitory computer-readable medium/media comprises machine-executable code that, upon execution by the one or more computer processors, implements any of the methods and/or operations (e.g., as disclosed herein), and/or effectuates directions of the controller(s) (e.g., as disclosed herein).

In another aspect, a method for three-dimensional printing, the method comprises executing one or more operations associated with at least one configuration of the device(s) disclosed herein.

In another aspect, an apparatus for three-dimensional printing, the apparatus comprising at least one controller is configured (i) operatively couple to the device, and (ii) direct executing one or more operations associated with at least one configuration of the device(s) disclosed herein.

In another aspect, at least one controller is associated with the methods, devices, and software disclosed herein. In some embodiments, the at least one controller comprise at least one connector configured to connect to a power source. In some embodiments, the at least one controller being configured to operatively couple to a power source at least in part by (I) having a power socket and/or (II) being configured for wireless power transfer using inductive charging. In some embodiments, the at least one controller is included in, or comprises, a hierarchical control system. In some embodiments, the hierarchical control system comprises at least three hierarchical control levels. In some embodiments, the at least one controller is included in a control system configured to control a three-dimensional printer that prints the one or more three-dimensional objects. In some embodiments, the at least one controller is configured to control at least one other component of a 3D printing system. In some embodiments, the device disclosed herein is a component of a three-dimensional printing system, and wherein the at least one controller is configured to (i) operatively couple to another component of the three-dimensional printing system and (ii) direct operation of the other component. In some embodiments, the at least one controller is configured to direct operation of the other component at least in part for participation of the other component in three-dimensional printing. In some embodiments, the at least one controller is operatively coupled with at least about 900 sensors, or 1000 sensors operatively couple to the three-dimensional printer. In some embodiments, the at least one controller is configured to control a pressure in the three-dimensional printer to be above ambient pressure external to the three-dimensional printer. In some embodiments, the at least one controller is configured to control an internal atmosphere of the three-dimensional printer to be depleted of a reactive agent relative to its concentration in an ambient atmosphere external to the device, the reactive agent being configured to react with a starting material of the three-dimensional printing at least during the three-dimensional printing.

In another aspect, non-transitory computer readable program instructions for three-dimensional printing, the non-transitory computer readable program instructions, when read by one or more processors operatively couped to the device, cause the one or more processors to direct executing one or more operations associated with at least one configuration of the device(s) disclosed herein.

In some embodiments, the program instructions are of a computer product.

In another aspect, a system for three-dimensional printing, the system comprising: the any of the devices above; and an energy beam configured to irradiate powder material (e.g., a planar layer of powder material) to print at least a portion of at least one three-dimensional object at least in part by using three-dimensional printing. In some embodiments, the system further comprising a scanner configured to translate the energy beam along a target surface, wherein the device is operatively coupled with the scanner disposed in an optical system enclosure. In some embodiments, the system further comprises an energy source configured to generate the energy beam, wherein the device is operatively coupled with the energy source. In some embodiments, the energy source comprises a laser source or an electron beam source. In some embodiments, the system further comprises at least one controller that (i) is operatively coupled with the device and (ii) direct one or more operations associated with the device. In some embodiments, the system is configured to operatively couple to at least one controller configured to (i) operatively couple to the system and (ii) direct one or more operations associated with the system.

The various embodiments in any of the above aspects are combinable (e.g., within an aspect), as appropriate.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the present disclosure are set forth with particularity in the appended claims. A better understanding of the features and advantages of the present disclosure will be obtained by reference to the following detailed description that sets forth illustrative embodiments, in which the principles of the present disclosure are utilized, and the accompanying drawings or figures (also “FIG.” and “FIGS.” herein), of which:

FIG. 1 schematically illustrates a front view of components of a three-dimensional (3D) printing system, and a path;

FIG. 2 schematically illustrates a front view of components of a 3D printing system;

FIG. 3 schematically illustrates a perspective view of components of a 3D printing system;

FIG. 4 schematically illustrates various views of components of a 3D printing system;

FIG. 5 schematically illustrates various components of a 3D printing system;

FIG. 6 schematically illustrates an optical setup; an energy beam; and control system;

FIG. 7 schematically illustrates a processing (e.g., computer) system;

FIG. 8 schematically illustrates a vertical cross section of a 3D object; an example of a 3D plane; and a vertical cross section in portion of a 3D object;

FIG. 9 schematically shows perspective views of 3D objects; and a cross section of various layering planes;

FIG. 10 schematically illustrates various vertical cross-sectional views of various 3D objects and overhang portions of 3D objects;

FIG. 11 schematically illustrates various paths;

FIG. 12 show schematic top views of various 3D objects and sections thereof;

FIG. 13 schematically illustrate cross section views of irradiated portions of various 3D objects, and top views of various irradiated portions of a target surface;

FIG. 14 schematically illustrate operations in printing a 3D object;

FIG. 15 schematically illustrate a vertical cross section in portion of a 3D object

FIG. 16 schematically illustrate top views of various 3D objects in material beds;

FIG. 17 schematically illustrate vertical cross sections in various 3D objects;

FIG. 18 schematically illustrates various views of a 3D object;

FIG. 19 schematically illustrates a perspective view of a 3D object and beam paths;

FIG. 20 schematically illustrates a frontal view of a 3D object and a photograph of its section;

FIG. 21 schematically illustrates a frontal view of a 3D object and a photograph of its section;

FIG. 22 schematically illustrate operations in printing a 3D object;

FIG. 23 shows a vertical cross sectional view of a 3D object with a support member; and a horizontal view of a 3D object; and

FIG. 24 illustrates a block diagram of a printing methodology.

The figures and components therein may not be drawn to scale. Various components of the figures described herein may not be drawn to scale.

### DETAILED DESCRIPTION

While various embodiments of the invention have been shown, and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein might be employed. The various embodiments disclosed herein are combinable, as appropriate.

Terms such as “a,” “an” and “the” are not intended to refer to only a singular entity but include the general class of which a specific example may be used for illustration. The terminology herein is used to describe specific embodiments in the present disclosure, but their usage does not delimit to the specific embodiments of the present disclosure. The term “includes” means includes but not limited to, the term “including” means including but not limited to, and the term “based on” means based at least in part on.

When ranges are mentioned, the ranges are meant to be inclusive, unless otherwise specified. For example, a range between value 1 and value 2 is meant to be inclusive and include value 1 and value 2. The inclusive range will span any value from about value 1 to about value 2. The term “adjacent” or “adjacent to,” as used herein, includes “next to,” “adjoining,” “in contact with,” and “in proximity to.” When ranges are mentioned (e.g., between, at least, at most, and the like) the endpoint(s) of the range is/are also claimed. For example, when the range is from X to Y, the values of X and Y are also claimed. For example, when the range is at most Z, the value of Z is also claimed. For example, when the range is at least W, the value of W is also claimed.

The conjunction “and/or” as used herein in “X and/or Y”-including in the specification and claims—is meant to include the options (i) X, (ii) Y, and (iii) X and Y, as applicable. The conjunction of “and/or” in the phrase “including X, Y, and/or Z” is meant to include any combination and any plurality thereof, as applicable. For example, it is meant to include the following: (1) a single X, (2) a single Y, (3) a single Z, (4) a single X and a single Y, (5) a single X and a single Z, (6) a single Y and a single Z, (7) a single X, a single Y, and a single Z, (8) a plurality of X, (9) a plurality of Y, (10) a plurality of Z, (11) a plurality of X and a single Y, (12) a plurality of X, a single Y and a single Z, (13) a plurality of X and a single Z, (14) a plurality of Y and a single X, (15) a plurality of Y, a single X, and a single Z, (16) a plurality of Y and a single Z, (17) a plurality of Z and a single X, (18) a plurality of Z, a single X, and a single Y (19) a plurality of Z and a single Y, (20) a plurality X and a plurality Y, (21) a plurality X and a plurality Z, (22) a plurality Y and a plurality Z, and (23) a plurality X, a plurality Y, and a plurality Z. The phrase “including X, Y, and/or Z” is meant to have the same meaning as the phrase “comprising X, Y, or Z.”

The term “operatively coupled” or “operatively connected” refers to a first mechanism that is coupled (or connected) to a second mechanism to allow the intended operation of the second and/or first mechanism. The coupling may comprise physical or non-physical coupling. The non-physical coupling may comprise signal induced coupling (e.g., wireless coupling).

The phrase “is/are structured” or “is/are configured,” when modifying an article, refers to a structure of the article that is able to bring about the referred result.

Fundamental length scale (abbreviated herein as “FLS”) comprises any suitable scale (e.g., dimension) of an object. For example, an FLS of an object may comprise a length, a width, a height, a diameter, a spherical equivalent diameter, a diameter of a bounding circle, a diameter of a bounding sphere, a radius, a spherical equivalent radius, or a radius of a bounding circle, or a radius of a bounding sphere.

A central tendency as understood herein comprises mean, median, or mode. The mean may comprise a geometric mean.

“Real time” as understood herein may be during at least part of the printing of a 3D object. Real time may be during a print operation. Real time may be during a print cycle. Real time may comprise: during formation of (i) a 3D object, (ii) a layer of hardened material as part of the 3D object, (iii) a hatch line, or (iv) a melt pool.

Performing a reversible first operation is understood herein to mean performing the first operation and being capable of performing the opposite of that first operation, e.g., which is a second operation. For example, when a controller directs the operation of reversibly opening a shutter, that shutter can also close, and the controller can optionally direct a closure of that shutter. For example, when a layer dispensing mechanism (e.g., recoater) reversibly translates in a first direction, that layer dispensing mechanism (e.g., recoater) can also translate in a second direction opposite to the first direction. For example, when a controller directs reversibly translating a recoater in a first direction, that recoater can translate in the first direction and can also translate in a second direction opposite to the first direction, e.g., when the controller directs the recoater to translate in the second direction.

Where suitable, one or more of the features shown in a figure comprising a 3D printer and/or components thereof can be combined with one or more of the various features of other 3D printers and/or components thereof described herein. A figure shown herein may not show certain features of a 3D printer and/or components thereof described herein. It should be understood that any such features can be incorporated within the 3D printer as requested and where suitable.

Any of the apparatuses and/or their components disclosed herein may be built by a material disclosed herein. The apparatuses and/or their components comprise a transparent or non-transparent (e.g., opaque) material. For example, the apparatuses and/or their components may comprise an organic or an inorganic material. For example, the apparatuses and/or their components may comprise an elemental metal, metal alloy, ceramic, or an allotrope of elemental carbon. For example, the manufacturing enclosure, platform, recycling system, or any of their components may comprise an elemental metal, metal alloy, ceramic, or an allotrope of elemental carbon.

The present disclosure provides three-dimensional (3D) printing apparatuses, systems, software, and methods for forming a 3D object. For example, a 3D object may be formed by sequential addition of material or joining of starting material (e.g., pre-transformed material or source material) to form a structure in a controlled manner (e.g., under manual or automated control).

Transformed material, as understood herein, is a material that underwent a physical change. The physical change can comprise a phase change. The physical change can comprise fusing (e.g., melting or sintering), connecting, or bonding (e.g., physical, or chemical bond). The physical change can be a phase transformation such as from a solid to a partially liquid, or to a liquid phase.

The 3D printing process may comprise printing one or more layers of hardened material in a building cycle, e.g., in a printing cycle. A building cycle (e.g., printing cycle), as understood herein, comprises printing the (e.g., hardened, or solid) material layers of a print job (e.g., all, or substantially all, the layers of a printing job), which may comprise printing one or more 3D objects above a platform (e.g., in a single material bed). The one or more 3D object(s) may or may not be physically anchored to the platform (e.g., a build platform) above which it/they are printed.

Pre-transformed material (also referred to herein as “starting material”), as understood herein, is a material before it has been transformed (e.g., once transformed) by an energy beam during an upcoming 3D printing process, e.g., it is a starting material for an upcoming 3D printing process. The pre-transformed material may be a material that was, or was not, transformed prior to its use in the upcoming 3D printing process. The pre-transformed material may be a material that was partially transformed prior to its use in the upcoming 3D printing process. The pre-transformed material may be a starting material for the upcoming 3D printing process. The pre-transformed material may be liquid, solid, or semi-solid (e.g., gel). The pre-transformed material may be a particulate material. For example, the particulate material may be a powder material. The powder material may comprise solid particles of material(s). The particulate material may comprise vesicles (e.g., containing liquid or semi-solid material). The particulate material may comprise solid or semi-solid material particles. The pre-transformed material may be in the form of a powder, wires, sheets, or droplets. The pre-transformed material may be pulverous. The pre-transformed material may have been introduced during a 3D printer process prior to the upcoming 3D printing process, and is left as a remainder material. For example, in a first 3D printing process (having a first build cycle), powder material was used to form a 3D object. A remainder of the powder material of the first 3D printing process may become a pre-transformed material for an upcoming second 3D printing process (having a second build cycle). Thus, even though the remainder powder of the first 3D printing process may comprise transformed material (e.g., bits of sintered powder), it is considered a pre-transformed material relative to the second 3D printing process. The remainder can be filtered and otherwise recycled for use as a pre-transformed material in the second 3D printing process.

In some embodiments, in a 3D printing process, the deposited pre-transformed material may be fused (e.g., sintered or melted), bound, or otherwise connected to form at least a portion of the requested 3D object. Fusing, binding, or otherwise connecting the material is collectively referred to herein as “transforming” the material. Fusing the material may refer to melting, smelting, or sintering a pre-transformed material.

In some embodiments, melting may comprise liquefying the material (i.e., transforming to a liquefied state). A liquefied state refers to a state in which at least a portion of a transformed material is in a liquid state. Melting may comprise liquidizing the material (i.e., transforming to a liquidus state). A liquidus state refers to a state in which an entire transformed material is in a liquid state. The apparatuses, methods, software, and/or systems provided herein are not limited to the generation of a single 3D object but may be utilized to generate one or more 3D objects simultaneously (e.g., in parallel) or separately (e.g., sequentially). The plurality of 3D objects may be formed in one or more material beds (e.g., powder bed). In some embodiments, a plurality of 3D objects is formed in one material bed.

At times, the printing of a (e.g., complex) 3D object involves using a combination of methodologies (e.g., having respective process parameters). In some cases, different methodologies may be used to transform different portions of the object. In some examples, 3D printing methodologies comprise extrusion, wire, granular, laminated, light polymerization, or powder bed and inkjet head 3D printing. Extrusion 3D printing can comprise robe-casting, fused deposition modeling (FDM) or fused filament fabrication (FFF). Wire 3D printing can comprise electron beam freeform fabrication (EBF3). Granular 3D printing can comprise direct metal laser sintering (DMLS), arc welding (e.g., powder based arc welding), electron beam melting (EBM), selective laser melting (SLM), selective heat sintering (SHS), or selective laser sintering (SLS). Powder bed and inkjet head 3D printing can comprise plaster-based 3D printing (PP).

Laminated 3D printing can comprise laminated object manufacturing (LOM). Light polymerized 3D printing can comprise stereo-lithography (SLA), digital light processing (OLP), or laminated object manufacturing (LOM). 3D printing methodologies can comprise Direct Material Deposition (DMD). The Direct Material Deposition may comprise Laser Metal Deposition (LMD, also known as Laser deposition welding). 3D printing methodologies can comprise powder feed, or wire deposition. Various apparatuses (e.g., controllers), systems (e.g., 3D printers), software, methods related to types of energy beam and formation of 3D objects, as well as various control schemes are described in U.S. patent application Ser. No. 15/435,128; International Patent Application number PCT/US17/18191; European Patent Application number EP17156707.6; and International Patent Application number PCT/US18/20406, each of which is entirely incorporated herein by reference.

In some examples, 3D printing methodologies differ from methods traditionally used in semiconductor device fabrication (e.g., vapor deposition, etching, annealing, masking, or molecular beam epitaxy). In some instances, 3D printing may further comprise one or more printing methodologies that are traditionally used in semiconductor device fabrication. 3D printing methodologies can differ from vapor deposition methods such as chemical vapor deposition, physical vapor deposition, or electrochemical deposition. In some instances, 3D printing may further include vapor deposition methods.

In an aspect provided herein is a system for generating a 3D object comprising: a manufacturing enclosure for accommodating at least one planar layer of pre-transformed material (e.g., powder); at least one energy (e.g., energy beam) capable of transforming the pre-transformed material to form a transformed material; and at least one controller (e.g., as part of a control system) that directs the energy beam(s) to impinge on the exposed surface of the layer of pre-transformed material and translate along a path (e.g., as described herein). The transformed material may be capable of hardening to form at least a portion of a 3D object. The system may comprise at least one energy source generating the energy beam(s), at least one optical system, a layer dispensing mechanism such as a recoater, gas source(s), pump(s), nozzle(s), valve(s), sensor(s), display(s), chamber(s), processor(s), or software inscribed on a computer readable media/medium. The control system may be configured to control attributes including temperature, pressure, gas flow, optics, actuator(s), energy source(s), energy beam(s), and/or atmosphere(s). The chamber may comprise a base (e.g., also referred to herein as “build platform,” or “build plate”) and a substrate. The substrate may comprise a piston. The system for generating at least one 3D object (e.g., in a printing cycle) and its components may be any 3D printing system. Examples of 3D printers, their components, and associated methods, software, systems, devices, and apparatuses, can be found in International Patent Application Serial No. PCT/US17/60035, filed Nov. 3, 2017; and in International Patent Application Serial No. PCT/US22/16550, filed Feb. 26, 2022; each of which is entirely incorporated herein by reference.

In some embodiments, the deposited pre-transformed material within the manufacturing enclosure is a liquid material, semi-solid material (e.g., gel), or a solid material (e.g., powder). The deposited pre-transformed material within the manufacturing enclosure can be in the form of a powder, wires, sheets, or droplets. The material (e.g., pre-transformed, transformed, and/or hardened) may comprise elemental metal, metal alloy, ceramics, or an allotrope of elemental carbon. The allotrope of elemental carbon may comprise amorphous carbon, graphite, graphene, amorphous carbon, carbon fiber, carbon nanotube, diamond, or fullerene. The fullerene may be selected from the group consisting of a spherical, elliptical, linear, and tubular fullerene. The fullerene may comprise a buckyball, or a carbon nanotube. The ceramic material may comprise cement. The ceramic material may comprise alumina, zirconia, or carbide (e.g., silicon carbide, or tungsten carbide). The ceramic material may include high performance material (HPM). The ceramic material may include a nitride (e.g., boron nitride or aluminum nitride). The material may comprise sand, glass, or stone. In some embodiments, the material may comprise an organic material, for example, a polymer or a resin (e.g., 114 W resin). The organic material may comprise a hydrocarbon. The polymer may comprise styrene or nylon (e.g., nylon 11). The polymer may comprise a thermoplast. The organic material may comprise carbon and hydrogen atoms. The organic material may comprise carbon and oxygen atoms. The organic material may comprise carbon and nitrogen atoms. The organic material may comprise carbon and sulfur atoms. In some embodiments, the material may exclude an organic material. The material may comprise a solid or a liquid. In some embodiments, the material may comprise a silicon-based material, for example, silicon-based polymer or a resin. The material may comprise an organosilicon-based material. The material may comprise silicon and hydrogen atoms. The material may comprise silicon and carbon atoms. In some embodiments, the material may exclude a silicon-based material. The powder material may be coated by a coating (e.g., organic coating such as the organic material (e.g., plastic coating)). The material may be devoid of organic material. The liquid material may be compartmentalized into reactors, vesicles, or droplets. The compartmentalized material may be compartmentalized in one or more layers. The material may be a composite material comprising a secondary material. The secondary material can be a reinforcing material (e.g., a material that forms a fiber). The reinforcing material may comprise a carbon fiber, Kevlar®, Twaron®, ultra-high-molecular-weight polyethylene, or glass fiber. The material can comprise powder (e.g., granular material) and/or wires. The bound material can comprise chemical bonding. Transforming can comprise chemical bonding. Chemical bonding can comprise covalent bonding.

The printed 3D object can be made of a single material (e.g., single material type) or a plurality of materials (e.g., a plurality of material types). Sometimes one portion of the 3D object and/or of the material bed may comprise one material, and another portion may comprise a second material different from the first material. The material may be a single material type (e.g., a single alloy or a single elemental metal). The material may comprise one or more material types. For example, the material may comprise two alloys, an alloy and an elemental metal, an alloy and a ceramic, or an alloy and an elemental carbon. The material may comprise an alloy and alloying elements (e.g., for inoculation). The material may comprise blends of material types. The material may comprise blends with elemental metal or with metal alloy. The material may comprise blends excluding (e.g., without) elemental metal or including (e.g., with) metal alloy. The material may comprise a stainless steel. The material may comprise a titanium alloy, aluminum alloy, and/or nickel alloy.

In some cases, a layer within the 3D object comprises a single type of material. In some examples, a layer of the 3D object may comprise a single elemental metal type, or a single alloy type. In some examples, a layer within the 3D object may comprise several types of material (e.g., an elemental metal and an alloy, an alloy and a ceramic, an alloy, and an elemental carbon). In certain embodiments, each type of material comprises only a single member of that type. For example: a single member of elemental metal (e.g., iron), a single member of metal alloy (e.g., stainless steel), a single member of ceramic material (e.g., silicon carbide or tungsten carbide), or a single member of elemental carbon (e.g., graphite). In some cases, a layer of the 3D object comprises more than one type of material. In some cases, a layer of the 3D object comprises more than one member of a type of material.

In some examples, the material bed, and/or 3D printing system (or any component thereof such as a build platform) may comprise any material disclosed herein. The material may comprise a material type which constituents (e.g., atoms) readily lose their outer shell electrons, resulting in a free-flowing cloud of electrons within their otherwise solid arrangement. The material bed may comprise a particulate material (e.g., powder). In some examples the material (e.g., powder, and/or 3D printer component) may comprise a material characterized in having high electrical conductivity (e.g., at least about 1*105 Siemens per meter (S/m)), low electrical resistivity (e.g., at most about 1*10-5 ohm times meter (O*m)), high thermal conductivity (e.g., at least about 10 Watts per meter times Kelvin (W/mK)), or high density (e.g., at least about 1.5 grams per cubic centimeter (g/cm3)). The density can be measured at ambient temperature (e.g., at R.T., or 20° C.) and at ambient atmospheric pressure (e.g., at 1 atmosphere). In some embodiments, the elemental metal is an alkali metal, an alkaline earth metal, a transition metal, a rare-earth element metal, a precious metal, or another elemental metal. The elemental metal may comprise Titanium, Copper, Platinum, Gold, Aluminum, or Silver.

In some embodiments, the metal alloy comprises iron-based alloy, nickel-based alloy, cobalt-based alloy, chrome-based alloy, cobalt chrome-based alloy, titanium-based alloy, magnesium-based alloy, or copper-based alloy. The alloy may comprise an oxidation or corrosion resistant alloy. The alloy may comprise a super alloy (e.g., Inconel, In718, Ti64, F357, Haynes282, GRCop-42, C22, CA6NM, Hastelloy-X). The alloy may comprise an alloy used for aerospace applications, automotive applications, surgical applications, or implant applications. The metal may include a metal used for aerospace applications, automotive applications, surgical applications, or implant applications.

In some embodiments, the metal alloys are refractory alloys. The refractory metals and alloys may be used for heat coils, heat exchangers, furnace components, or welding electrodes. The refractory alloys may comprise a high melting points, low coefficient of expansion, high mechanical strength, low vapor pressure at elevated temperatures, high thermal conductivity, or high electrical conductivity.

In some embodiments, the material (e.g., alloy or elemental) comprises a material used for applications in industries comprising aerospace (e.g., aerospace super alloys), jet engine, missile, automotive, marine, locomotive, satellite, defense, oil & gas, energy generation, semiconductor, fashion, construction, agriculture, printing, or medical. The material may comprise an alloy used for products comprising, devices, medical devices (human & veterinary), machinery, cell phones, semiconductor equipment, generators, engines, pistons, electronics (e.g., circuits), electronic equipment, agriculture equipment, motor, gear, transmission, communication equipment, computing equipment (e.g., laptop, cell phone, tablet), air conditioning, generators, furniture, musical equipment, art, jewelry, cooking equipment, or sport gear. The material may comprise an alloy used for products for human or veterinary applications comprising implants, or prosthetics. The metal alloy may comprise an alloy used for applications in the fields comprising human or veterinary surgery, implants (e.g., dental), or prosthetics.

In some embodiments, the alloy includes a high-performance alloy. The alloy may include an alloy exhibiting at least one of excellent mechanical strength, resistance to thermal creep deformation, good surface stability, resistance to corrosion, and resistance to oxidation. The alloy may include a face-centered cubic austenitic crystal structure. The alloy can be a single crystal alloy. Examples of materials, 3D printers, and associated methods, software, systems, devices, materials (e.g., alloys), and apparatuses, can be found in International Patent Application Serial No. PCT/US17/60035, filed Nov. 3, 2017; and in International Patent Application Serial No. PCT/US22/16550, filed Feb. 26, 2022; each of which is entirely incorporated herein by reference.

In some embodiments, the material comprises powder material (also referred to herein as a “pulverous material”). The powder material may comprise a solid comprising fine particles. The powder may be a granular material. The powder can be composed of individual particles. At least some of the particles can be spherical, oval, prismatic, cubic, or irregularly shaped. At least some of the particles can have a fundamental length scale (e.g., diameter, spherical equivalent diameter, length, width, depth, or diameter of a bounding sphere). The central tendency of the fundamental length scale (abbreviated herein as “FLS”) of the particles can be from about 5 micrometers (μm) to about 100 μm, from about 10 μm to about 70 μm, or from about 50 μm to about 100 μm. The particles can have central tendency of the FLS of at most about 75 μm, 65 μm, 50 μm, 30 μm, 25 μm or less. The particles can have a central tendency of the FLS of at least 10 μm, 25 μm, 30 μm, 50 μm, 70 μm, or more. A central tendency of the distribution of an FLS of the particles (e.g., range of an FLS of the particles between largest particles and smallest particles) can be about at least about 5 μm, 10 μm, 20 μm, 30 μm, 40 μm, 53 μm, 60 μm, or 75 μm. The particles can have a central tendency of the FLS of at most about 65 μm. In some cases, the powder particles may have central tendency of the FLS between any of the afore-mentioned FLSs.

In some embodiments, the powder comprises a particle mixture, which particle comprises a shape. The powder can be composed of a homogenously shaped particle mixture such that all the particles have substantially the same shape and FLS magnitude within at most about 1%, 5%, 8%, 10%, 15%, 20%, 25%, 30%, 35%, or 40% distribution of FLS.

At times, a plurality of build modules may be situated in a manufacturing enclosure comprising the processing chamber. At times, the build module may be connected to, or may comprise an autonomous guided vehicle (AGV). The AGV may have at least one of the following: a movement mechanism (e.g., wheels), positional (e.g., optical) sensor, and controller. The controller may enable self-docking (e.g., to a docking station) and/or self-driving of the AGV. The self-docking and/or self-driving may be to and from the processing chamber. The build module may reversibly engage with (e.g., couple to) the processing chamber. The engagement of the build module with the processing chamber may be controlled (e.g., by a controller). The control may be automatic and/or manual. The engagement of the build module with the processing chamber may be reversible. In some embodiments, the engagement of the build module with the processing chamber may be permanent.

In some embodiments, the pre-transformed material (e.g., starting material for the 3D printing) is deposited in a manufacturing enclosure, e.g., a build module. The build module container can contain the pre-transformed material (e.g., without spillage). Material may be placed in, or inserted to, the container. The material may be deposited in, pushed to, sucked into, or lifted to the container. The material may be layered (e.g., spread) in the manufacturing enclosure such as by using a layer dispensing mechanism. The build module container may be configured to enclosure a substrate (e.g., an elevator piston). The substrate may be situated adjacent to the bottom of the build module container. Bottom may be relative to the gravitational field along gravitational vector pointing towards gravitational center, or relative to the position of the footprint of the energy beam on the layer of pre-transformed material as part of a material bed. The build module container may comprise a platform comprising a substrate or a base (e.g., a build plate). The platform may be situated within the build module container. The base may be situated within the build module container. The base may reside adjacent to the substrate. For example, the base may (e.g., reversibly) connect to the substrate. The pre-transformed material may be layer-wise deposited adjacent to a side of the build module container, e.g., above and/or on the bottom of the build module container. The pre-transformed material may be layered adjacent to the substrate and/or adjacent to the base. Adjacent to may be above. Adjacent to may be directly above, or directly on. The substrate may have one or more seals that enclose the material in a selected area within the build module container. The one or more seals may be flexible or non-flexible. The seal may be a hermetic seal such as a gas tight seal. The one or more seals may comprise a polymer or a resin. The manufacturing enclosure, processing chamber, and/or building module container may comprise (I) a window (e.g., an optical window and/or a viewing window) or (II) an optical system. The optical window may allow the energy beam to pass through without (e.g., substantial) energetic loss. The viewing window may be any window disclosed herein. The viewing window may be a single or a double pane window. The viewing window may be an insulated glass unit (IGU). The viewing window may be configured to withstand positive pressure within the processing chamber, e.g., during printing. The positive pressure is above ambient pressure external to the build module, e.g., the ambient pressure may be about one atmosphere. During the 3D printing, a ventilator and/or gas flow may prevent debris (e.g., spatter) from accumulating on the surface of the optical window that is disposed within the manufacturing enclosure (e.g., within the processing chamber). A portion of the manufacturing enclosure that is occupied by the energy beam (e.g., during the 3D printing) can define a processing cone (e.g., a truncated processing cone). During 3D printing may comprise during the entire 3D printing. The processing cone can be the space that is occupied by a non-reflected energy beam during the (e.g., entire) 3D printing. The processing cone can be the space that is occupied by an energy beam that is directed towards the material bed during the (e.g., entire) 3D printing. During 3D printing may comprise during printing of a layer of hardened material.

In some embodiments, the 3D printer comprises a gas flow mechanism. The gas flow mechanism may be in fluidic contact with one or more enclosures of the 3D printer, e.g., the optical enclosure. For example, the gas flow mechanism may be in fluidic contact with (i) a processing chamber, (ii) a build module, (iii) an optical system enclosure, or (iv) any combination thereof. The gas flow mechanism may be in fluidic contact with a processing chamber and/or a build module. The gas flow mechanism may be in fluid communication with the optical system enclosure. At times, a gas flow assembly may be in fluid communication with the optical system Enclosure. The gas flow assembly may be configured to flow gas into and out of the optical system enclosure. The gas flow assembly may be separate from the gas flow mechanism. For example, the gas flow mechanism and the gas flow assembly may be isolated (e.g., fluidically separate) from each other. The gas flow mechanism may be configured to flow gas into and out of the processing chamber. The gas flow mechanism may or may not be included in the gas conveyance system, e.g., as disclosed herein. In an example, the gas flow mechanism and the gas conveyance system can be separate from each other. In an example, the gas flow mechanism can be included in the gas conveyance system, e.g., of the manufacturing enclosure.

In some embodiments, the 3D printer comprises a layer dispensing mechanism. The pre-transformed material may be deposited in the manufacturing enclosure by a layer dispensing mechanism (also referred to herein as a “layer dispenser,” “layer forming apparatus,” or “layer dispensing mechanism”). The layer dispensing mechanism may comprise a recoater. In some embodiments, the layer dispensing mechanism includes one or more material dispensers (also referred to herein as “dispensers” or “material dispensing mechanism”), and/or at least one powder removal mechanism (also referred to herein as material “remover” or “material remover”) to form a layer of pre-transformed material (e.g., starting material) as at least a portion of material bed, e.g., within the manufacturing enclosure. The deposited starting material may be shaped (e.g., leveled) by a shaping operation (e.g., leveling operation). Shaping the material bed may comprise altering the shape of the exposed surface of the material bed. In some embodiments, the layer dispensing mechanism includes a leveler to planarize (e.g., smooth, such as substantially planarize) an exposed surface of a material bed within the manufacturing enclosure. In some embodiments, the layer dispensing mechanism is devoid of a leveler to planarize (e.g., smooth, such as substantially planarize) an exposed surface of a material bed within the manufacturing enclosure. The leveling operation may comprise using a material removal mechanism that does not contact the exposed surface of the material bed. The material removed can comprise a pre-transformed material or debris. The layer dispensing mechanism and energy beam(s) can translate and form the 3D object adjacent to (e.g., above) the platform and/or within the material bed (e.g., as described herein), while the platform gradually (e.g., sequentially and/or stepwise) lowers its vertical position to facilitate layer-wise formation of the 3D object. The material dispensing mechanism (e.g., the dispenser) can comprise a reservoir configured to retain a volume of pre-transformed material. The volume of pre-transformed material may be equivalent to about the volume of pre-transformed material sufficient for at least one or more dispensed layers above the platform. For example, the volume of pre-transformed material may be equivalent to about the volume of starting material sufficient for at least an integer number of dispensed layers above the platform. For example, the volume of pre-transformed material retained within the reservoir can be at least about 2 cubic centimeters (cc), 15 cc, 20 cc, 50 cc, 100 cc, 250 cc, 1500 cc, 2000 cc, or 2500 cc. The material dispensing mechanism can comprise a reservoir configured to retain a volume of pre-transformed material can be between any of the afore-mentioned amounts, for example, from about 2 cc to about 2500 cc. The material dispensing mechanism can dispense material at a dispensing rate (e.g., flow rate from the material dispensing mechanism) of at least 0.2 cubic centimeters per second (cm3/sec) or (cc/sec), 0.5 cc/sec, 2 cc/sec, 2.5 cc/sec, 3.5 cc/sec, 5 cc/sec, 10 cc/sec, 30 cc/sec, 50 cc/sec, 75 cc/sec, 90 cc/sec, 100 cc/sec, 110 cc/sec, 125 cc/sec, or 150 cc/sec. The dispensing rate can be between any of the afore-mentioned dispensing rates (e.g., from about 2 cc/sec to about 150 cc/sec). The layer dispensing mechanism may include components comprising a material dispensing mechanism, material leveling mechanism, material removal mechanism, or any combination or permutation thereof. Examples of 3D printing systems, apparatuses, devices, components (e.g., material dispensing mechanisms and material removal mechanisms), controllers, software, and 3D printing processes can be found in Patent Application serial number PCT/US15/36802 filed on Jun. 19, 2015; in U.S. patent application Ser. No. 17/881,797, filed Aug. 5, 2022; or in International Patent Application serial number PCT/US16/66000 filed on Dec. 9, 2016; each of which is incorporated herein in its entirety.

In some embodiments, a layer dispensing mechanism is utilized for the 3D printing. The layer dispensing mechanism can be in a layer forming mode when dispensing the material and/or shaping the material bed. The layer dispensing mechanism can be in a parked mode when the layer dispensing mechanism is in an idle position such as a parked position. In some embodiments, the layer dispensing mechanism may reside within an ancillary chamber. The layer dispenser may be physically secluded from the processing chamber when residing in the ancillary chamber. The ancillary chamber may be connected (e.g., reversibly) to the processing chamber. The ancillary chamber may be connected (e.g., reversibly) to the build module. The ancillary chamber may convey the layer dispensing mechanism adjacent to a platform (e.g., that is disposed within the build module). The layer dispensing mechanism may be retracted into the ancillary chamber (e.g., when the layer dispensing mechanism does not perform dispensing).

Examples of 3D printing systems, apparatuses, devices, components (e.g., material dispensing mechanisms and material removal mechanisms), controllers, software, and 3D printing processes can be found in Patent Application serial number PCT/US15/36802 filed on Jun. 19, 2015; in Provisional Patent Application Ser. No. 62/317,070 filed Apr. 1, 2016; in International Patent Application serial number PCT/US16/66000 filed on Dec. 9, 2016; in International Patent Application Ser. No. 62/265,817, filed Dec. 10, 2015; or in Provisional Patent Application Ser. No. 63/357,901, filed on Jul. 1, 2022; each of which is incorporated herein in its entirety.

In some embodiments, the 3D object(s) are printed from a material bed. At least one FLS (e.g., width, depth, and/or height) of the material bed can be at least about 50 millimeters (mm), 60 mm, 70 mm, 80 mm, 90 mm, 100 mm, 200 mm, 250 mm, 280 mm, 400 mm, 500 mm, 600 mm, 800 mm, 900 mm, 1 meter (m), 2 m, or 5 m. The at least one FLS (e.g., width, depth, and/or height) of the material bed can be at most about 50 millimeters (mm), 60 mm, 70 mm, 80 mm, 90 mm, 100 mm, 200 mm, 250 mm, 280 mm, 400 mm, 500 mm, 600 mm, 800 mm, 900 mm, 1 meter (m), 2 m, or 5 m. The at least one FLS of the material bed can be between any of the afore-mentioned values (e.g., from about 50 mm to about Sm, from about 250 mm to about 500 mm, from about 280 mm to about 1 m, or from about 500 mm to about Sm). In some embodiments, an FLS of the material bed is in the direction of the gas flow. The build module may be configured to accommodate the material bed, e.g., having the at least one FLS disclosed herein. In some embodiments, the 3D printer has a capacity to complete at least 1, 2, 3, 4, or 5 printing cycles before requiring human intervention. Human intervention may be required for refilling the pre-transformed (e.g., powder) material, unloading the build modules, unpacking the 3D object, removing the debris byproduct of the 3D printing, or any combination thereof. The 3D printer operator may condition the 3D printer at any time during operation of the 3D printing system (e.g., during the 3D printing process). Conditioning of the 3D printer may comprise refilling the pre-transformed material that is used by the 3D printer, replacing gas source, or replacing filters. The conditioning may be with or without interrupting the 3D printing system. For example, refilling and unloading from the 3D printer can be done at any time during the 3D printing process without interrupting the 3D printing process. Conditioning may comprise refreshing the 3D printer.

In some examples, the 3D printing system requires operation of maximum an operator during a single standard daily work shift. The 3D printing system may require operation by a human operator working at most of about 8 hours (h), 7 h, 6 h, Sh, 4 h, 3 h, 2 h, 1 h, or 0.5 h a day. The 3D printing system may require operation by a human operator working between any of the afore-mentioned time frames (e.g., from about 8 h to about 0.5 h, from about 8 h to about 4 h, from about 6 h to about 3 h, from about 3 h to about 0.5 h, or from about 2 h to about 0.5 h a day).

In some embodiments, the manufacturing enclosure and/or processing chamber of the 3D printing system may be opened to the ambient environment sparingly. In some embodiments, the manufacturing enclosure and/or processing chamber of the 3D printing system may be opened by an operator (e.g., human) sparingly. Sparing opening may be at most once in at most every 1, 2, 3, 4, or 5 weeks. The weeks may comprise weeks of standard operation of the 3D printer. In some embodiments, the 3D printer has a capacity of 1, 2, 3, 4, or 5 full prints in terms of pre-transformed material (e.g., starting material such as powder) reservoir capacity. The 3D printer may have the capacity to print a plurality of 3D objects in parallel, e.g., in one material bed. For example, the 3D printer may be able to print at least 2, 3, 4, 5, 6, 7, 8, 9, or 10 3D objects in parallel.

In some embodiments, the printed 3D object is retrieved soon after terminating the last transformation operation of at least a portion of the material bed. Soon after terminating may be at most about 1 day, 12 hours, 6 hours, 3 hours, 2 hours, 1 hour, 30 minutes, 15 minutes, 5 minutes, 240 seconds (sec), 220 sec, 200 sec, 180 sec, 160 sec, 140 sec, 120 sec, 100 sec, 80 sec, 60 sec, 40 sec, 20 sec, 10 sec, 9 sec, 8 sec, 7 sec, 6 sec, 5 sec, 4 sec, 3 sec, 2 sec, or 1 sec. Soon after terminating may be between any of the afore-mentioned time values (e.g., from about 1 s to about 1 day, from about 1 s to about 1 hour, from about 30 minutes to about 1 day, or from about 20 s to about 240 s).

Ambient refers to a condition to which people are generally accustomed. For example, ambient pressure may be about 1 atmosphere. Ambient temperature may be a typical temperature to which humans are generally accustomed. For example, from about 15° C. to about 30° C., from about −30° C. to about 60° C., from about −20° C. to about 50° C., from 16° C. to about 26° C., from about 20° C. to about 25° C. “Room temperature” may be measured in a confined or in a non-confined space. For example, “room temperature” can be measured in a room, an office, a factory, a vehicle, a container, or outdoors. The vehicle may be a car, a truck, a bus, an airplane, a space shuttle, a spaceship, a ship, a boat, or any other vehicle. Room temperature may represent the small range of temperatures at which the atmosphere feels neither hot nor cold, approximately 24° C. “Room temperature” may denote 20° C., 25° C., or any value from about 20° C. to about 25° C.

In some embodiments, a time lapse between the end of printing in a first material bed, and the beginning of printing in a second material bed is at most about 60 minutes (min), 40 min, 30 min, 20 min, 15 min, 10 min, or 5 min. The time lapse between the end of printing in a first material bed, and the beginning of printing in a second material bed may be between any of the afore-mentioned times (e.g., from about 60 min to about 5 min, from about 60 min to about 30 min, from about 30 min to about 5 min, from about 20 min to about 5 min, from about 20 min to about 10 min, or from about 15 min to about 5 min). The speed during which the 3D printing process proceeds is disclosed in Patent Application serial number PCT/US15/36802 that is incorporated herein in its entirety.

In some embodiments, at least one (e.g., each) energy source of the 3D printing system is able to transform (e.g., print) at a throughput of at least about 6 cubic centimeters of material per hour (cc/hr), 12 cc/hr, 35 cc/hr, 50 cc/hr, 120 cc/hr, 480 cc/hr, 600 cc/hr, 1000 cc/hr, or 2000 cc/hr. The at least one energy source may print at any rate within a range of the aforementioned values (e.g., from about 6 cc/hr to about 2000 cc/hr, from about 6 cc/hr to about 120 cc/hr, or from about 120 cc/hr to about 2000 cc/hr). At times, the 3D printing increases in efficiency when a plurality of energy beams (e.g., at least two energy beams) is used for the 3D printing. In some embodiments, the plurality of energy beams incident on a target surface may increase (i) the (e.g., total) processing field available for printing (e.g., in a X-Y plane) and/or (ii) the rate of 3D printing completion for a given print cycle (as compared to using a single energy beam). For example, the plurality of energy beams may be useful in providing a relatively larger processing area (e.g., build platform and/or material bed) in which one or more 3D objects (e.g., larger 3D object) may be generated. The processing field may be larger in relation to a 3D printing system that comprises (e.g., only) a single energy beam, which processing area is limited to the areal extent (e.g., the processing field) of the single energy beam (e.g., as guided by an optical system), which is not arbitrarily sized. For example, the time for 3D printing may be shortened when at least two of the plurality of energy beams operate simultaneously at least in part (e.g., in parallel). For example, the time for 3D printing may be shortened by at least about 25%, 50%, 75% or 95% when at least two of the plurality of energy beams operate simultaneously at least in part. The time for 3D printing may be shortened by any value of the afore-mentioned values (e.g., by from about 25% to about 95%, about 25% to about 50%, or about 50% to about 95%) when at least two of the plurality of energy beams operate simultaneously at least in part. A shortened time may be relative to a 3D printing system that does not use a plurality of energy beams (e.g., uses only a single energy beam). Examples of 3D printing systems, apparatuses, devices, components, controllers, software, and 3D printing processes (e.g., speed of printing, throughput of printing processes) can be found in International Patent Application Serial No. PCT/US15/36802, and in International Patent Application Serial No. PCT/US19/226364, filed on May 16, 2019, each of which is incorporated herein by reference in its entirety.

In some embodiments, the at least one 3D object is removed from the material bed after the completion of the 3D printing process. For example, the 3D object(s) may be removed from the material bed when the transformed material that formed the 3D object hardens. For example, the 3D object may be removed from the material bed when the transformed material that formed the 3D object is no longer susceptible to deformation under standard handling operation (e.g., human and/or machine handling).

At times, a 3D printing process, e.g., 3D printing processes described herein, may result in a physical signature in a 3D object such as a material signature. The physical signature may comprise a detectable deviation or change on the surface of the 3D object.

In some embodiments, once a 3D object is removed from a printer, the object may include identifying one or more characteristics that indicate the orientation of the object during its formation in the printer. For example, the object may include features (e.g., transition lines, surface steps, melt pools and/or grain boundaries) that indicate one or more (e.g., average) layering planes. In some embodiments, the portion of the requested 3D object comprises (e.g., substantially) the same material as the support member. In some embodiments, the portion of the requested object comprises different material than the support member. Some or (e.g., substantially) all the support members may be removed from the main portion (e.g., after the printing is complete). In some cases, the support member causes one or more layers of the portion of the requested object to deform during printing (e.g., due to the presence of the support member during formation of the requested 3D object). Sometimes, the deformed layers comprise a visible mark. The mark may be a region of discontinuity in the layer, such as a microstructure discontinuity and/or an abrupt microstructural variation. The discontinuity in the microstructure may be explained by an inclusion of a foreign object (e.g., the support member). The microstructural variation may include (e.g., abruptly) altered melt pools and/or grain structure (e.g., crystals, e.g., dendrites) at or near the attachment point of the support member. The microstructure variation may be due to differential thermal gradients due to the presence of the support member. The discontinuity may be external at the surface of the 3D object. The discontinuity may arise from inclusion of the support member to the surface of the 3D object (e.g., the discontinuity may be visible as a breakage of the support member when at attempt is made to remove the support member after the printing). Breakage may be the result of cutting, shaving, chipping, sawing, polishing, sanding, or any combination thereof (e.g., to remove the support member from the main portion). In some instances, the object includes two or more support members and/or support marks. The two or more support members and/or support marks can be used to define a build plane that is (e.g., substantially) parallel to the platform surface during printing. In some embodiments, the build plane is (e.g., substantially) parallel to the (e.g., average) layering plane. In some embodiments, the process used for printing at least a portion of the 3D object leaves one or more surface marks. The surface mark(s) may comprise (i) a surface marking characteristic of a top surface, (ii) a surface marking characteristic of a top surface, or (iii) a surface marking characteristic of a side surface. The characteristic may comprise a roughness, material deposition trajectory pattern, tessellation pattern, or auxiliary support(s) or mark(s) indicative thereof. At times, the 3D printing comprises different printing methodologies. Each of the different printing methodologies may have a material signature, e.g., that is detectable. At least one of the 3D printing methodologies may have a material signature associated with an energy beam that facilitated in its generation.

In some examples, the generated 3D object adheres (e.g., substantially) to a requested model of the 3D object. Substantially may be with relation to the intended purpose of the 3D object. The 3D object (e.g., solidified material) that is generated can be formed with high fidelity, e.g., having a high fidelity (e.g., high accuracy) of one or more characteristics (e.g., dimensions) of the generated 3D object when compared to a model or simulation of the intended 3D object. For example, have an average deviation percentage from intended dimensions that are at most about 5%, 2%, 1%, 0.5%, 0.25%, 0.1%, 0.05%, or less. For example, the 3D object that is generated can have an average deviation value from the intended dimensions (e.g., of a requested 3D object) of at most about 0.5 microns (μm), 1 μm, 3 μm, 10 μm, 30 μm, 100 μm, 300 μm or less from a requested model of the 3D object. The deviation can be any value between the afore-mentioned values. The average deviation can be from about 0.5 μm to about 300 μm, from about 10 μm to about 50 μm, from about 15 μm to about 85 μm, from about 5 μm to about 45 μm, or from about 15 μm to about 35 μm. The 3D object can have a deviation from the intended dimensions in a specific direction, according to the formula Dv +.!:_, wherein Dv is a Kctv deviation value, L is the length of the 3D object in a specific direction, and Kdv is a constant. Dv can have a value of at most about 300 μm, 200 μm, 100 μm, 50 μm, 40 μm, 30 μm, 20 μm, 10 μm, 5 μm, 1 μm, or 0.5 μm. Dv can have a value of at least about 0.5 μm, 1 μm, 3 μm, 5 μm, 10 μm, 20 μm, 30 μm, 50 μm, 70 μm, 100 μm, 300 μm or less. Dv can have any value between the afore-mentioned values. For example, Dv can have a value that is from about 0.5 μm to about 300 μm, from about 10 μm to about 50 μm, from about 15 μm to about 85 μm, from about 5 μm to about 45 μm, or from about 15 μm to about 35 μm. Kdv can have a value of at most about 3000, 2500, 2000, 1500, 1000, or 500. Kdv can have a value of at least about 500, 1000, 1500, 2000, 2500, or 3000. Kdv can have any value between the afore-mentioned values. For example, Kdv can have a value that is from about 3000 to about 500, from about 1000 to about 2500, from about 500 to about 2000, from about 1000 to about 3000, or from about 1000 to about 2500.

At times, the generated 3D object (i.e., the printed 3D object) does not require further processing following its generation (e.g., retrieval) by a method described herein. The printed 3D object may require reduced amount of processing after its generation by a method described herein. For example, the printed 3D object may not require removal of auxiliary support (e.g., since the printed 3D object was generated as a 3D object devoid of auxiliary support) and/or removal of transformed material. The printed 3D object may not require smoothing, flattening, polishing (e.g., sanding), leveling, trimming, annealing, or curing. The printed 3D object may not require further machining. In some examples, the printed 3D object may require one or more treatment operations following its generation (e.g., post generation treatment, or post printing treatment). The further treatment step(s) may comprise surface scraping, machining, polishing, grinding, blasting (e.g., sand blasting, bead blasting, shot blasting, or dry ice blasting), annealing, or chemical treatment. Examples of 3D printing systems, apparatuses, devices, components, controllers, software, and 3D printing processes (e.g., post-processing, post-generation treatment, and post-printing treatment) can be found in U.S. patent application Ser. No. 17/835,023, filed on Jun. 8, 2022, in International Patent Application Serial No. PCT/US22/52588, filed Dec. 12, 2022, and in International Patent Application Serial No. PCT/US22/52902 filed Dec. 14, 2022, each of which is entirely incorporated herein by reference.

In some embodiments, the 3D printer comprises a chamber having an interior space. The chamber may be referred to herein as a “processing chamber.” The processing chamber may facilitate the ingress of at least one energy beam into the processing chamber. The energy beam(s) may be directed towards a target surface, e.g., an exposed surface of a material bed. The 3D printer may comprise one or more modules, e.g., build modules. At times, at least one build module may be situated in the manufacturing enclosure and coupled with the processing chamber. At times, at least one build module may reversibly engage with (e.g., couple to) the processing chamber to expand an interior volume of the processing chamber, e.g., to form at least a portion of the chamber.

In some embodiments, the 3D printing system comprises a build module. The build module may be mobile or stationary. The build module may comprise an elevation mechanism, e.g., comprising a build platform assembly. The build module may comprise the build platform (e.g., base) that may be coupled with the build platform assembly. The build platform may be disposed within the build module. The build platform may reside adjacent to the substrate, e.g., above the substrate relative to a gravitational center of the environment, e.g., Earth. The elevation mechanism may be reversibly connected to (and disconnected from) at least a portion of the build platform. The elevation mechanism may comprise a portion that vertically translates the build platform with respect to a gravitational center (e.g., a gravitational center of the Earth). The build platform may be disposed on the substrate. The build platform and the substrate may operatively couple (e.g., physically connect). The material bed may be disposed above build platform. The build platform may support the material bed. The build platform may comprise, or be configured to operatively couple to, an engagement mechanism. The substrate may comprise, or be configured to operatively couple to, an engagement mechanism. The engagement mechanism may facilitate engagement and/or dis-engagement between a base (e.g., of the build platform) and the substrate. The build platform may be configured to support one or more layers of pre-transformed material (e.g., as part of the material bed). The build platform may be configured to support at least a portion of the 3D object (e.g., during forming of the 3D object). The substrate and/or the base (e.g., build platform) may be removable or non-removable (e.g., from the 3D printing system and/or relative to each other). The substrate and/or base may be fastened (I) to the build module and/or (II) to each other. The build platform and/or substrate may be translatable, e.g., before, during, and/or after printing one or more 3D objects in a print cycle. The translation of the build platform may be effectuated (e.g., controlled and/or regulated) by the build platform assembly and/or an actuator (e.g., by at least one controller and/or by a control system). The build platform assembly may be configured to provide a high precision platform for building one or more 3D objects in a printing cycle with high fidelity. The translation of the substrate may be controlled and/or regulated by at least one controller (e.g., by a control system). The build platform and/or substrate may be translatable horizontally, vertically, or at an angle (e.g., planar or compound angle). The translation may be in both directions (e.g., back and forth such as up and down relative to a gravitational vector). The control system may be any control system disclosed herein, e.g., a control system of the 3D printer such as the one controlling an energy beam. The substrate may comprise a piston. At times, the 3D printing system may comprise more than one substrate. At times, the 3D printing system may comprise more than one piston. The disclosure herein relating to the substrate may apply to the substrates.

In some embodiments, the build module, processing chamber, and/or enclosure comprises one or more seals. The seal may be a sliding seal or a stationary (e.g., top) seal. For example, the build module and/or processing chamber may comprise a sliding seal that meets with the exterior of the build module upon engagement of the build module with the processing chamber. During at least a portion of the 3D printing process, the atmospheres of the build module and processing chamber may be separate. For example, the processing chamber may comprise a top seal that faces the build module and is pushed upon engagement of the processing chamber with the build module. For example, the build module may comprise a top seal that faces the processing chamber and is pushed upon engagement of the processing chamber with the build module. The seal may be a face seal, or compression seal. The seal may comprise an O-ring. For example, the build module and the processing chamber may be separated by a load lock. The seal may be impermeable or substantially impermeable to at least one gas. The seal may be permeable to at least one gas. The seal may be impermeable to a solid material (e.g., the pre-transformed material and/or the transformed material). The seal may be flexible. The seal may be elastic. The seal may be bendable. The seal may be compressible. The seal may include a material comprising rubber (e.g., latex), Teflon, plastic, or silicon. The seal may comprise a mesh, membrane, sieve, paper (e.g., filter paper), cloth such as felt (e.g., Aramid felt, or another high temperature felt or fiber), or a brush. The mesh, membrane, paper and/or cloth may comprise randomly or non-randomly arranged fibers. The paper may comprise a HEPA filter.

In some embodiments, the substrate is separated from the base (e.g., build platform) assembly by a seal. The base and/or the substrate may be separated from the internal surface (e.g., side walls) of the build module by one or more seals. The seal may be attached to the moving build platform and/or substrate (e.g., while the walls of the build module are devoid of a seal). The seal may be attached to the (e.g., vertical) walls of the build module (e.g., while the build platform and/or substrate is devoid of a seal). In some embodiments, both the build platform and/or substrate and the walls of the build module comprise a seal. The seal may be placed laterally (e.g., horizontally) between one or more walls (e.g., side walls) of the build module. The seal may be connected to the bottom plane of the build platform and/or substrate. The seal may be connected to a side (e.g., circumference) of the build platform and/or substrate.

The seal may be permeable to at least one gas. The seal may be impermeable or substantially impermeable to at least one gas. The seal may be impermeable to a solid material (e.g., the pre-transformed material and/or the transformed material). The seal may be impermeable to particulate material (e.g., powder). The seal may not allow permeation of particulate material into the build platform assembly and/or piston assembly. The build platform assembly may comprise a piston and a build platform. The piston assembly may comprise a piston. The seal may be flexible. The seal may be elastic. The seal may be bendable. The seal may be compressible. The seal may include a material comprising a polymeric material (e.g., nylon, polyurethane), Teflon, plastic, rubber (e.g., latex), or silicon. The seal may comprise a mesh, membrane, sieve, paper (e.g., filter paper), cloth (e.g., felt, or wool), or brush. The mesh, membrane, paper and/or cloth may comprise randomly and/or non-randomly arranged fibers. The paper may comprise a HEPA filter.

In some embodiments, the 3D printing system comprises a build module, e.g., as disclosed herein. The build module may accommodate a material bed having at least one (e.g., two or more) FLS (e.g., diameter, width, and/or height) of at most about 200 mm, 250 mm, 300 mm, 350 mm, 400 mm, 450 mm, 500 mm, 550 mm, 600 mm, 650 mm, 700 mm, 800 mm, 900 mm, 1000 mm, 1200 mm, 1500 mm, 2000 mm, 2500 mm, 3000 mm, 3500 mm, 4000 mm, or 4500 mm. The FLS of the material bed accommodated by the build module may have a FLS value between any of the aforementioned values (e.g., from about 100 mm to about 4500 mm, from about 100 mm to about 2000 mm, from about 100 mm to about 700 mm, or from about 300 mm to about 4000 mm). In addition to the material bed, the build module may be configured to accommodate a base (e.g., build platform) and at least one substrate (e.g., piston). The build module may accommodate a build platform having an FLS (e.g., diameter or width) of at least about 100 millimeters (mm), 200 mm, 300 mm, 400 mm, 500 mm, 600 mm, 700 mm, 800 mm, 900 mm, 1000 mm, 1500 mm, or 2000 mm, 2500 mm, 3000 mm, 3000 mm, 3500 mm, or 4000 mm. The build module may accommodate a build platform having at least one FLS (e.g., diameter, height and/or width), the FLS being of at most about 200 mm, 250 mm, 300 mm, 350 mm, 400 mm, 450 mm, 500 mm, 550 mm, 600 mm, 650 mm, 700 mm, 800 mm, 900 mm, 1000 mm, 1200 mm, 1500 mm, 2000 mm, 4000 mm, or 4500 mm. The FLS of the build platform accommodated by the build module may have a FLS value between any of the aforementioned values (e.g., from about 100 mm to about 4500 mm, from about 100 mm to about 1200 mm, from about 100 mm to about 1500 mm, or from about 300 mm to about 2000 mm). The build platform assembly may be able to translate in a continuous and/or discrete manner. The build platform assembly may be able to translate in discrete increments of at most about 5 micrometers (μm), 20 μm, 30 μm, 40 μm, 50 μm, 60 μm, 70 μm, or 80 μm. The build platform assembly may be able to translate in discrete increments having a value between any of the aforementioned values (e.g., from about 5 μm to about 80 μm, from about 10 μm to about 60 μm, or from about 40 μm to about 80 μm). The build platform assembly may have a precision (e.g., error+/−) of at most about 0.25 μm, 0.5 μm, 1 μm, 1.5 μm, 2 μm, 2.5 μm, 3 μm, 4 μm, or 5 μm. The build platform assembly may have a precision value between any of the aforementioned precision value (e.g., from about 0.25 μm to about 5 μm, from about 0.25 μm to about 2.5 μm, or from about 1.5 μm to about 5 μm). The build platform assembly may have a precision (e.g., error+/−) of at most about 0.5%, 1%, 2%, 3%, 4%, 5%, 6%, 8% or 10% of its incremental movement. The build platform assembly may have a precision value between any of the aforementioned precision values relative to its incremental movement (e.g., from about 0.5% to about 10%, from about 0.5% to about 5%, or from about 1% to about 10%). The weight of the material bed (e.g., including any printed 3D object therein) may be at least about 300 Kilograms (Kg), 500 Kg, 800 Kg, 1000 Kg, 1200 Kg, 1500 Kg, 1800 Kg, 2000 Kg, 2500 Kg, or 3000 Kg. The weight of the material bed (e.g., including any printed 3D object therein) may be between any of the aforementioned values (e.g., from about 300 Kg to about 3000 Kg, from about 300 Kg to about 1500 Kg, or from about 1000 Kg to about 3000 Kg). The build platform assembly may be configured to translate the build module at a speed of at most 3 millimeters per second (mm/sec), 5 mm/sec, 10 mm/sec, 20 mm/sec, 30 mm/sec, or 50 mm/sec. The build platform assembly may be configured to translate the build module at a speed of at least 1 mm/sec, 3 mm/sec, 5 mm/sec, 10 mm/sec, 20 mm/sec, 30 mm/sec, or 40 mm/sec. The build platform assembly may be configured to translate the build module at a speed between any of the aforementioned speeds (e.g., from about 1 mm/sec to about 50 mm/sec, from about 1 mm/sec to about 20 mm/sec, or from about 5 mm/sec to about 50 mm/sec). The build platform assembly may be configured to translate the build module at a speed of at most 1 millimeter per second squared (mm/sec2), 2.5 mm/sec2, 5 mm/sec2, 7.5 mm/sec2, 10 mm/sec2, or 20 mm/sec2. The build platform assembly may be configured to translate the build module at an acceleration of at least 0.5 mm/sec2, 1 mm/sec2, 2 mm/sec2, 3 mm/sec2, 5 mm/sec2, 10 mm/sec2, or 15 mm/sec2. The build platform assembly may be configured to translate the build module at a speed between any of the aforementioned speeds (e.g., from about 0.5 mm/sec2 to about 20 mm/sec2, from about 0.5 mm/sec2 to about 10 mm/sec2, or from about 4 mm/sec2 to about 20 mm/sec2). The build platform assembly may be configured such that a time to complete a translation of a first portion of the build platform assembly relative to a second portion of the build platform assembly (e.g., to perform a block movement) is at most about 120 seconds (sec), 60 sec, 50 sec, 45 sec, 40 sec, 35 sec, 30 sec, 25 sec, 20 sec, 15 sec, or less. The build platform assembly may be configured such that a time to complete a translation of a first portion of the build platform assembly relative to a second portion of the build platform assembly is any value between the aforementioned values, for example, from about 120 sec to 40 sec, from about 60 sec to 25 sec, or from about 35 sec to 15 sec.

In some embodiments, the pre-transformed material (e.g., starting material for the 3D printing) is deposited in a manufacturing enclosure to form a material bed. The pre-transformed material may be layered on a target surface, e.g., on an exposed surface of a material or on a surface of the build platform. The deposited layer of pre-transformed material may be substantially planar. For example, the deposited layer may have a central tendency of planarity (e.g., a surface roughness Ra) that is from about 15% to about 65% of a second central tendency of thickness of the deposited layer. The second central tendency of thickness of the deposited layer may be about equal to a discrete increment of vertical translation of the platform. The second central tendency of thickness of the deposited layer may be about equal to any discrete increment of vertical translation of the build platform assembly, e.g., as disclosed herein.

In some embodiments, the 3D printer comprises an energy source that generates an energy beam. The energy beam may project energy to the material bed. The apparatuses, systems, and/or methods described herein can comprise at least one energy beam. In some cases, the 3D printing system can comprise at least two, three, four, five, eight, twelve, sixteen, twenty-four, thirty-two, or more energy beams. The energy beam may include radiation comprising electromagnetic, electron, positron, proton, plasma, or ionic radiation. The electromagnetic beam may comprise microwave, infrared, ultraviolet or visible radiation. The ion beam may include a cation or an anion. The electromagnetic beam may comprise a laser beam. The energy beam may derive from a laser source. In some embodiments, the energy source is an energy beam source. The energy source may be a laser source. The laser may comprise a fiber laser, a solid-state laser, or a diode laser (e.g., diode pumped fiber laser).

In some embodiments, the energy source is a laser source. The laser source may comprise a Nd: YAG, Neodymium (e.g., neodymium-glass), or an Ytterbium laser. The laser beam may comprise a ring (e.g., corona) laser beam, e.g., a laser beam having a footprint similar to a doughnut shape or a ring shape. The laser may comprise a carbon dioxide laser (CO2 laser). The laser may be a fiber laser. The laser may be a solid-state laser. The laser can be a diode laser. The energy source may comprise a diode array. The energy source may comprise a diode array laser. The laser may be a laser used for micro laser sintering. Examples of 3D printing systems, apparatuses, devices, components (e.g., energy beams), controllers, software, and 3D printing processes can be found in International Patent Application Serial No. PCT/US17/60035, filed Nov. 3, 2017; and in International Patent Application Serial No. PCT/US22/16550, filed Feb. 26, 2022; each of which is entirely incorporated herein by reference.

In some embodiments, the energy beam (e.g., transforming energy beam) comprises a Gaussian energy beam. The energy beam may have any cross-sectional shape comprising an ellipse (e.g., circle), or a polygon (e.g., as disclosed herein). The energy beam may be continuous or non-continuous (e.g., pulsing). The energy beam may be modulated before and/or during the formation of a transformed material as part of the 3D object. The energy beam may be modulated before and/or during the 3D printing process. In some embodiments, the energy beam (e.g., laser) has a power of at least about 150 Watt (W), 200 W, 250 W, 350 W, 500 W, 750 W, 1000 W, or 1500 W. The energy source may have a power between any of the afore-mentioned energy beam power values (e.g., from about from about 150 W to about 1000 W, or from about 1000 W to about 1500 W). The energy beam may derive from an electron gun.

In some embodiments, the 3D printer includes a plurality of energy beams, e.g., laser beams. The 3D printer may comprise at least 2, 4, 6, 8, 10, 12, 16, 20, 24, 32, 36, 64, or more energy beams. Each of the energy beam may be coupled with its own optical window. At times, at least two energy beams may shine through the same optical window. At times, at least two energy beams may shine through different optical windows.

In some embodiments, the energy beam (e.g., transforming energy beam) comprises a Gaussian energy beam. The energy beam may have any cross-sectional shape comprising an ellipse (e.g., circle), or a polygon (e.g., as disclosed herein). The energy beam may be continuous or non-continuous (e.g., pulsing). The energy beam may be modulated before and/or during the formation of a transformed material as part of the 3D object. The energy beam may be modulated before and/or during the 3D printing process.

In some embodiments, the beam profile of the energy beam is altered, e.g., during printing. Any of the 3D printing methodologies disclosed herein can include altering the beam profile. Alteration of the beam profile can be using a physical component and/or a computational scheme (e.g., algorithm). Alteration of the beam profile can comprise manual and/or automatic methods. The automatic methods may comprise usage of at least one controller directing the beam profile alteration. The beam profile may be altered during the 3D printing, e.g., during printing of a layer of transformed material that forms at least a portion of the 3D object. Alteration of the beam profile can comprise alteration of a type of an energy profile utilized. The type of the beam profile comprises: a gaussian beam profile, a top hat beam profile, or a ring (e.g., corona or doughnut) beam profile. For example, the energy beam may print a first portion of the 3D object using a gaussian beam profile, and then print a second portion of the 3D object using a ring shaped beam profile.

In some embodiments, the beam profile of the energy beam is altered, e.g., during printing. Any of the 3D printing methodologies disclosed herein can include altering the beam profile. Alteration of the beam profile can be at least in part by using a physical component and/or a computational scheme. Alteration of the beam profile can comprise manual and/or automatic methods. The automatic methods may comprise usage of at least one controller directing the beam profile alteration. The beam profile may be altered during the 3D printing, e.g., during printing of a layer of transformed material that forms at least a portion of the 3D object. Alteration of the beam profile can comprise alteration of a type of an energy profile utilized. The type of the beam profile comprises: a gaussian beam profile, a top hat beam profile, or a doughnut (e.g., corona) beam profile. For example, the energy beam may print a first portion of the 3D object using a gaussian beam profile, and then print a second portion of the 3D object using a doughnut shaped beam profile.

In some embodiments, the energy beam(s) is/are utilized for the 3D printing. The energy beam(s) can translate vertically, horizontally, or in an angle (e.g., planar or compound angle). The energy beam(s) can be modulated. The energy beam(s) emitted by the energy source(s) can be modulated.

In some embodiments, at least one of the energy beams is moveable with respect to a material bed and/or 3D printing system. Movable can be relative to the processing chamber, the build module, the target surface, or any combination thereof. The energy beam can be moveable such that it can translate relative to the material bed (e.g., across the top surface of the material bed), e.g., during the printing. The energy beam can be moved by an optical system (e.g., comprising a scanner). The movement of the energy beam can comprise utilization of a scanner e.g., optical scanner to move the energy beam, or mechanical stage type scanner to move the target surface on which the energy beam impinges. The energy beams can be translated independently of each other. In some cases, at least two energy beams can be translated at different rates, and/or along different paths. For example, the movement of a first energy beam may be faster (e.g., at a greater rate) as compared to the movement of a second energy beam. At times, the energy beam(s) are modulated. The energy (e.g., beam) emitted by the energy source can be modulated. The modulator can comprise an amplitude modulator, a phase modulator, or polarization modulator. The modulation may alter the intensity of the energy beam. The modulation may alter the shape (e.g., footprint) of the energy beam. The modulation may alter the current supplied to the energy source (e.g., direct modulation). The modulation may affect (e.g., alter) the energy beam, e.g., external modulation such as external light modulator. The modulator can comprise an acousto-optic modulator or an electro-optic modulator. The modulator can comprise an absorptive modulator or a refractive modulator. The modulation may alter the absorption coefficient of the material that is used to modulate the energy beam. The modulator may alter the refractive index of the material that is used to modulate the energy beam. The energy beam, and/or the platform can be moved by at least one scanner, e.g., optical scanner can move the energy beam, or mechanical stage type scanner to move the target surface on which the energy beam impinges such as moving a material bed having an exposed. The scanner can be included in an optical system that is configured to direct energy beam from the energy source to a predetermined position on the (target) surface, e.g., an exposed surface of the material bed. At least two scanners may be operably coupled with a single energy source and/or energy beam. In some embodiments, at least two energy beams are moved by the same scanner. At least two (e.g., each) energy sources and/or beams may have a separate scanner. In some embodiments, at least two energy beams are moved with different scanners, e.g., are each moved with a different scanner. The scanner may comprise one or more optical elements, e.g., mirrors. The scanner may comprise a galvanometer scanner (e.g., a two-axis galvanometer scanner), a polygon, a mechanical-stage (e.g., X-Y-stage), a piezoelectric device, gimbal, or any combination thereof. The galvanometer scanner may comprise a mirror. The scanner may comprise a modulator. The scanner may comprise a polygonal mirror. The systems and/or apparatuses disclosed herein may comprise one or more shutters (e.g., safety shutters). The energy source(s) can project energy using a OLP modulator, a one-dimensional scanner, a two-dimensional scanner, or any combination thereof.

In some embodiments, the energy source is used to generate the energy beam. The energy source can be stationary. In some embodiments, the energy beam (e.g., laser beam) impinges onto an exposed surface of a material bed to generate at least a portion of a 3D object. The energy beam may be a focused beam. The energy beam may be a dispersed beam. The energy beam may be an aligned beam. The apparatus and/or systems described herein may comprise a focusing coil, a deflection coil, or an energy beam power supply. The optical system may be configured to direct at least one energy beam from the at least one energy source to a position on a target surface such as an exposed surface of the material bed within the manufacturing enclosure, e.g., to a predetermined position on the target surface. The 3D printing system may comprise a processor (e.g., a central processing unit). The processor can be programmed to control a trajectory of the at least one energy beam and/or energy source e.g., with the aid of the optical system and/or optical actuator(s). The systems and/or the apparatus described herein can comprise a control system in communication with the energy source(s) and/or energy beam(s). The control system can regulate a supply of energy from the energy source(s) to the material (e.g., to the pre-transformed material), e.g., to form the transformed material. The control system may control the various components of the optical system. The various components of the optical system may include optical components comprising a mirror(s), a lens (e.g., concave, or convex), a fiber, a beam guide, a rotating polygon, or a prism. The optical system may be enclosed in an optical system enclosure, e.g., of the system of optical assemblies. Examples of 3D printing systems, apparatuses, devices, and components (e.g., optical housing and optical system), controllers, software, and 3D printing processes can be found Patent Application serial number PCT/US17/64474, filed Dec. 4, 2017, in International Patent Application serial number PCT/US18/12250, filed Jan. 3, 2018, in International Patent Application Serial No. PCT/US19/226364, filed on May 16, 2019, and in International Patent Application PCT/US23/24161, filed on Jun. 1, 2023, each of which is incorporated herein by reference in its entirety.

In some embodiments, the 3D printer and/or any of its components comprises a power supply. The power supply to any of the components described herein can be supplied by a grid, generator, local, or any combination thereof. The power supply can be from renewable or non-renewable sources. The renewable sources may comprise solar, wind, hydroelectric, or biofuel. The power supply can comprise rechargeable batteries.

In some embodiments, the 3D printing system can comprise two, three, four, five, eight, ten, sixteen, eighteen, twenty, twenty-four, thirty-two, thirty-six, or more energy sources that each generates an energy beam (e.g., laser beam). An energy source can be a source configured to deliver energy to an area (e.g., a confined area). The energy can be in the form of an energy beam such as a laser beam or an electron beam. An energy source can deliver energy to the confined area through radiative heat transfer. The energy source may comprise a laser source or an electron beam source.

In some embodiments, the 3D printing system can comprise at least one (e.g., a plurality of) optical windows. The optical window(s) may be arranged on the roof of the processing chamber. The optical window(s) may be arranged on a side wall of the processing chamber. The optical window(s) may be arranged with respect to the processing chamber to allow transmittance of energy beam(s) directed by the array of optical assemblies into the processing chamber. The optical window(s) may be arranged with respect to the processing chamber to allow transmittance of energy beam(s) directed by the array of optical assemblies into the processing chamber and incident on the target surface supported by the build platform. During the 3D printing, a ventilator and/or gas flow may deter (e.g., measurably and/or substantially prevent) debris from accumulating on the surface of optical window(s) that are disposed within the manufacturing enclosure (e.g., within the processing chamber). The debris may comprise soot, spatter, or splatter. The optical window may be supported by (or supportive of) a nozzle that directs debris away from the optical window, e.g., at towards the material bed. The processing cone may assume the shape of a truncated cone withing the processing chamber.

In some embodiments, the 3D printing system comprises one or more sensors. The one or more sensors may be at least about 500, 600, 900, or 1000 sensors. At least two of the sensors may be of the same type. At least two of the sensors may be of different type. The 3D printing system includes at least one enclosure. In some embodiments, the 3D printing system (e.g., its enclosure) comprises one or more sensors (alternatively referred to herein as one or more sensors). The enclosure described herein (e.g., manufacturing enclosure and/or optical enclosure) may comprise at least one sensor. The enclosure may comprise, or be operatively coupled with, the build module, the filtering mechanism, gas recycling system, the processing chamber, or the ancillary chamber. The sensor may be connected and/or controlled by the control system (e.g., computer control system, or controller(s)). The control system may be able to receive signals from the at least one sensor. The control system, e.g., through a control scheme, may act upon at least one signal received from the at least one sensor. The control scheme may comprise a feedback and/or feed forward control scheme, e.g., that has been pre-programmed. The feedback and/or feed forward control may rely on input from at least one sensor that is connected to the controller(s).

In some embodiments, the 3D printing system comprises one or more sensors. The one or more sensors can comprise a pressure sensor, a temperature sensor, a gas flow sensor, or an optical density sensor. The pressure sensor may measure the pressure of the chamber (e.g., pressure of the chamber atmosphere). The pressure sensor can be coupled with the control system. The pressure can be electronically and/or manually controlled. The controller may regulate the pressure (e.g., with the aid of one or more vacuum pumps) according to input from at least one pressure sensor. The sensor may comprise light sensor, image sensor, acoustic sensor, vibration sensor, chemical sensor, electrical sensor, magnetic sensor, fluidity sensor, movement sensor, speed sensor, position sensor, pressure sensor, force sensor, density sensor, metrology sensor, sonic sensor (e.g., ultrasonic sensor), or proximity sensor. The metrology sensor may comprise measurement sensor (e.g., height, length, width, depth, angle, and/or volume). The metrology sensor may comprise a magnetic, acceleration, orientation, or optical sensor. The sensor may comprise a material level sensor such as a powder level sensor. The sensor (e.g., material level sensor) may comprise a guided wave radar. The optical sensor may comprise a camera. The metrology sensor may measure the gap. The metrology sensor may measure at least a portion of the layer of material (e.g., pre-transformed, transformed, and/or hardened). The layer of material may be a pre-transformed material (e.g., powder), transformed material, or hardened material. The metrology sensor may measure at least a portion of the 3D object. The sensor may comprise a temperature sensor, weight sensor, powder level sensor, gas sensor, or humidity sensor. The gas sensor may sense any gas enumerated herein. The temperature sensor may measure the temperature without contacting the material bed (e.g., non-contact measurements). The weight of the manufacturing enclosure (e.g., container), or any components within the manufacturing enclosure can be monitored by at least one weight sensor in or adjacent to the material. One or more position sensors (e.g., height sensors) can measure the height of the material bed relative to the substrate. The position sensors can be optical sensors. The position sensors can determine a distance between one or more energy sources and the surface of the material bed. The exposed surface of the material bed can be the upper surface of the material bed relative to the gravitational center of the environment. Examples of 3D printing systems, apparatuses, devices, material beds, and components (e.g., sensors), controllers, software, and 3D printing processes can be found in International Patent Application Serial No. PCT/US17/60035, filed Nov. 3, 2017; and in International Patent Application Serial No. PCT/US22/16550, filed Feb. 26, 2022; each of which is entirely incorporated herein by reference.

In some embodiments, the 3D printer comprises one or more valves. The methods, systems and/or the apparatus described herein may comprise at least one valve. The valve may be shut or opened based at least in part on an input from the at least one sensor (e.g., automatically), or manually. The degree of valve opening or shutting may be regulated by the control system, for example, according to at least one input from at least one sensor. The systems and/or the apparatus described herein can include one or more valves, such as throttle valves or butterfly valves. The valve may or may not comprise a sensor sensing the open/shut position of the valve. The valve may be a component of a gas conveyance system, e.g., operable to control the flow of gas of the gas conveyance system. A valve may be a component of the gas conveyance system, e.g., operable to control a flow of gas in the gas conveyance system. The valve(s) may comprise a proportional valve or a discrete valve.

In some embodiments, the 3D printer comprises one or more actuators such as motors. The motor may be controlled by the controller(s) (e.g., by the control system) and/or manually. The motor may alter (e.g., the position of) the substrate and/or the base. The motor may alter (e.g., the position of) the build platform assembly. The actuator may facilitate translation (e.g., propagation) of the layer dispenser, e.g., the actuator may facilitate reversible translation of the layer dispenser. The motor may alter an opening of the manufacturing enclosure (e.g., its opening or closure). The motor may be a step motor or a servomotor. The actuator (e.g., motor) may alter (e.g., a position of) one or more optical components, e.g., mirrors, lenses, prisms, and the like. The servomotors may comprise actuated linear lead screw drive motors. The motors may comprise belt drive motors. The motors may comprise rotary encoders. The encoder may comprise an absolute encoder. The encoder may comprise an incremental encoder. The apparatuses and/or systems may comprise switches. The switches may comprise homing or limit switches. The motors may comprise actuators. The motors may comprise linear actuators. The motors may comprise belt driven actuators. The motors may comprise lead screw driven actuators. The actuators may comprise linear actuators.

In some embodiments, the 3D printer (e.g., its components) comprises one or more nozzles. The systems and/or the apparatus described herein may comprise at least one nozzle. For example, the material remover may comprise a nozzle. The nozzle may be regulated according to at least one input from at least one sensor. The nozzle may be controlled automatically or manually. The controller(s) may control the nozzle. The controller(s) may any controller(s) disclosed herein, e.g., as part of the control system of the 3D printer. The nozzle may include jet (e.g., gas jet) nozzle, high velocity nozzle, propelling nozzle, magnetic nozzle, spray nozzle, vacuum nozzle, or shaping nozzle (e.g., a die). The nozzle can be a convergent or a divergent nozzle. The spray nozzle may comprise an atomizer nozzle, an air-aspirating nozzle, or a swirl nozzle. The material dispenser can comprise a nozzle, e.g., through which material is removed from the material bed. The gas flow system may comprise a nozzle, e.g., that facilitates adjustment to the gas flow. The optical window may be supported by a nozzle that directs debris away from the optical window, e.g., at towards the material bed. The nozzle may comprise a venturi nozzle.

In some embodiments, the 3D printer comprises one or more pumps. The systems and/or the apparatus described herein may comprise at least one pump. The pump may be regulated according to at least one input from at least one sensor. The pump may be controlled automatically or manually. The controller may control the pump. The one or more pumps may comprise a positive displacement pump. The positive displacement pump may comprise rotary-type positive displacement pump, reciprocating-type positive displacement pump, or linear-type positive displacement pump.

In some embodiments, the 3D printer comprises at least one filter. The filter may comprise a ventilation filter. The ventilation filter may capture debris and/or other gas-borne material (e.g., fine powder) from the 3D printing system. The filter may comprise a paper filter such as a high-efficiency particulate air (HEPA) filter (a.k.a., high-efficiency particulate arresting filter). The ventilation filter may capture debris comprising soot, splatter, spatter, gas borne pre-transformed material, or gas borne transformed material. The debris may result from the 3D printing process. The filter and/or gas flow may direct the debris in a requested direction (e.g., by using positive and/or negative gas pressure). For example, the filter and/or gas flow may use vacuum, overpressure, and/or gas pulsing. For example, the ventilator may use gas flow.

At times, it may be advantageous to allow for easy installation and/or component maneuvering of the 3D printing system. For example, it may be advantageous if one or more components of the 3D printing system are easily maneuvered, e.g., insertable and/or removed. Easy maneuvering (e.g., removal and/or insertion) may include actions of a user facing the 3D printing system, and maneuvering (e.g., pulling and/or pushing) the one or more components to facilitate their maneuver, e.g., removal and/or insertion, respectively. For example, easy maneuvering (e.g., removal and/or insertion) may include actions of a personnel facing a front, a back, a side, a top, or a bottom of the 3D system, and maneuvering (e.g., pulling and/or pushing) the one or more components to facilitate their maneuver (e.g., removal and/or insertion, respectively). The one or more components may comprise: an optical system (e.g., including an array of optical assemblies, a laser generator), a detection system, an optical system enclosure, a side cover, or a door. The front of the 3D printing system can include a door to the processing chamber. The top of the 3D printing system can face the platform, e.g., through the optical window(s). The one or more components can be reversibly secured to and release from the rest of the 3D printing system using a (e.g., flexible) fastener. The flexible fastener may facilitate reversible maneuvering of a component (e.g., retraction and insertion of the component into a designated location in the 3D printing system. The fastener may comprise any material disclosed herein, e.g., an elemental metal, a metal alloy, or a polymer. The fastener may comprise a lock assembly. The fastener may comprise a snap (e.g., snap fit) assembly, or a latch assembly. The fastener may comprise interlocking portions that engage and/or disengage using human exerted force. The fastener may comprise a cantilever, torsional or annular. The fastener may be devoid of loose parts. The fastener may or may not comprise a spring. In some embodiments, a component may be configured to (e.g., reversibly) snap into and/or out of a cavity in the 3D printing system, e.g., without any fastener, and rather due to the geometric configuration of the cavity edge and component edge that fit together. The fastener may comprise a screw, a peg, or a pin. The component (e.g., energy source) may be disposed on a rack (e.g., an electronic rack). The component may be engaged with a sliding mechanism (e.g., similar to a drawer). For example, the component may comprise at least one wheel (e.g., wheels) configured to couple to at least one rail (e.g., two rails) disposed in 3D printing system cavity. For example, the component may comprise at least one rail (e.g., two rails) configured to couple to the 3D printing system cavity (e.g., wheel(s) configured to engage with the at least one rail. The component and/or 3D printing system cavity may comprise bracket(s) as part of the engagement mechanism between the 3D printing system cavity and the component. The engagement mechanism may comprise a rail, a wheel, or a bracket. The engagement mechanism may facilitate linear and/or tilting sliding of the component with respect to the 3D printing system. Any parts of the components may remain stable (e.g., configured to remain stable) during the maneuvering. For example, one or more parts (e.g., all parts) of the optical system may be stable during extraction of the optical system and/or one or more components of the optical system (e.g., an optical assembly of the array of optical assemblies) from the 3D printing system and/or insertion of the optical system into the 3D printing system. Such (e.g., reversible) maneuvering methodology may allow easy assembly, and/or maintenance of the 3D printing system (e.g., of the component thereof).

At times, maneuvering the optical system with respect to the 3D printing system causes no, or minimum (e.g., non-material), alternation of the optical system(s) disposed in the optical system enclosure. For example, one or more parts (e.g., all parts) of the optical system, optical assembly/ies, or of the optical system enclosure may be stable during extraction of the optical system, optical assembly/ies, (or optical system enclosure comprising the optical system) from the 3D printing system and/or insertion of the optical system or optical assembly/ies into the 3D printing system. Such (e.g., reversible) maneuvering methodology may allow easy assembly, and/or maintenance of the 3D printing system (e.g., of the component thereof).

At times, the energy beam follows a path. The path of the energy beam may be a vector. The path of the energy beam may comprise a raster, a vector, or any combination thereof. The path of the energy beam may comprise an oscillating pattern. The path of the energy beam may comprise a zigzag, wave (e.g., curved, triangular, or square), or curve pattern. The curved wave may comprise a sine or cosine wave. The path of the energy beam may comprise a sub-pattern. The path of the energy beam may comprise an oscillating (e.g., zigzag), wave (e.g., curved, triangular, or square), and/or curved sub-pattern. The curved wave may comprise a sine or cosine wave.

The path of the energy beam may comprise a sub-pattern. The sub-pattern of the energy beam may comprise a wave (e.g., sine or cosine wave) pattern. The sub-pattern may be a small path that forms the large path. The sub-pattern may be a component (e.g., a portion) of the large path. The path that the energy beam follows may be a predetermined path. A model may predetermine the path by utilizing a controller or an individual (e.g., human). The controller may comprise a processor. The processor may comprise a computer, computer program, drawing or drawing data, statue or statue data, or any combination thereof. The hatch lines or paths may be straight or curved. The hatch lines or paths may be winding. At times, the path comprises successive lines. The successive lines may touch each other. The successive lines may overlap each other in at least one point. The successive lines may substantially overlap each other. The successive lines may be spaced by a first distance (e.g., hatch spacing). Examples of 3D printing systems, apparatuses, devices, and any component thereof; controllers, software, and 3D printing processes (e.g., hatch spacings) can be found in International Patent Application Serial No PCT/US16/34857 filed on May 27, 2016, which is entirely incorporated herein by reference.

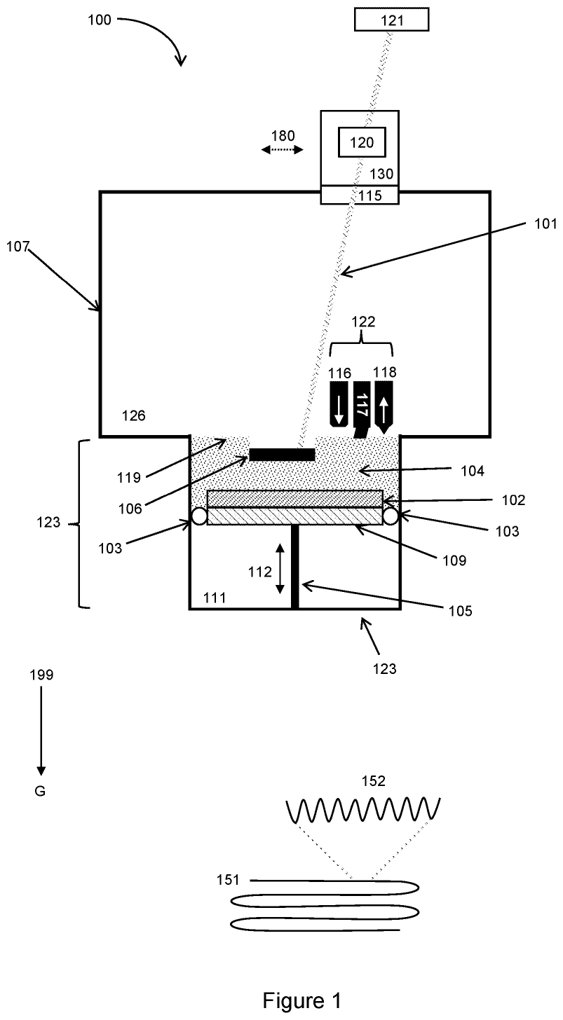

FIG. 1 shows an example of a 3D printing system 100 having a processing chamber 107 coupled with a build module 123. The build module comprises an elevation mechanism 105 (e.g., as part of a build platform assembly) that vertically translate a substrate 109 (e.g., piston) along arrow 112. A build platform 102 is disposed on substrate 109 (e.g., piston). Material bed 104 is disposed above build platform 102 (e.g., also referred herein as “base”, or “build plate”). The 3D printing system 100 comprises an optical system 120 (e.g., a guidance system) for energy beam 101 (e.g., a galvanometer scanner). The optical system 120 is disposed in optical system enclosure 130 coupled with optical window 115. Optical system 120 can optionally be translatable along axis 180, e.g., translatable along an axis perpendicular to gravitational vector 199 pointing towards the gravitational center of the ambient environment, e.g., earth. Energy source (e.g., laser source) 121 generates energy beam 101 that traverses through the optical system 120 (e.g., comprising a guidance system such as a scanner) and through an optical window 115 into processing chamber 107 enclosing interior space 126 that can include an atmosphere. The optical window 115 is configured to allow the energy beam to pass through with minimal energetic loss, e.g., without (e.g., substantial) energetic loss. Processing chamber 107 can include an optional temperature adjustment device (e.g., cooling plate), not shown. Seal 103 encircles the substrate and/or base, e.g., to deter (e.g., prevent) migration of material of the material bed from reaching elevation mechanism 105. Energy beam 101 impinges upon an exposed surface 119 of material bed 104, to form at least a portion of a 3D object 106. FIG. 1 shows an example of a build module 123. Build module 123 contains the pre-transformed (e.g., starting) material in a material bed 104. As depicted in FIG. 1, the 3D printer comprises a layer dispensing mechanism 122. The layer dispensing mechanism 122 includes a material dispenser 116 and a powder removal mechanism 118 to form a layer of pre-transformed material (e.g., starting material) within the manufacturing enclosure. Layer dispensing mechanism 122 includes an optional leveler 117. The material may be layered (e.g., spread) in the manufacturing enclosure such as by using the layer dispensing mechanism 122. Build module 123 is configured to enclose a substrate 109 (e.g., piston) and arranged adjacent to a floor 111 at the bottom of build module 123. Floor 111 is defined relative to the gravitational field along gravitational vector 199 pointing towards gravitational center G, and/or relative to the position of the footprint of the energy beam 101 on the layer of pre-transformed material as part of a material bed 104. Build module 123 comprises build platform 102. The substrate is coupled with one or more seals 103 that enclose the material in a selected area within the build module to form material bed 104. One or more components of 3D printing system 100 are controlled by a control system (not shown in FIG. 1). The energy beam 101 can travel along a path such as path 151. FIG. 1 shows an example of a path of an energy beam path 151 comprising a zigzag sub-pattern. Sub-pattern 152 is an expansion (e.g., blow-up) of a portion of path 151.

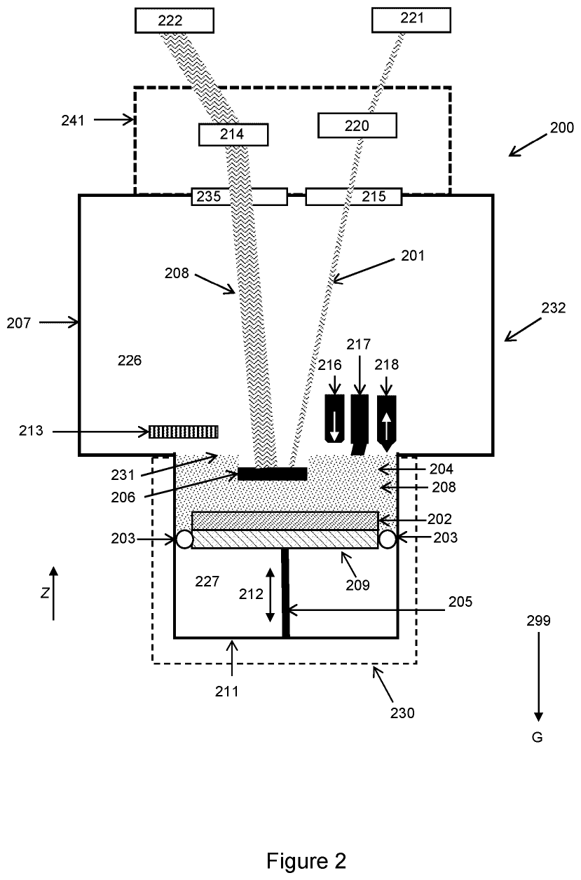

In some embodiments, the 3D object(s) is/are formed using a 3D printing system (also referred to herein as “3D printer” or “printer”). FIG. 2 shows an example 3D printing system portion 200. The 3D printer may include a manufacturing enclosure (e.g., FIG. 2, 232). The manufacturing enclosure can include sub-enclosures. For example, the manufacturing enclosure can include a processing chamber (e.g., FIG. 2, 207) and a build module (e.g., FIG. 2, 230). The sub-enclosures may be configured to be coupled and decoupled from one another. The build module can include a platform for supporting a material bed (e.g., FIG. 2, 204) during formation of the one or more 3D objects. The material bed can include a pre-transformed material (e.g., FIG. 2, 208) and/or a transformed material (e.g., FIG. 2, 206). In some embodiments, the platform includes a base (e.g., build plate such as in FIG. 2, 202) and/or a substrate (e.g., piston such as in FIG. 2, 209). In some embodiments, an elevator shaft (e.g., FIG. 2, 205) is configured to move the platform (e.g., vertically such as 212). The lower portion (e.g., FIG. 2, 227) comprising the elevator shaft can be separated from the material bed by seal(s), e.g., O-ring portions (e.g., FIG. 2, 203). The substrate and/or base can have a circular, rectangular, square, or irregularly shaped cross-section. The platform can comprise a support surface that supports at least a portion of one or more 3D objects. The support surface may be the surface of the base. In some instances, one or more 3D objects are coupled with (e.g., build onto) the base during printing. In some embodiments, the support surface is (e.g., substantially) orthogonal (e.g., normal and/or perpendicular) to the gravitational field vector. In some embodiments, the one or more 3D objects are printed directly on the support surface of the platform (e.g., directly on the base). The base may also be referred to herein as the build plate. The manufacturing enclosure and/or platform may comprise an elemental metal, metal alloy, ceramic, or an allotrope of elemental carbon. The manufacturing enclosure wall may comprise a non-transparent (e.g., opaque) material. The platform may be separated from one or more walls (e.g., side walls) of the build module by a seal (e.g., FIG. 2, 203). The 3D printer portion shown in FIG. 2 is depicted relative to gravitational vector 299 pointing towards the gravitational center of the ambient environment, e.g., Earth. Examples of 3D printing systems, apparatuses, devices, components, controllers, software, and 3D printing processes can be found in International Patent Application Serial No. PCT/US15/36802, filed Jun. 19, 2015, International Patent Application Serial No. PCT/US16/66000, filed Dec. 9, 2016, International Patent Application Serial No. PCT/US17/60035, filed Nov. 3, 2017, and International Patent Application Serial No. PCT/US17/39422, filed Jun. 27, 2017, each of which is entirely incorporated herein by reference.

In some embodiments, the enclosure (e.g., manufacturing enclosure and/or processing enclosure) is configured to hold an atmosphere. In some cases, the build module is (e.g., removably) coupled with the processing chamber during at least a portion of the printing. In some embodiments, the manufacturing enclosure is configured to allow an atmosphere (e.g., FIG. 2, 226) in the processing chamber to mix with an atmosphere (e.g., FIG. 2, 227) in the build module (e.g., during printing). In some embodiments, the manufacturing enclosure is configured to separate the atmosphere in the processing chamber to mix with the atmosphere in the build module (e.g., during separation of the build module from the processing chamber). The one or more 3D objects may be exposed to the atmosphere in the processing chamber during printing (or a portion of the printing process). In some cases, the build module is configured to maintain an atmosphere separate from the processing chamber. Examples of 3D printing systems, apparatuses, devices (e.g., build module and processing chamber coupling mechanism), components, controllers, software, and 3D printing processes (e.g., atmosphere management) can be found in International Patent Application Serial No. PCT/US17/39422, filed Jun. 27, 2017, which is entirely incorporated herein by reference. The atmosphere in the processing chamber and/or build module may be non-reactive with the pre-transformed material and/or transformed material (e.g., during their formation). A non-reactive atmosphere comprises an inert gas (e.g., noble gas, e.g., argon). The atmosphere may be at an ambient or above ambient pressure, during at least apportion of the 3D printing.

In some instances, the printer is configured to transform a pre-transformed material (e.g., starting material confined in material bed such as FIG. 2, 208) to a transformed material, e.g., as part of a 3D object such as in FIG. 2, 206. The transformed material may correspond to at least a portion of the one or more 3D objects. The material bed may comprise the pre-transformed material and the transformed material. The material bed may comprise multiple layers of pre-transformed and/or transformed material. The pre-transformed material may be in a granular form (e.g., powder). In some cases, the material bed has a (e.g., substantially) constant pressure gradient. In some cases, the material bed is free of pressure gradients. In some cases, a multiplicity of layers of pre-transformed material is sequentially deposited, and a top layer (or optionally at least two, or three top layers) is transformed, wherein the bottom layers remain loose (i.e., uncompact) and flowable (e.g., flowable powder material) at least during the printing. An optional thermal conditioning unit (e.g., FIG. 2, 213) can be configured to maintain a local temperature (e.g., of the material bed or atmosphere). In some cases, the thermal control unit comprises a (e.g., passive, or active) heating member. In some cases, the thermal control unit comprises a (e.g., passive, or active) cooling member. The thermal control unit may comprise a thermostat. The thermal control unit can be provided inside of a region where the 3D object is formed or adjacent to (e.g., above) a region (e.g., within the processing chamber atmosphere) where the 3D object is formed. The thermal control unit can be provided outside of a region (e.g., within the processing chamber atmosphere) where the 3D object is formed (e.g., at a predetermined distance).

In some embodiments, the printer includes one or more layer dispensing mechanisms for dispensing the pre-transformed material. The layer dispensing mechanisms may be configured to dispense the pre-transformed material layer by layer. The layer dispensing mechanisms may level, distribute, spread, and/or remove the pre-transformed material in the material bed. The layer dispensing mechanism may be utilized to form the material bed. The layer dispensing mechanism may be utilized to form the layer of pre-transformed material (or a portion thereof). The layer dispensing mechanism may be utilized to level (e.g., planarize) the layer of pre-transformed material or a portion thereof. The leveling may be to a predetermined height. The layer dispensing mechanism may comprise at least one, two or three of a (i) powder dispensing mechanism (e.g., FIG. 2, 216), (ii) powder leveling mechanism (e.g., FIG. 2, 217), and (iii) powder removal mechanism (e.g., FIG. 2, 218). The layer dispensing system may comprise a hopper. The layer dispensing system may comprise a recoater. The layer dispensing mechanism may be controlled by the controller, e.g., in real time. Examples of 3D printing systems, apparatuses, devices (e.g., layer dispensing mechanism), components, controllers, software, and 3D printing processes can be found in international patent application number PCT/US16/66000, filed Dec. 9, 2016, and international patent application number PCT/US15/36802, filed on Jun. 19, 2015, each of which is entirely incorporated herein by reference.

In some examples, the printer includes one or more energy sources. The energy sources can be configured to generate one or more energy beams for transforming pre-transformed material and/or re-transforming transformed material. In some embodiments, the printer includes at least two energy sources (e.g., FIGS. 2, 221 and 222) configured to generate energy beams (e.g., FIGS. 2, 201 and 208). The energy beam(s) can be directed at a target surface. A target surface can include an exposed surface (e.g., FIG. 2, 231) of the material bed (e.g., FIG. 2,204) and/or a surface of the platform (e.g., FIG. 2,209). For example, the target surface can comprise an exposed surface of the pre-transformed material (e.g., FIG. 2, 208) (e.g., powder) and/or the transformed material (e.g., FIG. 2, 206). The energy beam(s) may have enough energy to transform (e.g., melt and/or sinter) the pre-transformed material (e.g., powder) and/or re-transform (e.g., re-melt and/or re-sinter) a previously transformed (e.g., hardened (e.g., solidified)) material of the material bed. The energy beam(s) may be directed by one or more optical elements (e.g., FIGS. 2, 214 and/or 220) disposed in an optical enclosure 241. In some cases, the optical element(s) comprise a galvanometer scanner (e.g., comprising one or more mirrors), a polygon, a mechanical stage (e.g., X-Y stage), a piezoelectric device, gimble, or any combination of thereof. The optical element(s) may direct the energy beam(s) through one or more optical windows (e.g., FIGS. 2, 215 and/or 235). In some cases, the energy source(s) comprise a laser, electron beam source, ion beam source, or any combination thereof. Examples of 3D printing systems (e.g., comprising energy source(s), energy beam(s), optical element(s) and optical window(s)), apparatuses, devices, components, controllers, software, and 3D printing processes can be found in U.S. patent application Ser. No. 15/435,128, filed on Feb. 16, 2017, international patent application number PCT/US17/18191, filed on Feb. 16, 2017, European patent application number EP17156707.6, filed on Feb. 17, 2017, international patent application number PCT/US17/64474, filed Dec. 4, 2017, and international patent application number PCT/US18/12250, filed Jan. 3, 2018, each of which is entirely incorporated herein by reference.

In some embodiments, the formation of the 3D object includes transforming (e.g., fusing, binding and/or connecting) the pre-transformed material (e.g., starting material such as a powder material) using an energy beam. The energy beam may be projected onto the starting material (e.g., disposed in the material bed), thus causing the pre-transformed material to transform (e.g., fuse). The pre-transformed or transformed material can absorb the energy from the energy source (e.g., energy beam, diffused energy, and/or dispersed energy), and as a result, a localized region of that pre-transformed or transformed material can increase in temperature (e.g., and at least partially transform). The energy beam may cause at least a portion of the pre-transformed material to transform from its present state of matter to a different state of matter. For example, the pre-transformed material may transform at least in part (e.g., completely) from a solid to a liquid state. The energy beam may cause at least a portion of the pre-transformed material to chemically transform. For example, the energy beam may cause chemical bonds to form or break. The chemical transformation may be an isomeric transformation. The transformation may comprise a magnetic transformation or an electronic transformation. The transformation may comprise coagulation of the material, cohesion of the material, or accumulation of the material. Transformation of the material may comprise connecting disconnected starting materials. For example, connecting various powder particles. The connection may comprise phase transfer, or chemical bonding. The connection may comprise fusing the starting material, e.g., sintering or melting the starting material.

In some embodiments, the methods described herein comprise repeating the operations of material deposition and material transformation operations to produce (e.g., print) a 3D object (or a portion thereof) by at least one 3D printing (e.g., additive manufacturing) method. For example, the methods described herein may comprise repeating the operations of depositing a layer of pre-transformed material and transforming at least a portion of the pre-transformed material to connect to the previously formed 3D object portion (e.g., repeating the 3D printing cycle), thus forming at least a portion of a 3D object. The transforming operation may comprise utilizing energy beam(s) to transform the material. In some instances, the energy beam is utilized to transform at least a portion of the material bed.

In some embodiments, the term “auxiliary support,” as used herein, generally refers to at least one feature that is a part of a printed 3D object, but not part of the requested, intended, designed, ordered, and/or final 3D object. Auxiliary support may provide structural support during and/or after the formation of the 3D object. The auxiliary support may be anchored to the manufacturing enclosure. For example, an auxiliary support may be anchored to the build platform (e.g., build platform such as a build plate), to the side walls of the material bed, to a wall of the manufacturing enclosure, to an object (e.g., stationary, or semi-stationary) within the manufacturing enclosure, or any combination thereof. The auxiliary support may be the build platform or the bottom of the manufacturing enclosure. The auxiliary support may enable the removal of energy from the 3D object (e.g., or a portion thereof) that is being formed. The removal of energy (e.g., heat) may be during and/or after the formation of the 3D object. Examples of auxiliary support comprise a fin (e.g., heat fin), anchor, handle, pillar, column, frame, footing, wall, build platform, or another stabilization feature. In some instances, the auxiliary support may be mounted, clamped, or situated on the build platform. The auxiliary support can be anchored to the build platform, to the sides (e.g., walls) of the build platform, to the manufacturing enclosure, to an object (stationary or semi-stationary) within the manufacturing enclosure, or any combination thereof. Sometimes, the generated 3D object may comprise one or more auxiliary supports. The auxiliary support may be suspended in the pre-transformed material (e.g., powder material). The auxiliary support may provide weight or stabilizer. The auxiliary support can be suspended in the material bed such as within the layer of pre-transformed material in which the 3D object (or a portion thereof) has been formed. The auxiliary support may touch the build platform. The auxiliary support may be suspended in the material bed and not touch (e.g., contact) the build platform. The auxiliary support may be anchored to the build platform.

In some examples, the generated 3D object(s) can be printed without auxiliary support in a material bed in which it/they are formed. In some examples, low overhanging feature and/or hollow cavities of the generated 3D object can be printed without (e.g., without any) auxiliary support. The low overhanging features may be shallow overhanging features with respect to an exposed surface of the material bed. The low overhanging features may form an angle of at most about 40 degrees (0), 35°, or 25° with the exposed surface of the material bed (or a plane parallel thereto). The printed 3D object can be devoid of auxiliary supports. The printed 3D object may be suspended (e.g., float anchorlessly) in the material bed (e.g., powder bed). The term “anchorlessly,” as used herein, generally refers to without, or in the absence of, an auxiliary anchor. In some examples, an object is suspended in a material bed anchorlessly without attachment to a support. For example, the object floats in the material bed. A portion of the printed 3D object can be devoid of auxiliary support. The portion of the 3D object may be suspended over a volume of the material bed. For example, a portion of the object defines an enclosed cavity which may be temporarily filled with powder material during a build process. The generated 3D object may be suspended in the layer of pre-transformed material (e.g., powder material). The pre-transformed material can offer support to the printed 3D object (or the object during its generation).

In some examples, the at least 3D object may be generated above a build platform, which at least one 3D object comprises auxiliary supports. In some examples, the auxiliary support(s) adhere (e.g., connect) to the build platform, e.g., the upper surface of the build platform). In some examples, the auxiliary supports of the printed 3D object may touch the build platform (e.g., the bottom of the manufacturing enclosure, the substrate, or the base. In some embodiments, the auxiliary supports are an integral part of the build platform. At times, auxiliary support(s) of the printed 3D object, do not touch the build platform. In any of the methods described herein, the printed 3D object may be supported only by the pre-transformed material within the material bed. Any auxiliary support(s) of the printed 3D object, if present, may be suspended adjacent to the build platform. Occasionally, the build platform may have a pre-hardened (e.g., pre-solidified) amount of material. Such pre-solidified material may provide support to the printed 3D object. At times, the build platform may provide adherence to the material. At times, the build platform does not provide adherence to the material. The build platform may comprise elemental metal, metal alloy, elemental carbon, or ceramic. The build platform may comprise a composite material (e.g., as disclosed herein). The build platform may comprise glass, stone, zeolite, or a polymeric material. The polymeric material may include a hydrocarbon or fluorocarbon. The build platform (e.g., base) may include Teflon. The build platform may include compartments for printing small objects. Small may be relative to the size of the manufacturing enclosure. The compartments may form a smaller compartment within the manufacturing enclosure, which may accommodate a layer of pre-transformed material.

In some examples, when the energy source is in operation, the material bed reaches a certain (e.g., average) temperature. The average temperature of the material bed can be an ambient temperature or “room temperature.” The average temperature of the material bed can be an average temperature during the operation of the energy (e.g., beam(s)). The average temperature of the material bed can be an average temperature during the formation of the transformed material, the formation of the hardened material, or the generation of the 3D object. The average temperature can be below or just below the transforming temperature of the material. Just below can refer to a temperature that is by at most about 1° C., 2° C., 3° C., 4° C., 5° C., 6° C., 7° C., 8° C., 9° C., 10° C., 11° C., or 20° C. below the transforming temperature. The average temperature of the material bed (e.g., pre-transformed material) can be by at most about 25° C. (degrees Celsius), 50° C., 100° C., 150° C., 200° C., 250° C., 300° C., 400° C., 500° C., 600° C., 700° C., 800° C., 900° C., 1000° C., 1200° C., 1400° C., 1600° C., 1800° C., or 2000° C. The average temperature of the material bed (e.g., pre-transformed material) can be at least about 20° C., 25° C., 50° C., 100° C., 150° C., 200° C., 250° C., 300° C., 400° C., 500° C., 600° C., 700° C., 800° C., 900° C., 1000° C., 1200° C., 1400° C., 1600° C., or 1800° C. The average temperature of the material bed (e.g., of the pre-transformed material therein) can be any temperature between the afore-mentioned material average temperatures. The temperature of the material bed can be conditioned (e.g., heated or cooled) before, during, or after forming (e.g., printing) the 3D object (e.g., hardened material). The material bed temperature can be controlled (e.g., substantially maintained) at a predetermined value. The temperature of the material bed can be monitored. The material temperature can be controlled manually and/or by a control system (e.g., such as any control system disclosed herein).

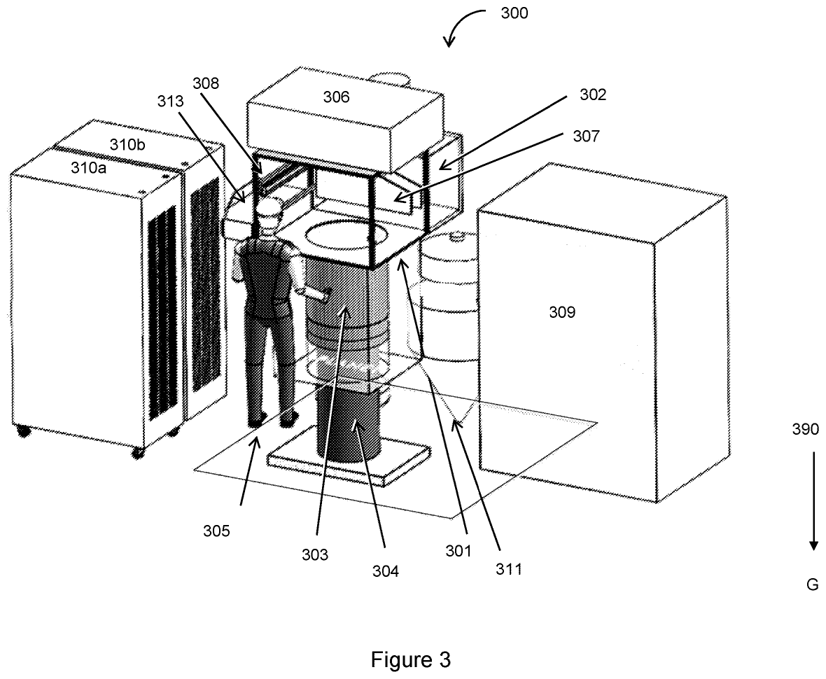

FIG. 3 shows an example of a 3D printing system 300 disposed in relation to gravitational vector 390 directed towards gravitational center G. The 3D printing system comprises processing chamber 301 coupled with an ancillary chamber (e.g., garage) 302 configured to accommodate a layer dispensing mechanism (e.g., recoater), e.g., in its resting (e.g., idle) position. The processing chamber is coupled with a build module 303 that extends 304 under a plane (e.g., floor) at which user 305 stands on (e.g., can extend undergrounds). The processing chamber may comprise a door (not shown) facing user 305. 3D printing system 300 comprises optical system enclosure 306 that can comprise an energy beam alignment system, e.g., comprising at least one optical array comprising at least one guidance system (e.g., scanner). A layer dispensing mechanism (not shown) may be coupled with framing 307 as part of a movement system that facilitate movement of the layer dispensing mechanism along the material bed and garage, e.g., in a reversible back-and-forth movement. The movement system comprises a translation inducer system, e.g., comprising a belt or a chain 308. 3D printing system 300 comprises a filter unit 309, heat exchangers 310a and 310b, pre-transformed material (e.g., powder) reservoir 311, and gas conveyance system (e.g., comprising gas inlets and gas inlet portions) disposed in enclosure 313. The filtering system may filter gas and/or pre-transformed material. The filtering system may be configured to filter debris, e.g., comprising byproduct(s) of the 3D printing.

In some embodiments, 3D printing system comprises a pre-transformed material (e.g., starting material such as powder) conveyor system (e.g., also referred to as “conveyance system” or “powder conveyance system”). The pre-transformed material conveyor system may be coupled with a processing chamber having a layer dispensing mechanism (e.g., recoater). Pre-transformed material (e.g., powder) from a reservoir (e.g., hopper) can be introduced into the layer dispensing mechanism disposed in the processing chamber. Once the layer dispensing mechanism dispenses a layer of pre-transformed material to layerwise form a material bed utilized for the three-dimensional printing, excess pre-transformed material may be attracted away from the material bed. In this process, excess pre-transformed material may be attracted away from the material bed using layer dispensing mechanism and introduced into separator (e.g., cyclone), and optionally to an overflow separator (e.g., cyclone). The pre-transformed material may undergo separation (e.g., cyclonic separation) in separator(s), and may be introduced into sieve(s), followed by gravitational flow into a lower reservoir (e.g., hopper). The separated and sieved pre-transformed material can be then delivered into separator(s), and into a reservoir that can deliver the pre-transformed material back into the layer dispensing mechanism. The separator may be coupled with sieve(s) instead of to the reservoir. The pre-transformed material conveyor system may comprise pumps (e.g., displacement pump and/or compressor pumps), and a temperature regulator (e.g., heater or radiator such as a radiant plane). The pre-transformed material conveyor system may comprise a venturi nozzle, for example, to facilitate suction of the pre-transformed material from the reservoir into separator(s). The pre-transformed material conveyance system can include a condensed gas source (e.g., a blower or a cylinder of condensed gas). The pre-transformed material conveyance system may include a heat exchanger. The pre-transformed material conveyance system may include one or more filters. The pre-transformed material conveyance system may operate at a positive pressure above ambient pressure external to the pre-transformed material conveyance system (e.g., above about one atmosphere). The gas conveyance system may be configured to circulate (e.g., recirculate) gas also in the processing chamber. The gas conveyance system may sweep debris (e.g., soot) away from the process area in which the 3D object is being printed. At times, a pressure differential is required to convey pre-transformed material from one compartment of the 3D printer to another. The pressure differential may be established via pressurizing or vacuuming one or more compartments. For example, pre-transformed material from the layer dispensing system to the recycling system (e.g., including the separator(s), sieve(s), and/or reservoirs) may be conveyed using (a) induced pressure differential among components, (b) pressure isolation of the components, and (c) induced pressure equilibration of components.

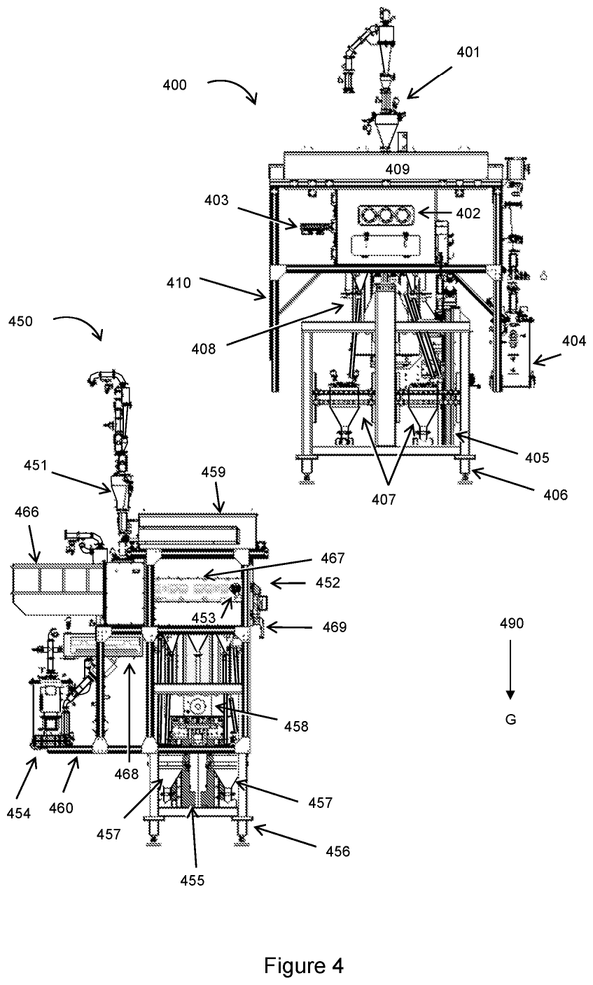

FIG. 4 shows in example 400 a front side example of a portion of a 3D printing system comprising a material reservoir 401 configured to feed pre-transformed material to a layer dispensing mechanism, and an optical system enclosure 409 configured to enclose, e.g., one or more optical system including scanner(s) and/or director(s) of at least one energy beam (e.g., laser beam) configured to transform the pre-transformed material into a transformed material to print one or more 3D object in a printing cycle. Example 400 of FIG. 4 shows processing chamber 402 having a primary door with three circular viewing windows and a secondary door, e.g., having a glove box type arrangement. Example 400 show a material reservoir 404 configured to accumulate a remainder pre-transformed material. The remainder may be from the layer dispensing mechanism, post 405 as part of a build platform assembly of build module 408, two material reservoirs 407 for accumulating a remainder of the material bed that did not form the 3D object, and actuator 403 configured to translate the layer dispensing mechanism to dispense a layer of pre-transformed material as part of a material bed. Supports 406 are planarly stationed in a first horizontal plane, which supports 406 and associated framing support one section of the 3D printing system portion 400 and framing 410 is disposed on a second horizontal plane higher than the first horizontal plane. FIG. 4 shows in 450 an example side view example of a portion of the 3D printing system shown in example 400, which side view comprises a material reservoir 451 configured to feed pre-transformed material to a layer dispensing mechanism (not shown), a manufacturing enclosure 459 enclosing an optical system (e.g., including scanners and/or directors) of at least one energy beam (e.g., laser beam) configured to transform the pre-transformed material into a transformed material to print one or more 3D object in a printing cycle. Example 450 of FIG. 4 shows an example of a processing chamber 452 having a door comprising handle 469 (as part of a handle assembly). 3D printing system portion 450 shows a material reservoir 454 configured to accumulate recycled remainder from the layer dispensing process to form a material bed and/or a remainder of the material bed that did not form one or more 3D objects during a printing cycle, and a portion of the material conveyance system 468 configured to convey the material to reservoir 454. The remainder material conveyed to reservoir 454 may be separated (e.g., sieved) before reaching reservoir 454. The example shown in 450 shows post 455 as part of a build platform assembly of build module 458, two material reservoirs 457 for accumulating a remainder of the material bed that did not form the 3D object, and actuator 454 configured to translate the layer dispensing mechanism to dispense a layer of pre-transformed material as part of a material bed, e.g., along railing 467 in processing chamber and into garage 466 in a reversible (e.g., back and forth) movement. Supports 456 are planarly stationed in a first horizontal plane, which supports 456 and associated framing support one section of the 3D printing system portion 450 and framing 460 is disposed on a second horizontal plane higher than the first horizontal plane. In the example shown in FIG. 4, the 3D printing system components is aligned with respect to gravitational vector 490 pointing towards gravitational center G.

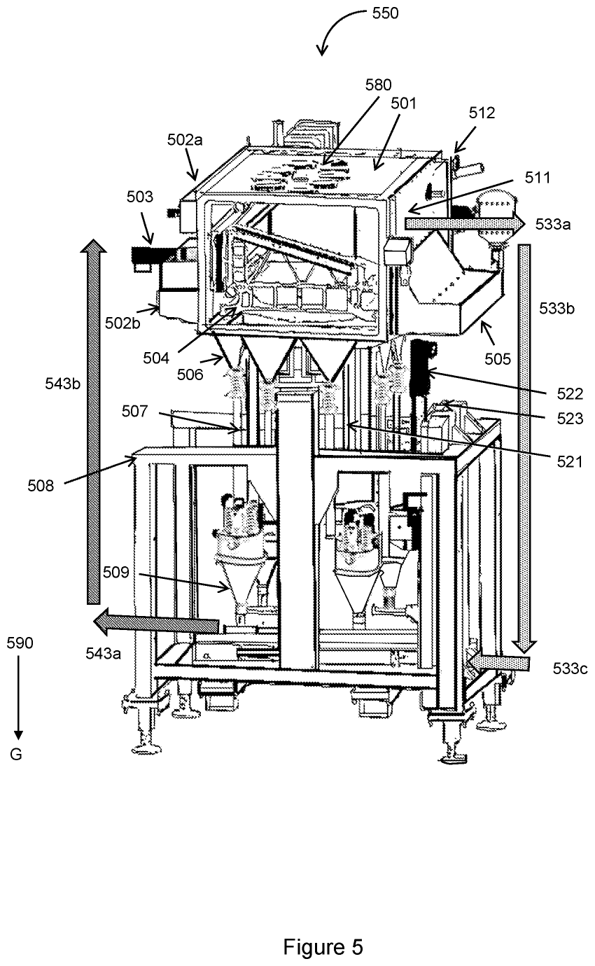

FIG. 5 shows a perspective view example of a portion of a 3D printing system including a processing chamber having a roof 501 in which eight optical windows 580 are disposed to each facilitate penetration of each of eight energy beam respectively into the interior space of processing chamber having side wall 511 comprising a gas exit port covering 505 coupled thereto. The processing chamber has two gas entrance port coverings 502a and 502b coupled with a wall opposing side wall 511. The opposing wall to wall 511 is coupled with actuator 503 configured to facilitate translation of a layer dispensing mechanism mounted on framing 504 above a base disposed adjacent to a floor of the processing chamber (e.g., the base can be flush with the floor), which framing is configured to translate reversibly back and forth in the processing chamber along railings. The processing chamber floor has slots through which remainder material can flow downwards towards gravitational center G along gravitational vector 590. The slots are coupled with funnels such as 506, which are connected by channels (e.g., pipes) such as 507 to material reservoir such as 509. The processing chamber is coupled with a build module 521 that comprises a substrate to which the base is attached, which substrate is configured to vertically translate with the aid of actuator 522 coupled with an elevator motion stage (e.g., supporting plate) 523 via a bent arm. The elevator motion stage 523 and its coupled components are supported by framing 508. An atmosphere (e.g., content and/or pressure) may be equilibrated between the material reservoirs 509 and the processing chamber via schematic channel (e.g., pipe) portions 533a-c. Remainder material in the material reservoirs may be conveyed via schematic channels (e.g., pipes) 543a-b to a material recycling system, e.g., at least in part for future use in printing and/or debris removal. The components of the 3D printing system are disposed relative to gravitational vector 590 pointing to gravitational center G.

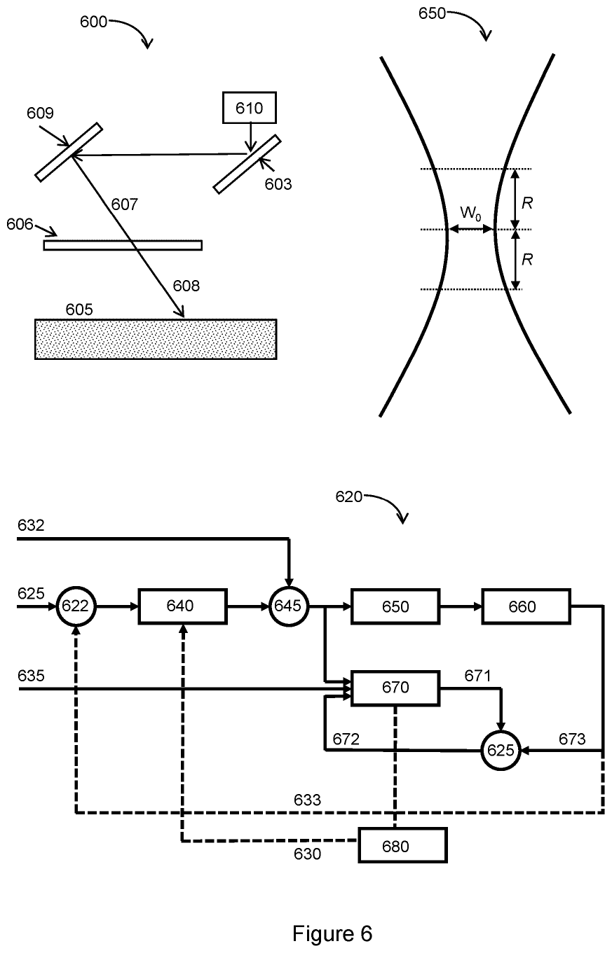

In some embodiments, the printer includes an optical system. The optical system may be used to control the one or more energy beams. The energy beams may comprise a single mode beam (e.g., Gaussian beam) or a multi-mode beam. The optical system may be coupled with or separate from the enclosure. The optical system may be enclosed in an optical enclosure (e.g., FIG. 2, 232). FIG. 6 shows in example 600 of an optical system in which an energy beam is projected from the energy source 610, and is deflected by two mirrors 603 and 609, and travels through an optical element 606 prior to reaching target 605 (e.g., an exposed surface of a material bed comprising a pre-transformed material and/or hardened or partially hardened material such as from a previous transformation operation). The optical system may comprise more than one optical element. In some cases, the optical element comprises an optical window (e.g., for transmitting the energy beam into the enclosure). In some embodiments, the optical element comprises a focus altering device, e.g., for altering (e.g., focusing or defocusing) an incoming energy beam (e.g., FIG. 6, 607) to an outgoing energy beam (e.g., FIG. 6, 608). The focus altering device may comprise a lens. In some embodiments, aspects of the optical system are controlled by one or more controllers of the printer. For example, one or more controllers may control one or more mirrors (e.g., of galvanometer scanners) that directs movement of the one or more energy beams in real time. Examples of 3D printing systems, apparatuses, devices (e.g., optical systems), components, controllers, software, and 3D printing processes can be found in U.S. patent application Ser. No. 15/435,128, filed on Feb. 16, 2017, international patent application number PCT/US17/18191, filed on Feb. 16, 2017, European patent application number EP17156707.6, filed on Feb. 17, 2017, international patent application number PCT/US17/64474, filed Dec. 4, 2017, and international patent application number PCT/US18/12250, filed Jan. 3, 2018, each of which is entirely incorporated herein by reference.

In some cases, the optical system modifies a focus of the one or more energy beams at the target surface. In some embodiments, the energy beam is (e.g., substantially) focused on the target surface. In some embodiments, the energy beam is defocused at the target surface. An energy beam that is focused on the target surface may have a (e.g., substantially) minimum spot size at the target surface. An energy beam that is defocused at the target surface may have a spot size at the target surface that is (e.g., substantially) greater than the minimum spot size, for example, by a pre-determined amount. For example, a Gaussian energy beam that is defocused at the target surface can have spot size that is outside of a Rayleigh distance from the energy beam's focus (also referred to herein as the beam waist). FIG. 6 shows in example 650 example profile of a (e.g., Gaussian) beam as a function of distance. The target surface of a focused energy beam may be within a Rayleigh distance (e.g., FIG. 6, R) from the beam waist (e.g., FIG. 6, Wo).

In some cases, one or more controllers control the operation of one or more components. For example, one or more controllers may control one or more aspects (e.g., movement and/or speed) of a layer forming apparatus. One or more controllers may control one or more aspects of an energy source (e.g., energy beam power, scan speed and/or scan path). One or more controllers may control one or more aspects of an energy beam optical system (e.g., energy beam scan path and/or energy beam focus). One or more controllers may control one or more operations of a gas flow system (e.g., gas flow speed and/or direction). In some embodiments, one or more controllers controls aspects of multiple components or systems. For example, a first controller can control aspects of the energy source(s), a second controller can control aspects of a layer forming apparatus(es), and a third controller can control aspects of a gas flow system. In some embodiments, one or more controller controls aspect of one component or system. For example, multiple controllers may control aspects of an optical system. For instance, a first controller can control the path of the one or more energy beams, a second controller may control scan speed of the one or more energy beams, and a third controller may control a focus of the one or more energy beams. As another example, multiple controllers may control aspects of an energy source. For instance, a first controller can control the power of one or more energy beams, a second controller may control pulsing (e.g., pulse versus continuous, or pulse rate) of the one or more energy beams, and a third controller may control a power profile over time (e.g., ramp up and down) one or more energy beams. At times, the first controller, second controller, and the third controller are the same controller. At times, at least two of the first controller, second controller, and the third controller are different controllers. Any combination of one or more controllers may control aspects of one or more components or systems of a printer. The one or more controllers may control the operations before, during, and/or after the printing, or a portion of the printing (irradiation operation).

In some instances, aspects of the printer are controlled by one or more controllers. The controller(s) can include (e.g., electrical) circuitry that is configured to generate output (e.g., voltage signals) for directing controlling one or more aspects of the apparatuses (or any parts thereof) described herein. FIG. 6 shows a schematic example of a (e.g., automatic) control system (e.g., comprising a controller) 620 that is programmed or otherwise configured to facilitate formation of one or more 3D objects. The control system (e.g., FIG. 6, 620) can comprise a subordinate-controller 640 for controlling formation of at least one 3D object (e.g., FIG. 6, 650), one or more sensors (e.g. temperature sensor) (e.g., FIG. 6, 660), one or more control-models (e.g., FIG. 6, 670) for the physical process of 3D printing. The control system may utilize one or more loop schemes (e.g., open loop, feed-forward loop and/or feedback loop). In the example of FIG. 6, the controller optionally includes feedback control loop control schemes 630 and/or 633. The subordinate-controller may be an internal-controller. The subordinate-controller can be a second controller as part of the control system. The subordinate-controller can be a linear controller. The control system (e.g., FIG. 6, 620) may be configured to control (e.g., in real time during at least a portion of the 3D printing) a controllable property comprising: (i) an energy beam power (e.g., delivered to the material bed), (ii) temperature at a position in the material bed (e.g., on the forming 3D object), (iii) energy beam speed, (iv) energy beam power density, (v) energy beam dwell time, (vi) energy beam irradiation spot (e.g., on the exposed surface of the material bed), (vii) energy beam focus (e.g., focus or defocus), or (viii) energy beam cross-section (e.g., beam waist). The controllable property may be a control variable. Control may be to maintain a target parameter (e.g., temperature) of one or more 3D objects being formed. The target parameter may vary in time (e.g., in real time) and/or in location. The location may comprise a location at the exposed surface of the material bed. The location may comprise a location at the top surface of the (e.g., forming) 3D object. The target parameter may correlate to the controllable property. The (e.g., input) target parameter may vary in time and/or location in the material bed (e.g., on the forming 3D object). The subordinate-controller may receive a pre-determined power per unit area (of the energy beam), temperature, and/or metrological (e.g., height) target value. For example, the subordinate-controller may receive a target parameter (e.g., FIG. 6, 625) (e.g. temperature) to maintain at least one characteristic of the forming 3D object (e.g., dimension in a direction, and/or temperature). The control system can receive multiple (e.g., three) types of target inputs: (i) energy beam power (e.g., FIG. 6, 632) (which may be user defined), (ii) temperature (e.g., FIG. 6, 625), and (iii) geometry (e.g., FIG. 6, 635). The geometry may comprise geometrical object pre-print correction. The geometric information may derive from the 3D object (or a correctively deviated (e.g., altered) model thereof). The geometry may comprise geometric information of a previously printed portion of the 3D object (e.g., comprising a local thickness below a given layer, local build angle, proximity to an edge on a given layer, or proximity to layer boundaries). The geometry may be an input to the control system (e.g., via an open loop control scheme). Some of the target values may be used to form 3D printing instructions for generating the 3D object (e.g., FIG. 6, 650). The printing instructions may be dynamically adjusted in real time. The control system may monitor (e.g., continuously) one or more signals from one or more sensors (e.g., FIG. 6, 660). For example, the control system may monitor the energy beam power, temperature of a position in the material bed, and/or metrology (e.g., height) of a position in the material bed. The position in the material bed may be of the forming 3D object. The monitor may be continuous or discontinuous. The monitor may be in real-time during the 3D printing. The monitor may be using the one or more sensors. The printing instructions may be dynamically adjusted in real time (e.g., using the signals from the one or more sensors). A variation between the target parameter and the sensed parameter may be used to estimate an error in the value of that parameter (e.g., FIG. 6, 622). The variation (e.g., error) may be used by the subordinate-controller (e.g., FIG. 6, 640) to adjust the printing instructions. The control system may control (e.g., continuously) one or more parameters (e.g., in real time). The control system may use historical data (e.g., for the parameters). The historical data may be of previously printed 3D objects, or of previously printed layers of the 3D object. The control-model may comprise free parameters which may be estimated using a characterization process. The characterization process may be before, during and/or after the 3D printing. The control-model may be wired to the control system. The control model can be configured into the control system (e.g., before and/or during the 3D printing). Configured may comprise built, constructed, designed, patterned, or arranged. The hardware of the control system may comprise the control-model. The control-model may be linear or non-linear. For example, the control-model may be non-linear. The control-model may comprise linear or non-linear modes.

In some cases, a control-model is configured to predict and/or estimate one or more physical parameters (e.g., FIG. 6, 671) of the 3D object being formed (e.g., in real time). In some embodiments, the control-model is a reduced form of the 3D model of the requested 3D object. In some embodiments, the control-model is a simplified 3D model compared to the complete 3D model of the requested 3D object. The physical parameters may comprise shape. For example, the control-model may comprise the shape (e.g., geometry) of the 3D object. The control-model may be used to adjust the 3D printing. The control-model may comprise a simulation. The simulation may comprise an imitation of a real-world process (e.g., 3D printing) over time. The simulation may comprise finite element analysis. For example, the control-model may comprise a thermal and/or mechanical (e.g., elastic and/or plastic) simulation. For example, the control-model may comprise thermo-mechanical (e.g., thermo-elastic and/or thermo-plastic) simulation. The simulation may comprise the material(s) of the forming 3D object (e.g., material(s) in the material bed). For example, the simulation may comprise the material properties of the requested 3D object. The simulation and/or control-model may be adjusted (e.g., using the control loop) using one or more measured parameters. The simulation and/or control-model may be adjusted in real-time. The control-model may output an estimation of the parameter. The simulation and/or control-model may use an input from the one or more sensors (e.g., power, temperature, and/or metrology sensors). The control-model can comprise one or more free parameters. The one or more free parameters can be optimized in real time (e.g., using one or more sensor signals). The control system may comprise an internal-state-system that provides an estimate of an internal state of the 3D printer and/or 3D printing. The internal state can be derived from one or more measurements of the control variable and/or input parameters. The internal-state-system may be implemented using a computer. The internal-state-system may comprise a state-observer. The control system may comprise a state-observer. The control-model can be a state-observer-model. The control system may comprise a reconfigurable firm-ware (e.g., flash memory). The control system may comprise a microprocessor. The control system may comprise a (e.g., programmable and/or reconfigurable) circuit. The estimated parameter may be compared (e.g., FIG. 6, 625) with the measured parameter (e.g., FIG. 6, 673). The comparison may be used to alter (e.g., FIG. 6, 672) the control model. The control-model may dynamically be adjusted in real time. The simulation may be dynamically adjusted in real-time. The prediction of the parameter may be done offline (e.g. predetermined) and/or in real-time (e.g., during the 3D printing). The control-model may receive the sensed parameter(s) value(s). The control-model may use the sensed parameter(s) value(s) for a prediction and/or adjustment of at least one target parameter. For example, the control-model may use geometric information (e.g., FIG. 6, 635) associated with the requested and/or forming 3D object. The control model may set up a feedback control loop (e.g., FIG. 6, 630) to adjust one or more target parameters to achieve convergence (e.g., with the requested 3D object). The feedback loop(s) control may comprise one or more comparisons with an input parameter (e.g., FIG. 6, 622) and/or threshold value (e.g., FIG. 6, 680). Real time may be during (i) formation of at least one 3D object, (ii) a layer within the 3D object, (iii) a dwell time of an energy beam along a path, (iv) a dwell time of an energy beam along a hatch line, and/or (v) a dwell time of an energy beam forming a melt pool. The one or more forming 3D objects can be generated (e.g., substantially) simultaneously, or sequentially. The one or more 3D objects can be formed in a (e.g., single) material bed. The subordinate-controller (e.g., FIG. 6, 640) may output one or more parameters as part of the 3D printing instructions. The output of the subordinate-controller may be based at least in part on one or more parameter input (e.g., of a different type). For example, the subordinate-controller may receive a temperature input and output a power parameter. The output parameter may be compared with the same type of parameter that was input. For example, the output power parameter may be compared with (e.g., FIG. 6, 645) a power input to generate the printing instructions for the portion of the 3D object. The comparison may be a dynamic comparison in real time. The comparison may be prior or subsequent to the 3D printing. The one or more controllers (e.g., as part of the control system) may be implemented in a processor hardware (e.g., GPU, CPU, or FPGA). Examples of 3D printing systems, apparatuses, devices, components, controllers, software, and 3D printing processes can be found in international patent application number PCT/US16/59781, filed on Oct. 31, 2016, U.S. patent application Ser. No. 15/435,128, filed on Feb. 16, 2017, international patent application number PCT/US17/18191, filed on Feb. 16, 2017, and European patent application number EP17156707.6, filed on Feb. 17, 2017, each of which is entirely incorporated herein by reference.

At times, the methods described herein are performed in a manufacturing enclosure (e.g., container, processing chamber, and/or build module). One or more 3D objects can be formed (e.g., generated, and/or printed) in the manufacturing enclosure (e.g., simultaneously, and/or sequentially). The enclosure (e.g., manufacturing enclosure and/or optical enclosure) may have a predetermined and/or controlled (e.g., maintained) pressure. The enclosure may have a predetermined and/or controlled atmosphere, e.g., during the 3D printing. The control may be manual or via a control system. The atmosphere may comprise at least one gas.

In some embodiments, the enclosure (e.g., manufacturing enclosure and/or optical enclosure) comprises an atmosphere having an ambient pressure (e.g., 1 atmosphere), or positive pressure above ambient pressure in an ambient environment external to the enclosure. The atmosphere may have a negative pressure (i.e., vacuum). Different (e.g., compartmentalized) portions of the enclosure may have different atmospheres. The different atmospheres may comprise different gas compositions. The different atmospheres may comprise different atmosphere temperatures. The different atmospheres may comprise ambient pressure (e.g., 1 atmosphere), negative pressure (i.e., vacuum) or positive pressure. The different portions of the manufacturing enclosure may comprise the processing chamber, build module, or enclosure volume excluding the processing chamber and/or build module. The vacuum may comprise pressure below 1 bar, below 1 atmosphere, or below ambient pressure in the ambient environment. The positively pressurized environment may comprise pressure above 1 bar, above 1 atmosphere, or above the ambient pressure. In some cases, the chamber pressure can be (e.g., substantially) standard atmospheric pressure. The pressure may be measured at an ambient temperature, e.g., room temperature such as 20° C., or 25° C.

In some embodiments, the enclosure (e.g., manufacturing enclosure and/or optical enclosure) comprises an atmosphere. The atmosphere within the enclosure may comprise a positive pressure above ambient pressure in an ambient environment external to the enclosure. The atmosphere within the enclosure may be different than the atmosphere outside the enclosure. At times, a differential atmosphere (e.g., a difference in atmospheres between the inside of the enclosure and the outside of the enclosure) depends in part on the processing condition of the three-dimensional printing. Processing conditions can include, for example, (i) a composition of the pre-transformed material, (ii) an internal temperature of the material bed during the three-dimensional processing, (iii) a number of energy beams (e.g., an average number of energy beams) transforming (e.g., incident on) the target surface during the three-dimensional processing, (iv) an amount of contamination by debris during the three-dimensional processing, (v) temperature in the material bed during 3D printing, (vi) temperature in the processing chamber during the printing, (vii) amount of energy supplied by the energy beams to the material bed, or (vii) any combination thereof. For example, a differential atmosphere between the interior of the enclosure (e.g., within the processing chamber) and an ambient environment external to the enclosure may depend at least in part on an average number of energy beams utilized during the three-dimensional process.

In some embodiments, the enclosure (e.g., manufacturing enclosure and/or optical enclosure) includes an atmosphere that is greater than (e.g., at a positive pressure with respect to) an ambient atmosphere external to the enclosure. The atmosphere within the enclosure may comprise a positive pressure of at least about 20 Kilo Pascal (KPa), 18 KPa, 16 KPa, 14 KPa, 12 KPa, 10 KPa, or SKPa above ambient atmospheric pressure, e.g., above 101 KPa. The pressure in the enclosure can be at a range between any of the afore-mentioned pressure values above atmospheric pressure, e.g., from about 5 KPa to about 20 KPa, the values representing a pressure difference above atmospheric pressure, e.g., above 101 KPa. The pressure can be measured by a pressure gauge. The pressure can be measured at ambient temperature (e.g., room temperature (R.T.)). In some cases, the chamber pressure can be standard atmospheric pressure. The pressure may be measured at an ambient temperature (e.g., room temperature such as about 20° C., or about 25° C.). The composition of the atmosphere within the enclosure may comprise any one or more of the gases described herein, for example, clean dry air (CDA), argon, and/or nitrogen. The gas may comprise a reactive agent (e.g., comprising oxygen or humidity). The atmosphere may comprise a v/v percent of the reactive agent (gas) of at most about 0.05%, 0.1%, 0.2%, 0.3%, 0.4%, 0.5%, 0.6%, 0.7%, 0.8%, 0.9%, 1%, 2%, 3%, 4%, or 5%, at ambient pressure (e.g., and ambient temperature). The atmosphere may comprise any percent of the reactive agent (gas) between the aforementioned percentages of hydrogen gas. The enclosure may comprise a gas flow, e.g., before, after, and/or during three-dimensional printing. The gas flow within the enclosure may comprise at least about 150 liters per minute (Umin), 300 Umin, 500 Umin, 750 Umin, or 1200 Umin. The gas flow within the enclosure may comprise any value between the aforementioned values, for example, from about 150 Umin to about 1200 Umin.

In some embodiments, the enclosure (e.g., manufacturing enclosure and/or optical enclosure) includes an atmosphere. The enclosure may comprise a (e.g., substantially) inert atmosphere. The atmosphere in the enclosure may be (e.g., substantially) depleted by one or more gases present in the ambient atmosphere. The atmosphere in the enclosure may include a reduced level of one or more gases relative to the ambient atmosphere. For example, the atmosphere may be substantially depleted, or have reduced levels of water (i.e., humidity), oxygen, nitrogen, carbon dioxide, hydrogen sulfide, or any combination thereof. The level of the depleted or reduced level gas may be at most about 0.1 parts per million (ppm), 1 ppm, 3 ppm, 10 ppm, 50 ppm, 100 ppm, 500 ppm, 1000 ppm, 3000 ppm, or 5000 ppm volume by volume (v/v). The level of the depleted or reduced level gas may be at least about 1 ppm, 10 ppm, 50 ppm, 100 ppm, 500 ppm, 1000 ppm, or 5000 ppm (v/v). The level of the oxygen gas may be at most about 1 ppm, 10 ppm, 50 ppm, 100 ppm, 500 ppm, 1000 ppm, or 2000 ppm (v/v). The level of the water vapor may be at most about 1 ppm, 10 ppm, 50 ppm, 100 ppm, 500 ppm, 700 ppm, 800 ppm, 900 ppm, or 1000 ppm (v/v). The level of the gas (e.g., depleted, or reduced level gas, oxygen, or water) may be between any of the afore-mentioned levels of gas. The atmosphere may comprise air. The atmosphere may be inert. The atmosphere in the enclosure (e.g., processing chamber) may have reduced reactivity (e.g., be non-reactive) as compared to the ambient atmosphere external to the processing chamber and/or external to the printing system. The atmosphere may have reduced reactivity with the material (e.g., the pre-transformed material deposited in the layer of material (e.g., powder) or with the material comprising the 3D object), which reduced reactivity is compared to the reactivity of the ambient atmosphere. The atmosphere may hinder (e.g., prevent) oxidation of the generated 3D object, e.g., as compared to the oxidation by an ambient atmosphere external to the 3D printer and/or processing chamber. The atmosphere may hinder (e.g., prevent) oxidation of the pre-transformed material within the layer of pre-transformed material before its transformation, during its transformation, after its transformation, before its hardening, after its hardening, or any combination thereof. The atmosphere may comprise an inert gas. For example, the atmosphere may comprise argon or nitrogen gas. The atmosphere may comprise a Nobel gas. The atmosphere can comprise a gas selected from the group consisting of argon, nitrogen, helium, neon, krypton, xenon, hydrogen, carbon monoxide, and carbon dioxide. The atmosphere may comprise hydrogen gas. The atmosphere may comprise a safe amount of hydrogen gas. The atmosphere may comprise a v/v percent of hydrogen gas of at least about 0.05%, 0.1%, 0.2%, 0.3%, 0.4%, 0.5%, 0.6%, 0.7%, 0.8%, 0.9%, 1%, 2%, 3%, 4%, or 5%, at ambient pressure (e.g., and ambient temperature). The atmosphere may comprise a v/v percent of hydrogen gas of at most about 0.05%, 0.1%, 0.2%, 0.3%, 0.4%, 0.5%, 0.6%, 0.7%, 0.8%, 0.9%, 1%, 2%, 3%, 4%, or 5%, at ambient pressure (e.g., and ambient temperature). The atmosphere may comprise any percent of hydrogen between the afore-mentioned percentages of hydrogen gas. The atmosphere may comprise a v/v hydrogen gas percent that is at least able to react with the material (e.g., at ambient temperature and/or at ambient pressure), and at most adhere to the prevalent work-safety standards in the jurisdiction (e.g., hydrogen codes and standards). The material may be the material within the layer of pre-transformed material (e.g., powder), the transformed material, the hardened material, or the material within the 3D object. Ambient refers to a condition to which people are generally accustomed. For example, ambient pressure may be about one (1) atmosphere.

In some embodiments, material utilized in the 3D printing undergoes passivation, e.g., using a passivation system. A passivation system may comprise (A) an in-situ passivation system (e.g., to passivate filtered debris and/or any other gas borne material before their disposal), (B) an ex-situ passivation system, or (C) a combination thereof. The passivation system may control a level of the oxidizing agent below a threshold. The oxidizing agent in the oxidizing mixture (e.g., oxygen) may be kept below a threshold (e.g., below 2000 ppm), e.g., by using one or more controllers such as the control system disclosed herein.

In some embodiments, the gas in the gas conveyance system and/or enclosure comprises a robust gas. The robust gas may comprise an inert gas, e.g., enriched with reactive agent(s). The robust gas may comprise argon or nitrogen. At least one reactive agent in the robust gas may be in a concentration below that present in the ambient atmosphere external to the gas conveyance system and/or enclosure. The reactive agent(s) may comprise water or oxygen. The robust gas (e.g., gas mixture) may be more inert than the gas present in the ambient atmosphere. The robust gas may be less reactive than the gas present in the ambient atmosphere. Less reactive may be with debris, and/or pre-transformed material, e.g., during and/or after the printing. In some embodiments, humidity levels and/or oxygen levels in at least a portion of the enclosure (e.g., processing chamber, ancillary chamber, and/or build module) can be regulated such that an oxygenation and/or humidification of powder in the powder conveyance system is controlled. Oxygenation and/or humidification levels of recycled pre-transformed material (e.g., recycled powder material) can be about 5 parts per million (ppm) to about 1500 ppm. The gas composition of the chamber can contain a level of oxygen that is at most about 4000 parts per million (ppm), 3000 ppm, 2000 ppm, 1500 ppm, 1000 ppm, 500 ppm, 400 ppm, 100 ppm, 50 ppm, 10 ppm, or 5 ppm. The gas composition of the chamber can contain an oxygen level between any of the afore-mentioned values (e.g., from about 4000 ppm to about 5 ppm, from about 2000 ppm to about 500 ppm, from about 1500 ppm to about 500 ppm, or from 500 ppm to about 50 ppm). Oxygenation and/or humidification levels of pre-transformed material can be about zero ppm. For example, oxygen content in pre-transformed material can be about 0 weight percent (wt %), 0.1 wt %, 0.25 wt %, 0.3 wt %, 0.5 wt %, 0.75 wt %, 1.0 wt %, or more. At times, atmospheric conditions can, in part, influence the flowability of pre-transformed material (e.g., powder material) from the layer dispensing mechanism. A dew point of an internal atmosphere of a manufacturing enclosure (e.g., of the processing chamber) can be (I) below a level in which the powder particles absorb water such that they become reactive under condition of 3D printing process(es) and/or sufficient to cause measurable defects in a 3D object printed from the powder particles and (II) above a level of humidity below which the powder agglomerates, (e.g., electrostatically). In some embodiments, conditions (I) and/or (II) may depend in part on a type of powder material and/or on processing condition(s) of the 3D printing process(es). The gas composition of the chamber can contain a level of humidity that corresponds to a dew point of at most about −10° C., −15° C., −20° C., −25° C., −30° C., −35° C., −40° C., −50° C., −60° C., or −70° C. The gas composition of the chamber can contain a level of humidity that correspond to a dew point of between any of the aforementioned values, e.g., from about −70° C. to abokilopascals60° C. to about −10° C. or from about −30° C. to about −20° C. A dew point of an internal atmosphere of the enclosure (e.g., of the processing chamber) can be from about −80° C. to about −30° C., from about −65° C. to about −40° C., or from about −55° C. to about −45° C., at an atmospheric pressure of at least about 10 kilo-Pascals (kPa), about 12 kPa, about 14 kPa, about 16 kPa, about 18 kPa, about 20 kPa above ambient pressure external to the enclosure. A dew point of an internal atmosphere of the enclosure can be any value within or including the afore-mentioned values. Examples of gas conveyance system and components (including control components), in-situ passivation systems, controlled oxidation methods and systems, 3D printing systems, control systems, software, and related processes, can be found in International Patent Applications Serial Nos. PCT/US17/60035 and PCT/US21/35350, each of which is incorporated herein by reference in its entirety.

In some embodiments, a 3D printing system includes, or is operationally coupled with, one or more gas recycling systems. The gas recycling system can be at least a portion of the gas conveyance system. The processing chamber may include gas inlet(s) and gas outlet(s). The gas recycling system can be configured to recirculate the flow of gas from gas outlet(s) back into processing chamber via the gas inlet(s). Gas flow through a channel exiting a gas outlet can include solid and/or gaseous contaminants such as debris (e.g., soot). A filtration system can be configured to filter out at least some of the solid and/or gaseous contaminants, thereby providing a clean gas (e.g., cleaner than gas flow through channel exiting the gas outlet). The filtration system can include one or more filters. The filters may comprise physical filters or chemical filters. The clean gas exiting the filtering mechanism (also herein “filtration system”) can be under lower pressure relative to the incoming gas pressure into the filtering mechanism. The lower pressure and the pressure of the incoming gas pressure may be above ambient pressure external to the 3D printing system. The clean gas can be directed through a pump to regulate (e.g., increase) its relative pressure prior to entry to the processing chamber. Clean gas with a regulated pressure that exits the pump can be directed through one or more sensors. The one or more sensors may comprise a flow meter, which can measure the flow (e.g., pressure) of the pressurized clean gas. The one or more sensors may comprise temperature, humidity, oxygen sensors, or any other sensor disclosed herein. In some cases, the clean gas can have an ambient pressure or higher. The higher pressure may provide a positive pressure within the processing chamber (see example values of positive pressure described herein). A first portion of the clean gas can be directed through at least one inlet of a gas inlet portion of the enclosure (e.g., manufacturing enclosure and/or optical enclosure), while a second portion of the clean gas can be directed to first and/or second window holders that provide gas purging of optical window areas, as described herein. That is, the gas recycling system can provide clean gas to provide a primary gas flow for the 3D printing system, as well as a secondary gas flow (e.g., window purging). In some embodiments, the pressurized clean gas is further filtered through a filter prior to reaching one or both of the window holders. In some embodiments, the one or more filters (e.g., as part of one or more filters and/or a filtration system) are configured to filter out particles having nanometer-scale (e.g., about 10 nm to about 500 nm) diameters. In some embodiments, the gas recycling system may provide clean gas to a recessed portion of the enclosure. In some embodiments, gas flow from the recessed portion of the enclosure can be directed through the gas recycling system. In some embodiments, gas flow from the recessed portion can be directed through one or more filters of a filtration system. In some embodiments, the gas recycling system provides clean gas directed to first and/or second window holders.

In some embodiments, the 3D printing system has various components. 3D printing system may comprise a manufacturing enclosure, a gas conveyance system, an optical system, and an energy source. The manufacturing enclosure may comprise a processing chamber and a build module. The processing chamber may or may not be connected to the build module. In an example, the build module is reversibly connected (e.g., during the printing) and disconnected (e.g., after the printing) from the manufacturing enclosure. The 3D printing system may comprise the optical system enclosure and the energy source. The optical system enclosure may be operatively coupled with at least one energy source. The optical system enclosure comprises various components including the optical system (e.g., scanner). The optical system can translate the energy beam along a path, which the energy beam travels through the optical windows into the manufacturing enclosure. The 3D printing system may comprise one or more energy beams and respective optical systems and optical windows. The manufacturing enclosure (e.g., processing chamber) may comprise one or more (i) gas inlets and (ii) gas outlets. The 3D printing system may comprise the gas conveyance system. The gas conveyance system may be connected to the manufacturing enclosure. One end of the gas conveyance system may be connected to the gas outlets, and the other end of the gas conveyance system may be connected to (i) the gas inlets, (ii) optical windows, and/or (iii) the optical system. The gas conveyance system may comprise various components comprising filter, gas line, discharge container, pump, gas enriching system, temperature conditioning system, or valve. Each of the components may be singular or plural. Gas egressed (e.g., expelled) from the enclosure (e.g., over pressured gas above a threshold) may be ingressed (e.g., introduced) into the filter, the enclosure being the manufacturing enclosure and/or the optical enclosure. The filter may be configured to facilitate streaming gas with a higher degree of purity, such as a HEPA filter. Debris included in the egressed gas from the manufacturing enclosure can be removed with the filter. The debris may be collected in the discharge container. The egressed gas stream from the enclosure (e.g., manufacturing enclosure and/or optical enclosure) may split and diverted to (i) the pump in the gas conveyance system and/or (ii) an exhaust location. The egressed gas from the enclosure may be (i) ingressed into the pump and/or (ii) egressed to the exhaust location. The exhaust location can comprise an ambient atmosphere or a reservoir (e.g., pressure reservoir). The pump may pressurize the gas passing through it. In an example, a portion of the filtered gas from the filter is ingressed into the pump and pressurized until the pressure of the gas conveyance system reaches its maximum. The rest of the filtered gas may be egressed to the exhaust location. The gas conveyance system may comprise one or more valves. The one or more valves may comprise valves located (i) upstream of the pump or (ii) upstream of the exhaust location. “Upstream” are based on the direction of the gas flow. The valves may control (i) the gas flow direction (e.g., to the pump and/or to the exhaust location), and/or (ii) the gas flow rate at each direction. In an example, the gas conveyance system may comprise valve(s) (e.g., an outlet valve assembly) located upstream of the exhaust location. The outlet valve assembly may comprise one or more valves, e.g., proportional valve(s) and/or discrete valves. The number of the valves of the outlet valve assembly may depend, e.g., on the pressure difference between the gas conveyance system and the exhaust location. The gas conveyance system comprises a gas enriching system. The gas enriching system may be connected in series or in parallel with the pump. The gas enriching system can enrich the gas with controlled level of a reactive agent. The reactive agent may comprise oxygen or humidity. The gas enriching system can enrich the gas with controlled level of a reactive agent. In an example, the gas enriching system comprises a humidity enriching system, e.g., enriching the gas flow with a controlled level of humidity. In an example, the gas enriching system is configured to enrich the gas flow with oxygen, e.g., with a controlled level of oxygen. One or more valves may be located (i) upstream of the gas enriching system and/or (ii) downstream of the gas enriching system. “Upstream” and “downstream” are based on the gas flow direction. The gas conveyance system may comprise a temperature conditioning system. The temperature conditioning system (e.g., cooler) may control (e.g., drop) the temperature of the gas flow.

In some embodiments, the 3D printing system may comprise a control system. The control system may comprise one or more controllers. The control system may comprise, or be operatively coupled with, one or more devices, apparatuses, and/or systems of the 3D printing system, including any component of the device(s), apparatuses(s), and/or system(s). The controllers or control mechanisms (e.g., comprising a computer system) may be programmed to implement methods of the disclosure.

In some embodiments, the 3D printer comprises a controller. The controller may monitor and/or direct (e.g., physical) alteration of the operating conditions of the apparatuses, software, and/or methods described herein. The controller may be a manual or a non-manual controller. The controller may be an automatic controller. The controller may operate upon request. The controller may be a programmable controller. The controller may be programed. The controller may comprise a processing unit (e.g., CPU or GPU). The controller may receive an input (e.g., from a sensor). The controller may deliver an output. The controller may be part of a control system comprising multiple controllers. The controller may receive multiple inputs. The controller may generate multiple outputs. The controller may be a single input single output controller (SISO) or a multiple input multiple output controller (MIMO). The controller may interpret the input signal received. The controller may acquire data from the one or more sensors. Acquire may comprise receive or extract. The data may comprise measurement, estimation, determination, generation, or any combination thereof. The controller may comprise feedback control. The controller may comprise feed-forward control. The control may comprise on-off control, proportional control, proportional-integral (PI) control, or proportional-integral-derivative (PIO) control. The control may comprise open loop control, or closed loop control scheme(s). The controller may comprise a closed loop control scheme. The controller may comprise an open loop control scheme. The controller may utilize one or more wired and/or wireless networks for communication, e.g., with other controllers or devices, apparatuses, or systems of the 3D printing system and its components. For example, wired ethernet technologies, e.g., a local area networks (LAN). For example, wireless communication technologies, e.g., a wireless local area network (WLAN). The controller may utilize one or more control protocols for communication, for example, with other controller(s) or one or more devices, apparatuses, or systems of the 3D printing system or any of its components. Control protocols can comprise one or more protocols of an internet protocol suite, e.g., transmission control protocol (TCP) or transmission control protocol/internet protocol (TCP/IP). Control protocols can comprise one or more serial communication protocols. Control protocols can comprise one or more of controller area networks or another message-based protocol, e.g., for communication with microcontrollers and devices. Control protocols can interface with one or more serial bus interfaces for communication with the 3D printing system and its components. The controller may comprise a user interface. The user interface may comprise a keyboard, keypad, mouse, touch screen, microphone, speech recognition package, camera, imaging system, or any combination thereof. The outputs may include a display (e.g., screen), speaker, or printer. Examples of controller, control protocols, control systems, 3D printing systems, apparatuses, devices, and any of their components, and 3D printing processes can be found in International Patent Application Serial No. PCT/US17/18191, filed Feb. 16, 2017, which is incorporated herein by reference in their entirety.

Control may comprise regulate, modulate, adjust, maintain, alter, change, govern, manage, restrain, restrict, direct, guide, oversee, manage, preserve, sustain, restrain, temper, or vary.

In some embodiments, the methods, systems, device, software and/or the apparatuses described herein comprise a control system. The control system can be in communication with one or more components of the 3D printing system. The control system can be in communication with one or more components facilitating the 3D printing methodologies. The control system can be in communication with one or more energy sources, optical systems, gas flow system, material flow systems, energy (e.g., energy beams), build platform assembly, and/or with any other component of the 3D printing system.

In some embodiments, the 3D printing system comprises a controller. The controller may include one or more components. The controller may comprise a processor. The controller may comprise a specialized hardware (e.g., electronic circuit). The controller may be a proportional-integral-derivative controller (PIO controller). The control may comprise dynamic control (e.g., in real time during the 3D printing process). For example, the control of the (e.g., transforming) energy beam may be a dynamic control (e.g., during the 3D printing process). The PIO controller may comprise a PIO tuning software. The PIO control may comprise constant and/or dynamic PIO control parameters. The PIO parameters may relate a variable to the required power needed to maintain and/or achieve a setpoint of the variable at any given time. The calculation may comprise calculating a process value. The process value may be the value of the variable to be controlled at a given moment in time. For example, the process controller may control a height of at least one portion of the layer of hardened material that deviates from the average surface of the target surface (e.g., exposed surface of the material bed) by altering the power of the energy source and/or power density of the energy beam, wherein the height measurement is the variable, and the power of the energy source and/or power density of the energy beam are the process value(s). The variable may comprise a temperature or metrological value. The parameters may be obtained and/or calculated using a historical (e.g., past) 3D printing process. The parameters may be obtained in real time, during a 3D printing process. During a 3D printing process, may comprise during the formation of a 3D object, during the formation of a layer of hardened material, or during the formation of a portion of a layer of hardened material. The calculation output may be a relative distance (e.g., height) of the material bed (e.g., from a cooling mechanism, bottom of the enclosure, optical window, energy source, or any combination thereof). The controller may comprise a feedback control scheme. The feedback control scheme may comprise an open feedback loop control scheme. The feedback loop control scheme may comprise a closed feedback loop control scheme. Feedback control scheme may comprise hardware compensation. Feedback control scheme may comprise software compensation. The control system may comprise, or be operatively coupled with, a metrological detection system and configured to receive measurement data from the metrological detection system, e.g., height mapper. The control system may be configured to generate control signals responsive to the measurement data collected by the metrological detection system.

In some embodiments, a controller of a 3D printing system comprises a metrological detection system. The metrological detection system may be used in the control of 3D printing processes of the 3D printing system. The metrological detection system may be configured to detect distance variations such as vertical distance variations, e.g., height variations. The metrological detection system may be configured to detect distance variations such as horizontal distance variations, e.g., variations with respect to an XY plane. For example, a horizontal distance variation along an X-axis that is oriented parallel to the direction of translation of a translatable component (e.g., a translation mechanism). For example, a horizontal distance variation along a Y-axis that is orientated perpendicular to the direction of translation of the translatable component (e.g., the translation mechanism) and perpendicular to a gravitational vector. The metrological detection system may be configured to detect a vertical (e.g., height) variations in a planar surface, e.g., a planar exposed surface of a material bed. The metrological detection system may comprise a height mapper system. The metrological detection system may comprise an interferometric optical system. The metrological detection system may comprise a position sensitive device system. The metrological detection system may comprise an optical detector. The metrological detection system may include, or be operatively coupled with, an image processor. The metrological detection system may comprise an imaging detector to monitor irregularities. The image detector may comprise a camera such as a charged coupled device (CCD) camera. The image detector may comprise detecting a location or an area of the printed 3D object and convert it to a pixel in the X-Y (e.g., horizontal) plane. The image detector may comprise detecting an interference pattern generated by an interferometric beam path. The image detector may comprise detecting position of a beam incident on the image detector relative to an imaging region of the image detector. The controller may comprise one or more computational schemes to convert data (e.g., measurement data) from the metrological detection system to generate a result. The one or more computational schemes may be utilized to determine one or more aspects of the build platform assembly, the optical system, and/or of the target surface, e.g., the exposed surface of the material bed or the build platform surface. The one or more aspects may comprise positional aspects, or localization aspects. The one or more aspects may be absolute or relative. For example, an aspect can include a physical orientation of a moving component of the build module, the moving component comprising a base, substrate, or build platform assembly, the build module assembly comprising the base (also herein “build platform”). For example, an aspect can include a physical orientation of a moving component of the optical system, e.g., of one or more optical assemblies, energy beam paths, or processing cones incident on the target surface. The physical orientation may comprise a relative orientation (e.g., relative to a requested orientation) or an absolute orientation (e.g., relative to a coordinate axis). For example, an aspect may comprise a relative orientation of the target surface or at least one optical assembly (e.g., a plurality of optical assemblies) with respect to a manufacturing enclosure (e.g., the processing chamber) with respect to a requested orientation, e.g., characterizing offset value(s) of the position (e.g., XY position) of the optical assembly or target surface from the requested value(s). For example, an aspect may include (a) a height (e.g., along a z-axis) of the target surface, (b) an XY position (c) a rotation of the target surface, or (d) any combination of (a), (b), and (c). The orientation may include (A) pitch or roll (e.g., due to movement around the horizontal axis). The controller may utilize one or more computational schemes to measure a height (e.g., along a z-axis) of the target surface (e.g., a phase shift computational scheme). The controller may utilize one or more computational schemes to measure a position (e.g., about the XY plane). The computational scheme may comprise an algorithm. The controller may utilize a computational scheme comprising a (e.g., digital) modulation scheme that conveys data by changing (e.g., modulating) the phase of a reference signal (e.g., carrier wave). Measurements collected by the metrological detection system may be utilized by one or more controllers, for example, to provide feedback controls to one or more control systems. For example, the one or more controllers may process, or direct processing, the measurements at a time including before, after and/or during the 3D printing process (e.g., in real time). The one or more controllers may be integrated in a control system that controls the 3D printing process (e.g., the recoater, gas flow system, and/or energy beam(s)). The control system may be any control system disclosed herein. For example, the control system may be a hierarchical control system. For example, the control system may comprise at least three hierarchical control levels, e.g., at least three, four, or five control levels.

Methods, apparatuses, and/or systems of the present disclosure can be implemented by way of one or more computational schemes. A computational scheme can be implemented by way of software upon execution by one or more computer processors. For example, the processor can be programmed to calculate the path of the energy beam and/or the power per unit area emitted by the energy source (e.g., that should be provided to the material bed in order to achieve the requested result). Examples of 3D printing systems (e.g., comprising energy source(s), energy beam(s), optical element(s) and optical window(s)), apparatuses, devices, components, controllers (e.g., including control schemes), software (e.g., computational schemes), and 3D printing processes can be found in International Patent Application Serial No. PCT/US17/18191, filed Feb. 16, 2017, which is incorporated herein by reference in their entirety.

At times, the 3D object printed by the 3D printing system is a high fidelity 3D object. At times, the generated 3D object (e.g., the hardened cover) is substantially smooth. The generated 3D object may have a deviation from an ideal planar surface (e.g., atomically flat or molecularly flat) of at most about 1.5 nanometers (nm), 2 nm, 3 nm, 4 nm, 5 nm, 10 nm, 15 nm, 20 nm, 25 nm, 30 nm, 35 nm, 100 nm, 300 nm, 500 nm, 1 micrometer (μm), 1.5 μm, 2 μm, 3 μm, 4 μm, 5 μm, 10 μm, 15 μm, 20 μm, 25 μm, 30 μm, 35 μm, 100 μm, 300 μm, 500 μm, or less. The generated 3D object may have a deviation from an ideal planar surface of at least about 1.5 nanometers (nm), 2 nm, 3 nm, 4 nm, 5 nm, 10 nm, 15 nm, 20 nm, 25 nm, 30 nm, 35 nm, 100 nm, 300 nm, 500 nm, 1 micrometer (μm), 1.5 μm, 2 μm, 3 μm, 4 μm, 5 μm, 10 μm, 15 μm, 20 μm, 25 μm, 30 μm, 35 μm, 100 μm, 300 μm, 500 μm, or more. The generated 3D object may have a deviation from an ideal planar surface between any of the afore-mentioned deviation values. The generated 3D object may comprise a pore. The generated 3D object may comprise pores. The pores may be of an average FLS (diameter or diameter equivalent in case the pores are not spherical) of at most about 1.5 nanometers (nm), 2 nm, 3 nm, 4 nm, 5 nm, 10 nm, 15 nm, 20 nm, 25 nm, 30 nm 35 nm, 100 nm, 300 nm, 500 nm, 1 micrometer (μm), 1.5 μm, 2 μm, 3 μm, 4 μm, 5 μm, 10 μm, 15 μm, or 20 μm. The pores may be of an average FLS of at least about 1.5 nanometers (nm), 2 nm, 3 nm, 4 nm, 5 nm, 10 nm, 15 nm, 20 nm, 25 nm, 30 nm, 35 nm, 100 nm, 300 nm, 500 nm, 1 micrometer (μm), 1.5 μm, 2 μm, 3 μm, 4 μm, 5 μm, 10 μm, 15 μm, or 20 μm. The pores may be of an average FLS between any of the afore-mentioned FLS values (e.g., from about 1 nm to about 20 μm). The 3D object (or at least a layer thereof) may have a porosity of at most about 0.05 percent (%), 0.1% 0.2%, 0.3%, 0.4%, 0.5%, 0.6%, 0.7%, 0.8%, 0.9%, 1%, 2%, 3%, 4%, 5%, 6%, 7%, 8%, 9%, 10%, 20%, 30%, 40%, 50%, 60%, 70%, or 80%. The 3D object (or at least a layer thereof) may have a porosity of at least about 0.05%, 0.1%, 0.2%, 0.3%, 0.4%, 0.5%, 0.6%, 0.7%, 0.8%, 0.9%, 1%, 2%, 3%, 4%, 5%, 6%, 7%, 8%, 9%, 10%, 20%, 30%, 40%, 50%, 60%, 70%, or 80%. The 3D object (or at least a layer thereof) may have porosity between any of the afore-mentioned porosity percentages (e.g., from about 0.05% to about 80%, from about 0.05% to about 40%, from about 10% to about 40%, or from about 40% to about 90%). In some instances, a pore may traverse the generated 3D object. For example, the pore may start at the face of the 3D object and end at the opposing face of the 3D object. The pore may comprise a passageway extending from one face of the 3D object and ending on the opposing face of that 3D object. In some instances, the pore may not traverse the generated 3D object. The pore may form a cavity in the generated 3D object. The pore may form a cavity on the face of the generated 3D object. For example, pore may start on the face of the plane and not extend to the opposing face of that 3D object.

The resolution of the printed 3D object may be at least about 1 micrometer, 1.3 micrometers (μm), 1.5 μm, 1.8 μm, 1.9 μm, 2.0 μm, 2.2 μm, 2.4 μm, 2.5 μm, 2.6 μm, 2.7 μm, 3 μm, 4 μm, 5 μm, 10 μm, 20 μm, 30 μm, 40 μm, 50 μm, 60 μm, 70 μm, 80 μm, 90 μm, 100 μm, 200 μm, or more. The resolution of the printed 3D object may be at most about 1 micrometer, 1.3 micrometers (μm), 1.5 μm, 1.8 μm, 1.9 μm, 2.0 μm, 2.2 μm, 2.4 μm, 2.5 μm, 2.6 μm, 2.7 μm, 3 μm, 4 μm, 5 μm, 10 μm, 20 μm, 30 μm, 40 μm, 50 μm, 60 μm, 70 μm, 80 μm, 90 μm, 100 μm, 200 μm, or less. The resolution of the printed 3D object may be any value between the above-mentioned resolution values. At times, the 3D object may have a material density of at least about 99.9%, 99.8%, 99.7%, 99.6%, 99.5%, 99.4%, 99.3%, 99.2% 99.1%, 99%, 98%, 96%, 95%, 94%, 93%, 92%, 91%, 90%, 80%, or 70%. At times, the 3D object may have a material density of at most about 99.5%, 99%, 98%, 96%, 95%, 94%, 93%, 92%, 91%, 90%, 80%, or 70%. At times, the 3D object may have a material density between the afore-mentioned material densities. The resolution of the 3D object may be at least about 100 dots per inch (dpi), 300 dpi, 600 dpi, 1200 dpi, 2400 dpi, 3600 dpi, or 4800 dpi. The resolution of the 3D object may be at most about 100 dpi, 300 dpi, 600 dpi, 1200 dpi, 2400 dpi, 3600 dpi, or 4800 dip. The resolution of the 3D object may be any value between the afore-mentioned values (e.g., from 100 dpi to 4800 dpi, from 300 dpi to 2400 dpi, or from 600 dpi to 4800 dpi). The height uniformity (e.g., deviation from average surface height) of a planar surface of the 3D object may be at least about 100 μm, 90 μm, 80 μm, 70 μm, 60 μm, 50 μm, 40 μm, 30 μm, 20 μm, 10 μm, or 5 μm. The height uniformity of the planar surface may be at most about 100 μm, 90 μm, 80 μm, 70 μm, 60 μm, 50 μm, 40 μm, 30 μm, 20 μm, 10 μm, or 5 μm. The height uniformity of the planar surface of the 3D object may be any value between the afore-mentioned height deviation values (e.g., from about 100 μm to about 5 μm, from about 50 μm to about 5 μm, from about 30 μm to about 5 μm, or from about 20 μm to about 5 μm). The height uniformity may comprise high precision uniformity.

In some embodiments the control system comprises a laser control system. The laser control system may comprise, or may be operatively coupled with, an optical translation control system. The laser control system may comprise, or be operatively coupled with, a laser system (e.g., optical system) of the 3D printing system, e.g., energy sources, optical components, translation mechanism, optical systems, motors, encoders, or the like. At times, the laser control system is operable to control operations of the optical system (e.g., comprising one or more optical assemblies) of the 3D printing system. The control system may be operable to adjust operations of the optical system (e.g., of the one or more optical assemblies) in response to a measured positional deviation of one or more aspects of the translatable optical system. The laser control system may be operable to adjust (e.g., calibrate) one or more characteristics of the irradiating energy (e.g., the energy beam) incident on the target surface, e.g., the exposed surface of the material bed. Adjusting one or more characteristics of the irradiating energy beam may comprise a software adjustment (e.g., calibration). Adjusting one or more characteristics of the irradiating energy beam may comprise a hardware adjustment (e.g., calibration).

In some embodiments, the laser control system is configured to calibrate one or more characteristics of the irradiating energy (e.g., energy beam) in response to a positional deviation of the target surface, translational mechanism, optical system component(s), build platform assembly, or build platform, from a requested position. For example, the laser control system may be configured to calibrate one or more characteristics of the irradiating energy in response to a positional deviation of the target surface about an XY plane and/or about a rotational axis of the target surface (e.g., rotation about a central axis). For example, the laser control system may calibrate (i) the position at which the irradiating energy contacts a surface (e.g., the target surface), (ii) the shape of the footprint of the energy beam at the (e.g., target) surface, (iii) the XY offset of a first energy beam position at the (e.g., target) surface with respect to a second energy beam position at the (e.g., target) surface, and/or (iv) the XY offset of the energy beam with respect to the (e.g., target) surface. The position at which the energy beam contacts the surface is the position at which the energy beam impinges on the surface.

In some embodiments, the laser control system is configured to calibrate one or more characteristics of the irradiating energy (e.g., energy beam). A calibration may include a comparison of a commanded (e.g., instructed) energy beam position (e.g., at the target surface) compared with an actual (e.g., measured) energy beam position at the target surface. The characteristics of the energy beam may be calibrated along a field of view of the optical system (e.g., and/or detector). The laser control system may calibrate characteristics of a processing cone of the energy (e.g., laser beam). The calibration of the focus mechanism may achieve a requested spot or footprint size for various locations in the field of view of the irradiating energy (e.g., intersection of the processing cone with the target surface and/or calibration structure surface). The power density distribution measure may be calibrated (e.g., substantially) identically, or differently, along the field of view of the irradiating energy. In some embodiments, different positions in the field of view may require different focus offsets and/or or footprint size. Processing cone coverage of the material bed can depend in part on dimensions of one or more of the mirrors of a scanner, e.g., galvanometric scanner, utilized to direct a path of the energy beam about the target surface. Examples of 3D printing systems (e.g., comprising energy source(s), energy beam(s), optical element(s) and optical window(s)), apparatuses, devices, components, controllers, software, and 3D printing processes can be found in International Patent Application Serial No. PCT/US19/14635 filed Jan. 22, 2019, and U.S. patent application Ser. No. 17/986,814 filed on Nov. 14, 2022, each of which is incorporated herein by reference in its entirety.

At times, a calibration comprises generating a compensation for one or more characteristics of the laser system. A compensation may be effectuated at least in part by a (e.g., energy beam) calibration. At times, an energy beam calibration comprises formation of one or more (e.g., physically printed or optically projected) alignment markers using at least one energy beam directed at a target surface. The one or more alignment markers may form an arrangement (e.g., a pattern). The position(s) of the marker(s) may be according to a requested (e.g., pre-determined) arrangement (e.g., a reference pattern). Requested may be according to a commanded arrangement as directed by commands to a guidance system for directing the energy beam(s). The arrangement (e.g., position(s)) of the one or more alignment markers may be detected by a detection system. The detected position(s) (e.g., measured position(s)) of the alignment marker(s) may be compared to commanded (e.g., requested) position(s). The energy beam calibration may comprise correction (e.g., compensation) of any deviation of the detected position(s) from the commanded position(s). The deviation of the detected position(s) from the commanded position(s) may be caused in part by (a) thermal effects on the energy beam and/or optical components, (b) position deviation of the target surface, (c) a non-uniformity of layer deposition, or (d) a combination thereof. Following application of the (e.g., initial) compensation to the energy beam (e.g., to the guidance system directing the energy beam), further (e.g., additional) calibration may be performed. Further calibration may (e.g., iteratively) improve the compensation of the any deviation between the detected position(s) from the commanded position(s) of the energy beam at the target surface. The deviation may depend on the nature and/or geometry of one or more optical elements of the optical system. The calibration may comprise altering the one or more elements (e.g., position thereof) of the optical system. The calibration may comprise altering a command to one or more elements of the optical system and/or to the energy source.

In some embodiments, the control system utilizes data from a metrological detection system. The control system may use the data to control one or more parameters of the 3D printing. For example, the control system may use the metrology data to control one or more positions of the optical system. At times, the control system may utilize a control scheme comprising a feedback control loop that utilizes alignment data, e.g., collected from one or more metrological detection systems to update control parameters of one or more control systems. Data collected from one or more metrological detection systems may comprise alignment data indicative of a position of at least one component of the optical system, for example, a position of (A) an optical assembly, (B) the array of optical assemblies, (C) the translation mechanism, (D) energy beam(s) of the optical system incident on the target surface, or (E) any combination of (A) to (D). The data collected from one or more metrological detection systems can be utilized by a feedback control loop to adjust a position of the component of the optical system, for example, a position of (A) an optical assembly, (B) the array of optical assemblies, (C) the translation mechanism, (D) energy beam(s) of the optical system incident on the target surface, or (E) any combination of (A) to (D). At times, a control scheme comprises a feedforward control that utilizes alignment data to update control parameters of one or more control systems. Alignment data may comprise historical data, e.g., data collected after a three-dimensional process performed by a three-dimensional printer. Historical data (e.g., historical measurements) may comprise characterization of three-dimensional objects formed utilizing the three-dimensional printer. The historical data may be utilized in a feedforward control to adjust a position of (A) an optical assembly, (B) the array of optical assemblies, (C) the translation mechanism, (D) energy beam(s) of the optical system incident on the target surface, or (E) any combination of (A) to (D). The control system may use the metrology data to control one or more parameters of the energy source and/or energy beam. The one or more measurements from the metrological detection system may be used to alter (e.g., in real time, and/or offline) the computer model. For example, the metrological detection system measurement(s) may be used to alter the optical proximity correction data. For example, the metrological detection system measurement(s) may be used to alter the printing instruction of one or more successive layers (e.g., during the printing of the 3D object).

In some embodiments, the detector and/or controller(s) averages at least a portion of the detected signal over time (e.g., period). In some embodiments, the detector and/or controller(s) reduces (at least in part) noise from the detected signal (e.g., over time). The noise may comprise detector noise, sensor noise, noise from the target surface, or any combination thereof. The noise from the target surface may arise from a deviation from planarity of the target surface (e.g., when a target surface comprises particulate material (e.g., powder)). The reduction of the noise may comprise using a filter, noise reduction algorithm, averaging of the signal over time, or any combination thereof.

In some embodiments, the controller(s) (e.g., continuously, or intermittently) calculates an error value during the control time. The intermittent calculation may or may not be periodic. The error value may be the difference between a requested setpoint and a measured process variable. The control may be continuous control (e.g., during the 3D printing process, during formation of the 3D object, and/or during formation of a layer of hardened material). The control may be discontinuous. For example, the control may cause the occurrence of a sequence of discrete events. The control scheme may comprise a continuous, discrete, or batch control. The requested setpoint may comprise a temperature, power, power density, or a metrological (e.g., height) setpoint. The metrological setpoint may relate to the target surface (e.g., the exposed surface of the material bed). The metrological setpoints may relate to one or more height setpoints of the target surface (e.g., the exposed (e.g., top) surface of the material bed). The controller(s) may attempt to minimize an error (e.g., temperature and/or metrological error) over time by adjustment of a control variable. The control variable may comprise a direction and/or (electrical) power supplied to any component of the 3D printing apparatus and/or system. For example, direction and/or power supplied to the: energy beam, scanner, motor translating the platform, optical system component, optical diffuser, or any combination thereof.

In some embodiments, the systems, apparatuses, and/or components thereof comprise one or more controllers. The one or more controllers can comprise one or more central processing unit (CPU), input/output (I/O) and/or communications module. The CPU can comprise electronic circuitry that carries out instructions of a computer program by performing basic arithmetic, logical, control and I/O operations specified by the instructions. The controller can comprise a suitable software (e.g., operating system). The control system may optionally include a feedback control and/or feed-forward control loop. The controllers may be shared between one or more systems or apparatuses. Each apparatus or system may have its own controller. Two or more systems and/or its components may share a controller. Two or more apparatuses and/or its components may share a controller. Examples of 3D printing systems (e.g., comprising energy source(s), energy beam(s), optical element(s) and optical window(s)), apparatuses, devices, components, controllers, software, and 3D printing processes can be found in U.S. patent application Ser. No. 18/207,206 filed on Jun. 8, 2023, in U.S. patent application Ser. No. 17/849,866, filed on Jun. 27, 2022, and in PCT Patent Application serial number PCT/U.S. Pat. No. 16,159,781, filed on Oct. 31, 2016, each of which is incorporated herein by reference in their entirety.

At times, multiple of tuning schemes can be generated for the one or more controllers, each tuning scheme selectable for a set of operating conditions and/or powder characteristics. For example, a tuning scheme may utilize (i) a look-up table (LUT), (ii) historical data, (iii) experiments, (iv) physics simulation, (v) artificial intelligence, (vi) data analysis, and/or (vii) the like. The artificial intelligence may comprise training a plant model (a machine-learned model). The artificial intelligence may comprise data analysis. The training model may be trained utilizing (i) a look-up table (LUT), (ii) historical data, (iii) experiments, (iv) synthesized results from physics simulation, or (v) the like. In some embodiments, control scheme(s) can use a single plant model and project changes due to the temperature based at least in part on previously identified models. The control scheme(s) may be inscribed as program instructions (e.g., software).

In some embodiments, the control scheme used the controller(s) disclosed herein involve data analysis. The data analysis techniques involve one or more regression analys(es) and/or calculation(s). The regression analysis and/or calculation may comprise linear regression, least squares fit, Gaussian process regression, kernel regression, nonparametric multiplicative regression (NPMR), regression trees, local regression, semiparametric regression, isotonic regression, multivariate adaptive regression splines (MARS), logistic regression, robust regression, polynomial regression, stepwise regression, ridge regression, lasso regression, elasticnet regression, principal component analysis (PCA), singular value decomposition (SVD)), probability measure techniques (e.g., fuzzy measure theory, Borel measure, Harr measure, risk-neutral measure, Lebesgue measure), predictive modeling techniques (e.g., group method of data handling (GMDH), Naive Bayes classifiers, k-nearest neighbors algorithm (k-NN), support vector machines (SVMs), neural networks, support vector machines, classification and regression trees (CART), random forest, gradient boosting, generalized linear model (GLM)), or any other suitable probability and/or statistical analys(es). A learning scheme may comprise neural networks. The leaning scheme may comprise machine learning. The learning scheme may comprise pattern recognition. The learning scheme may comprise artificial intelligence, data miming, computational statistics, mathematical optimization, predictive analytics, discrete calculus, or differential geometry. The learning schemes may comprise supervised learning, reinforcement learning, unsupervised learning, semi-supervised learning. The learning scheme may comprise bias-variance decomposition. The learning scheme may comprise decision tree learning, associated rule learning, artificial neural networks, deep learning, inductive logic programming, support vector machines, clustering, Bayesian networks, reinforcement learning, representation learning, similarity and metric learning, sparse dictionary learning, or genetic algorithms (e.g., evolutional algorithm). The non-transitory computer media may comprise any of the computational schemes disclosed herein. The controller and/or processor may comprise the non-transitory computer media. The software may comprise any of the computational schemes disclosed herein. The controller and/or processor may comprise the software. The learning scheme may comprise random forest scheme.

In some embodiments, the control system utilizes a physics simulation in, e.g., in a computer model (e.g., comprising a prediction model, statistical model, a thermal model, or a thermo-mechanical model). The computer model may provide feedforward information to the control system. The computer model may provide the feed forward control scheme. There may be more than one computer model (e.g., at least 1, 2, 3, 4, 5, 6, 7, 8, 9 or 10 different computer models). The controller may (e.g., dynamically) switch between the computer models to predict and/or estimate the behavior of the optical elements. Dynamic includes changing computer models (e.g., in real time) based at least in part on a sensor input or based at least in part on a controller decision that may in turn be based at least in part on monitored target temperature. The dynamic switch may be performed in real-time, e.g., during operation of the optical system and/or during printing 3D object(s). The controller may be configured (e.g., reconfigured) to include additional one or more computer models and/or readjust the existing one or more computer models. A prediction may be done offline (e.g., predetermined) and/or in real-time. Examples of 3D printing systems, apparatuses, devices, components, controllers, software, and 3D printing processes (e.g., including calibration methods) can be found in International Patent Application Serial No. PCT/US19/14635, filed Jan. 22, 2019, which is incorporated herein by reference in its entirety.

In some instances, the processing unit includes one or more cores. The computer system may comprise a single core processor, multi core processor, or a plurality of processors for parallel processing. The processing unit may comprise one or more central processing units (CPU) and/or a graphic processing unit (GPU). The multiple cores may be disposed in a physical unit (e.g., Central Processing Unit, or Graphic Processing Unit). The processing unit may include one or more processing units. The physical unit may be a single physical unit. The physical unit may be a die. The physical unit may comprise cache coherency circuitry. The multiple cores may be disposed in close proximity. The physical unit may comprise an integrated circuit chip. The integrated circuit chip may comprise one or more transistors. The close proximity may allow substantial preservation of communication signals that travel between the cores. The close proximity may diminish communication signal degradation. A core as understood herein is a computing component having independent central processing capabilities. The computing system may comprise a multiplicity of cores, which may be disposed on a single computing component. The multiplicity of cores may include two or more independent central processing units. The independent central processing units may constitute a unit that read and execute program instructions. The independent central processing units may constitute parallel processing units. The parallel processing units may be cores and/or digital signal processing slices (DSP slices). The multiplicity of cores can be parallel cores. The multiplicity of DSP slices can be parallel DSP slices. The multiplicity of cores and/or DSP slices can function in parallel. In some processors (e.g., FPGA), the cores may be equivalent to multiple digital signal processor (DSP) slices (e.g., slices). The plurality of DSP slices may be equal to any of plurality core values mentioned herein. The processor may comprise low latency in data transfer (e.g., from one core to another). Latency may refer to the time delay between the cause and the effect of a physical change in the processor (e.g., a signal). Latency may refer to the time elapsed from the source (e.g., first core) sending a packet to the destination (e.g., second core) receiving it (also referred as two-point latency). One-point latency may refer to the time elapsed from the source (e.g., first core) sending a packet (e.g., signal) to the destination (e.g., second core) receiving it, and the designation sending a packet back to the source (e.g., the packet making a round trip). The latency may be sufficiently low to allow a high number of floating point operations per second (FLOPS).

In some instances, the computer system includes hyper-threading technology. The computer system may include a chip processor with integrated transform, lighting, triangle setup, triangle clipping, rendering engine, or any combination thereof. The rendering engine may be capable of processing at least about 10 million polygons per second. The rendering engines may be capable of processing at least about 10 million calculations per second. As an example, the GPU may include a GPU by Nvidia, ATI Technologies, S3 Graphics, Advanced Micro Devices (AMO), or Matrox. The processing unit may be able to process one or more schemes comprising a matrix or a vector. The core may comprise a complex instruction set computing core (CISC), or reduced instruction set computing (RISC).

In some instances, the computer system includes an electronic chip that is reprogrammable (e.g., field programmable gate array (FPGA)). For example, the FPGA may comprise Tabula, Altera, or Xilinx FPGA. The electronic chips may comprise one or more programmable logic blocks (e.g., an array). The logic blocks may compute combinational functions, logic gates, or any combination thereof. The computer system may include custom hardware. The custom hardware may comprise a computational scheme, e.g., embedded therein.

In some instances, the computer system includes configurable computing, partially reconfigurable computing, reconfigurable computing, or any combination thereof. The computer system may include an FPGA. The computer system may include an integrated circuit that performs the computational scheme. For example, the reconfigurable computing system may comprise FPGA, CPU, GPU, or multi-core microprocessors. The reconfigurable computing system may comprise a High-Performance Reconfigurable Computing architecture (HPRC). The partially reconfigurable computing may include module-based partial reconfiguration, or difference-based partial reconfiguration. The FPGA may comprise configurable FPGA logic, and/or fixed-function hardware comprising multipliers, memories, microprocessor cores, first in-first out (FIFO) and/or error correcting code (ECC) logic, digital signal processing (DSP) blocks, peripheral Component interconnect express (PCI Express) controllers, ethernet media access control (MAC) blocks, or high-speed serial transceivers. DSP blocks can be DSP slices.

In some examples, the computing system includes an integrated circuit. The computing system may include an integrated circuit that performs the scheme (e.g., control scheme or other computational scheme). In some instances, the controller uses calculations, real time measurements, or any combination thereof to regulate the energy beam(s).

In some embodiments, a user develops at least one 3D printing instruction and directs the 3D printer (e.g., through communication with the 3D printer processor) to print in a requested manner according to the developed at least one 3D printing instruction. A user may or may not be able to control (e.g., locally, or remotely) the 3D printer controller, e.g., depending on permission preferences. For example, a client may not be able to control the 3D printing controller (e.g., maintenance of the 3D printer).

In some embodiments, the user (e.g., other than a client) processor may use real-time and/or historical 3D printing data of one or more 3D printers. The 3D printing data may comprise metrology data. The user processor may comprise quality control. The quality control may use a statistical method (e.g., statistical process control (SPC)). The user processor may log excursion log, report when a signal deviates from the nominal level, or any combination thereof. The user processor may generate a configurable response. The configurable response may comprise a print/pause/stop command (e.g., automatically) to the 3D printer (e.g., to the 3D printing processor). The configurable response may be based at least in part on a user defined parameter, threshold, or any combination thereof. The configurable response may result in a user defined action. The user processor may control the 3D printing process and ensure that it operates at its full potential. For example, at its full potential, the 3D printing process may make a maximum number of 3D object with a minimum of waste and/or 3D printer down time. The SPC may comprise a control chart, design of experiments, and/or focus on continuous improvement.

In some embodiments, the 3D printing system comprises a computer system. The computer system can control (e.g., direct, monitor, and/or regulate) various features of printing methods, apparatuses and systems of the present disclosure, such as, for example, control force, translation, heating, cooling and/or maintaining the temperature of a powder bed, process parameters (e.g., chamber pressure), scanning rate (e.g., of the energy beam and/or the platform), scanning route of the energy source, position and/or temperature of the cooling member(s), application of the amount of energy emitted to a selected location, or any combination thereof. The computer system can be part of, or be in communication with, a 3D printing system or apparatus. The computer may be coupled with one or more mechanisms disclosed herein, and/or any parts thereof. For example, the computer may be coupled with one or more sensors, valves, switches, motors, pumps, scanners, optical components, or any combination thereof.

In some embodiments, the computer system utilizes program instructions to execute, or direct execution of, operation(s). The program instructions can be inscribed in a machine executable code. Methods as described herein can be implemented by way of machine (e.g., computer processor) executable code stored on an electronic storage location of the computer system, such as, for example, on the memory, or electronic storage unit. The machine executable or machine-readable code can be provided in the form of software. During use, the processor can execute the code. In some cases, the code can be retrieved from the storage unit and stored on the memory for ready access by the processor. In some situations, the electronic storage unit can be precluded, and machine-executable instructions are stored on memory. The code can be pre-compiled and configured for use with a machine having a processer adapted to execute the code or can be compiled during runtime. The code can be supplied in a programming language that can be selected to enable the code to execute in a pre-compiled or as-compiled fashion.

In some embodiments, the computer system comprises a memory. The memory may comprise a random-access memory (RAM), dynamic random access memory (DRAM), static random access memory (SRAM), synchronous dynamic random access memory (SDRAM), ferroelectric random access memory (FRAM), read only memory (ROM), programmable read only memory (PROM), erasable programmable read only memory (EPROM), electrically erasable programmable read only memory (EEPROM), a flash memory, or any combination thereof. The flash memory may comprise a negative-AND (NANO) or NOR logic gates. A NANO gate (negative-AND) may be a logic gate which produces an output which is false only if all its inputs are true. The output of the NANO gate may be complemented to that of the AND gate. The storage may include a hard disk (e.g., a magnetic disk, an optical disk, a magneto-optic disk, a solid-state disk, or the like), a compact disc (CD), a digital versatile disc (DVD), a floppy disk, a cartridge, a magnetic tape, and/or another type of computer-readable medium, along with a corresponding drive.

In some embodiments, the computer system comprises an electronic storage unit. The electronic storage unit can be a data storage unit (or data repository) for storing data. In some embodiments, the storage unit stores files, such as drivers, libraries, and saved programs. The storage unit can store user data (e.g., user preferences and user programs). In some cases, the computer system can include one or more additional data storage units that are external to the computer system, such as located on a remote server that is in communication with the computer system through the network (e.g., an intranet or the Internet).

Aspects of the systems, apparatuses, and/or methods provided herein, such as the computer system, can be embodied in programming (e.g., using a software). Various aspects of the technology may be thought of as “product,” “object,” or “articles of manufacture” typically in the form of machine (or processor) executable code and/or associated data that is executed or embodied in a type of machine-readable medium. Machine-executable code can be stored on the electronic storage unit, such memory (e.g., read-only memory, random-access memory, flash memory) or a hard disk. The storage may comprise non-volatile storage media. “Storage” type media can include any or all of the tangible memory of the computers, processors or the like, or associated modules thereof, such as various semiconductor memories, tape drives, disk drives, external drives, and the like, which may provide non-transitory storage at any time for the software programming.

In some embodiments, the computer system may comprise a processor or a plurality of processors. The processor may be a processing unit. The processing unit may include one or more processing units. The processor (e.g., 3D printer processor) may be programmed to implement methods of the disclosure. The processing unit can execute a sequence of machine-readable instructions, which can be embodied in a program or software. The instructions can be directed to the processing unit, which can subsequently program or otherwise configure the processing unit to implement methods of the present disclosure. Examples of operations performed by the processing unit can include fetch, decode, execute, and write back. The processing unit may interpret and/or execute instructions. The processor may include a microprocessor, a data processor, a central processing unit (CPU), a graphical processing unit (GPU), a system-on-chip (SOC), a co-processor, a network processor, an application specific integrated circuit (ASIC), an application specific instruction-set processor (ASIPs), a controller, a programmable logic device (PLO), a chipset, a field programmable gate array (FPGA), or any combination thereof. The processing unit can be part of a circuit, such as an integrated circuit. One or more other components of the system can be included in the circuit.

The processor may be configured to process control protocols, e.g., communicate with one or more components of the 3D printer system using the control protocols. Control protocols can be one or more of the internet protocol suite, e.g., transmission control protocol (TCP) or transmission control protocol/internet protocol (TCP/IP). Control protocols can be one or more of serial communication protocols. Control protocols can be one or more of controller area networks or another message-based protocol, e.g., for communication with microcontrollers and devices. Control protocols can interface with one or more serial bus interfaces for communication with the 3D printing system and its components. The control protocol can be any control protocol disclosed herein.

In some embodiments, the plurality of processors may form a network architecture. At least two of the plurality of the 3D printer processors may interact with each other. In some embodiments, a 3D printer processor interacts with at least one processor that acts as a 3D printer interface (also referred to herein as “machine interface processor”). The one or more machine interface processors may be connected to at least one 3D printer processor. The connection may be through a wire (e.g., cable) and/or be wireless (e.g., via Bluetooth technology). In some embodiments, the machine interface processor directs 3D print job production, 3D printer management, 3D printer monitoring, or any combination thereof.

The computer system can be operatively coupled with a computer network (“network”), e.g., with the aid of the communication interface. The network can be the Internet, an internet and/or extranet, or an intranet and/or extranet that is in communication with the Internet. In some cases, the network is a telecommunication and/or data network. The network can include one or more computer servers, which can enable distributed computing, such as cloud computing. The network, in some cases with the aid of the computer system, can implement a peer-to-peer network, which may enable devices coupled with the computer system to behave as a client or a server.

In some embodiments, the 3D printer comprises communicating through the network. The computer system can communicate with one or more remote computer systems through the network. For instance, the computer system can communicate with a remote computer system of a user (e.g., operator). Examples of remote computer systems include personal computers (e.g., portable PC), slate or tablet PC's (e.g., Apple® iPad, Samsung® Galaxy Tab), telephones, Smart phones (e.g., Apple® iphone, Android-enabled device, Blackberry®), or personal digital assistants. A user (e.g., client) can access the computer system via the network.

In some instances, all or portions of the software are at times communicated through the Internet and/or other telecommunication networks. Such communications, for example, may enable loading of the software from one computer or processor into another, for example, from a management server or host computer into the computer platform of an application server. Thus, another type of media that may bear the software elements includes optical, electrical, and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium or media that participate(s) in providing instructions to a processor for execution.

In some embodiments, the 3D printer comprises a communication technology. The communication may comprise wired or wireless communication. For example, the systems, apparatuses, and/or parts thereof may comprise Bluetooth, wi-fi, or global positioning system (GPS), or radiofrequency (RF) technology. The RF technology may comprise ultrawideband (UWB) technology. Systems, apparatuses, and/or parts thereof may comprise a communication port. The communication port may be a serial port or a parallel port. The communication port may be a Universal Serial Bus port (e.g., USB). The systems, apparatuses, and/or parts thereof may comprise USB ports. The USB can be micro or mini-USB. The surface identification mechanism may comprise a plug and/or a socket (e.g., electrical, AC power, DC power). The systems, apparatuses, and/or parts thereof may comprise an electrical adapter (e.g., AC and/or DC power adapter). The systems, apparatuses, and/or parts thereof may comprise a power connector. The power connector can be an electrical power connector. The power connector may comprise a magnetically attached power connector. The power connector can be a dock connector. The connector can be a data and power connector. The connector may comprise pins. The connector may comprise at least about 10, 15, 18, 20, 22, 24, 26, 28, 30, 40, 42, 45, 50, 55, 80, or 100 pins.

In some instances, the system and/or apparatus described herein (e.g., controller) and/or any of their components comprise an output and/or an input device. The input device may comprise a keyboard, touch pad, or microphone. The output device may be a sensory output device. The output device may include a visual, tactile, or audio device. The audio device may include a loudspeaker. The visual output device may include a screen and/or a printed hard copy (e.g., paper). The output device may include a printer. The input device may include a camera, a microphone, a keyboard, or a touch screen.

In some instances, the computer system comprises an electronic display. The computer system can include or be in communication with an electronic display that comprises a user interface (UI) for providing, for example, a model design or graphical representation of a 3D object to be printed. Examples of UI's include, without limitation, a graphical user interface (GUI) and web-based user interface. The computer system can monitor and/or control various aspects of the 3D printing system. The control may be manual and/or programmed. The control may rely on feedback mechanisms (e.g., from the one or more sensors). The control may rely on historical data. The feedback mechanism may be pre-programmed. The feedback mechanisms may rely on input from sensors (described herein) that are connected to the control unit (i.e., control system or control mechanism e.g., computer) and/or processing unit. The computer system may store historical data concerning various aspects of the operation of the 3D printing system. The historical data may be retrieved at predetermined times and/or at a whim. The historical data may be accessed by an operator and/or by a user. The historical, sensor, and/or operative data may be provided in an output unit such as a display unit. The output unit (e.g., monitor) may output (e.g., display) various parameters of the 3D printing system (as described herein) in real time or in a delayed time. The output unit may output the current 3D printed object (e.g., real time display of the 3D object as it is being printed), the requested 3D printed object (e.g., according to a model), the printed 3D object or any combination thereof. The output unit may output the cleaning progress of the object, or various aspects thereof. The output unit may output the printing progress of the 3D printed object. The output unit may output at least one of the total time, time remaining, and time expanded on printing the 3D object. The output unit may output (e.g., display, voice, and/or print) the status of sensors, their reading, and/or time for their calibration or maintenance. The output unit may output the type of material(s) used and various characteristics of the material(s) such as temperature and flowability of the pre-transformed material. The output unit may display the amount of a certain gas in the chamber. The output unit may output the amount of oxidizing gas (e.g., oxygen), hydrogen, water vapor, or any of the gases mentioned herein, and pressure in the printing chamber (i.e., the chamber where the 3D object is being printed). The computer may generate a report comprising various parameters of the 3D printing system, method, and or objects at predetermined time(s), on a request (e.g., from an operator), and/or at a whim. The output unit may comprise a screen, printer, or speaker. The control system may provide a report. The report may comprise any items recited optionally as output by the output unit.

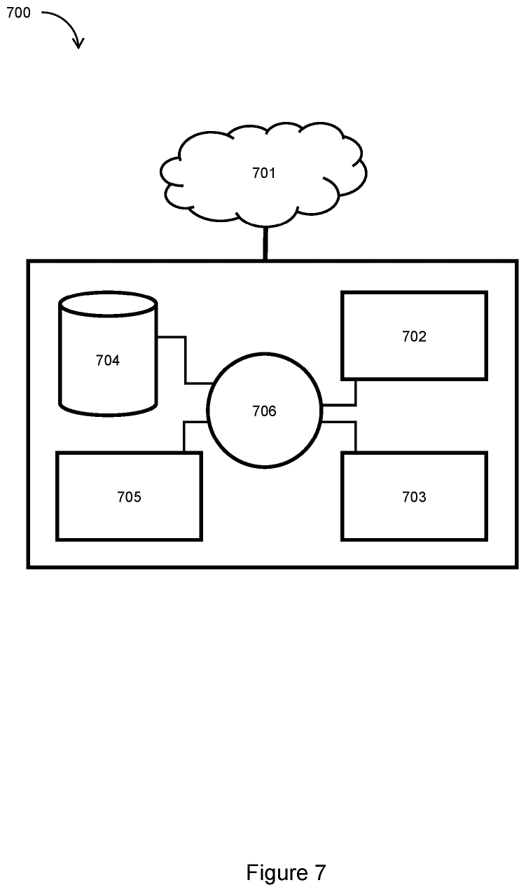

FIG. 7 is a schematic example of a computer system 700 that is programmed or otherwise configured to facilitate the formation of a 3D object according to the methods provided herein. The computer system 700 can include a processing unit 706 (also “processor,” “computer” and “computer processor” used herein). The computer system may include memory or memory location 702 (e.g., random-access memory, read-only memory, flash memory), electronic storage unit 704 (e.g., hard disk), communication interface 703 (e.g., network adapter) for communicating with one or more other systems, and peripheral devices 705, such as cache, other memory, data storage and/or electronic display adapters. The memory 702, storage unit 704, interface 703, and peripheral devices 705 are in communication with the processing unit 706 through a communication bus (solid lines), such as a motherboard.

In some embodiments, the 3D object includes one or more auxiliary features. The auxiliary feature(s) can be supported by the material (e.g., powder) bed. The term “auxiliary support,” as used herein, generally refers to one or more features that are part of a printed 3D object, but are not part of the requested, intended, designed, ordered, modeled, or final 3D object. Auxiliary features (e.g., auxiliary supports) may provide structural support during and/or after the formation of the 3D object. Auxiliary support may enable the removal of energy from the 3D object that is being formed. Examples of auxiliary support comprise heat fin, wire, anchor, handle, pillar, column, frame, footing, scaffold, flange, projection, protrusion, mold, or other stabilization features that are not part of the requested 3D object. In some instances, the auxiliary support is a scaffold that encloses the 3D object or part thereof. The scaffold may comprise lightly sintered or lightly fused pre-transformed (e.g., powder) material. The 3D object can have auxiliary support that can be supported by the material bed (e.g., powder bed) and not touch the platform (e.g., base, substrate, or enclosure bottom), and/or container accommodating the material bed. The 3D part (3D object) in a complete or partially formed state can be completely supported by the material bed (e.g., suspended anchorlessly in the material bed without contacting the platform and/or container accommodating the material bed). During formation, at least a portion of the 3D object (e.g., in a complete or partially formed state) can be completely supported by the material bed (e.g., without touching anything except the material bed). During formation, at least a portion of the 3D object (e.g., any portion thereof, e.g., a ledge or a cavity ceiling) can be suspended in the material bed without resting on any additional support structures. During formation, at least a portion of the 3D object (e.g., a nascent 3D object or a portion thereof) can freely float (e.g., anchorlessly) in the material bed. During formation, the 3D object may not be anchored (e.g., connected) to the platform and/or walls that define the material bed. During formation, at least a portion of the 3D object (e.g., the entire 3D object) may not touch (e.g., contact) the platform and/or walls that define the material bed. During formation, at least a portion of the 3D object be suspended (e.g., float) anchorlessly in the material bed. The scaffold may comprise a continuously sintered (e.g., lightly sintered) structure that is at most 1 millimeter (mm), 2 mm, 5 mm or 10 mm. The scaffold may comprise a continuously sintered structure that is at least 1 millimeter (mm), 2 mm, 5 mm or 10 mm. The scaffold may comprise a continuously sintered structure having dimensions between any of the afore-mentioned dimensions (e.g., from about 1 mm to about 10 mm, or from about 1 mm to about 5 mm). The supporting scaffold may engulf the 3D object. The supporting scaffold may float anchorlessly in the material bed. The scaffold may comprise a lightly sintered structure. In some examples, the 3D object may be printed without a supporting scaffold.

In some cases, the 3D object comprises an overhang structure. An overhang structure (also referred to herein as “overhang” or “overhang region”) can refer to a portion of a 3D object that protrudes a distance from previously transformed portion of the 3D object. The previously transformed portion may be a portion of the 3D object that is hardened (e.g., solidified or partially solidified). The previously transformed portion may be referred to herein as a “rigid portion.” The rigid portion may comprise the bulk core, e.g., generated by a bidirectional alternating hatching methodology. The rigid portion may comprise the shallow core, e.g., generated by a unidirectional hatching methodology, e.g., to connect the bulk core with a hanging structure generated by a tiling printing methodology, e.g., the LPM methodology. In some cases, at least a fraction of the previously transformed portion is formed using a hatching energy beam, as described herein. An overhang structure may comprise (e.g., correspond to) a ceiling (e.g., cavity ceiling), bottom (e.g., cavity bottom), protrusion, ledge, blade, wing, hanging structure, undercut, projection, protuberance, balcony, wing, leaf, extension, shelf, jut, hook, or step of a 3D object. The overhang may be a ledge off an edge of a previously transformed portion of the 3D object. The overhang may be free of auxiliary support during printing. For example, the overhang may be formed on (e.g., attached to) a previously transformed portion of the 3D object. A non-supported overhang may be referred to as “free-floating” in that the overhang may “float” anchorlessly within pre-transformed material (e.g., powder) during printing. A non-supported overhang may be referred to as “non-anchored” in that the overhang may not be directly connected to the platform. The previously transformed portion may comprise one or more supports (e.g., that are coupled with the platform). The overhand may be connected to another portion of the 3D object on one of its sides (e.g., and otherwise not anchored or connected). The surface (e.g., bottom surface) of an overhang may have a surface roughness at or below a prescribed roughness measurement (e.g., as described herein).

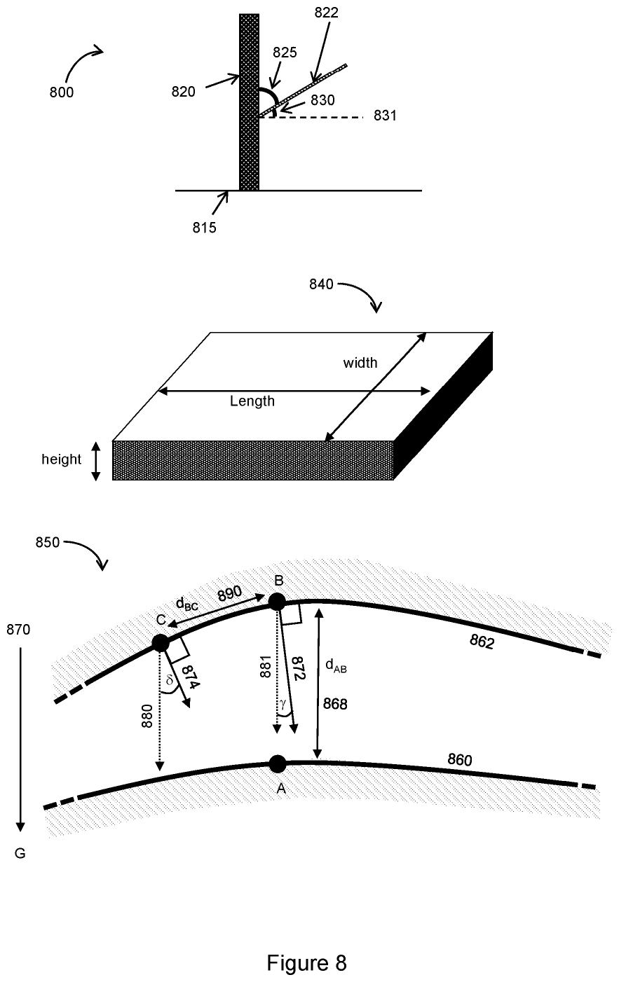

In some embodiments, the overhang if formed on a previously-transformed portion (also referred to herein as rigid portion) of the object. FIG. 8 shows in example 800 schematic depiction of an overhang 822 connected to a rigid portion 820. The rigid portion may be connected (e.g., anchored) to a platform (e.g., FIG. 8, 815) (e.g., base of the platform). The overhang may be printed without auxiliary supports other than the connection to the one or more rigid portions (e.g., that are part of the 3D object). The overhang may be formed at an angle (e.g., FIG. 8, 830) with respect to the build plane and/or platform (e.g., FIG. 8, 815). The overhang and/or the rigid portion may be formed from the same or different pre-transformed material (e.g., powder). The overhang can form a first angle (e.g., FIG. 8, 825) with respect to the rigid portion (e.g., FIG. 8, 820). The overhang can form a second angle (e.g., FIG. 8, 830) with respect to a plane (e.g., FIG. 8, 831) that is (e.g., substantially) parallel with the support surface of the platform, to the layering plane, and/or a normal to the layering vector (e.g., were the layer refer to the layerwise deposition of the transformed material to form the 3D object). In some embodiments, a plane (e.g., FIG. 8, 831) that is (e.g., substantially) parallel with the support surface of the platform corresponds to a layering plane.

In some embodiments, 3D printing methodologies are employed for printing at least one 3D object that is substantially two-dimensional, such as a wire or a planar object. The 3D object may comprise a plane like structure (referred to herein as “planar object,” “three-dimensional plane,” or “3D plane”). The 3D plane may have a relatively small thickness as opposed to a relatively large surface area. The 3D plane may have a relatively small height relative to its width and length. For example, the 3D plane may have a small height relative to a large horizontal plane. FIG. 8 shows in example 840 of a 3D plane that is substantially planar (e.g., flat). The 3D plane may be planar, curved, or assume an amorphous 3D shape. The 3D plane may be a strip, a blade, or a ledge. The 3D plane may comprise a curvature. The 3D plane may be curved. The 3D plane may be planar (e.g., flat). The 3D plane may have the shape of a curving scarf. The term “3D plane” is understood herein to be a generic (e.g., curved) 3D surface. For example, the 3D plane may be a curved 3D surface. The one or more layers within the 3D object may be substantially planar (e.g., flat). The planarity of a surface or a boundary the layer may be (e.g., substantially) uniform. Substantially uniform may be relative to the intended purpose of the 3D object. The height of the layer at a position may be compared to an average layering plane. The layering plane can refer to a plane at which a layer of the 3D object is (e.g., substantially) oriented during printing. A boundary between two adjacent (printed) layers of hardened material of the 3D object may define a layering plane. The boundary may be apparent by, for example, one or more melt pool terminuses (e.g., bottom, or top). A 3D object may include a plurality of layering planes (e.g., with each layering plane corresponding to each layer). In some embodiments, the layering planes are (e.g., substantially) parallel to one another. An average layering plane may be defined by a linear regression analysis (e.g., least squares planar fit of the top-most part of the surface of the layer of hardened material). An average layering plane may be a plane calculated by averaging the material height at each selected point on the top surface of the layer of hardened material. The selected points may be within a specified region of the 3D object. The deviation from any point at the surface of the planar layer of hardened material may be at most 20% 15%, 10%, 5%, 3%, 1%, or 0.5% of the height (e.g., thickness) of the layer of hardened material.

In some cases, the 3D object comprises an overhang structure. An overhang structure (also referred to herein as “overhang” or “overhang region”) can refer to a portion of a 3D object that protrudes a distance from previously transformed portion of the 3D object. In an example, the overhand structure is not directly vertically supported, e.g., by auxiliary supports. The previously transformed portion may be a portion of the 3D object that is hardened, e.g., solidified or partially solidified. The previously transformed portion may be referred to herein as a “rigid portion.” In some cases, at least a fraction of the previously transformed portion is formed using a hatching energy beam, as described herein. An overhang structure may comprise (e.g., correspond to) a ceiling (e.g., cavity ceiling), bottom (e.g., cavity bottom), protrusion, ledge, blade, wing, hanging structure, undercut, projection, protuberance, balcony, wing, leaf, extension, shelf, jut, hook, or step of a 3D object. The overhang may be a ledge off an edge of a previously transformed portion of the 3D object. The overhang may be free of supports during printing, e.g., free of auxiliary supports directly supporting it vertically. For example, the overhang may be printed on (e.g., attached to) a previously transformed portion of the 3D object. An overhang that is not directly vertically supported may be referred to as “free-floating,” e.g., as that the overhang may “float” anchorlessly within pre-transformed material (e.g., powder) during printing in a material bed. A non-supported overhang may be referred to as “non-anchored” in that the overhang may not be directly connected to the platform. The previously transformed rigid portion may comprise one or more supports, e.g., that are coupled with the build platform. The overhang may be connected to another portion of the 3D object on one of its sides, e.g., and otherwise not anchored or connected. A surface (e.g., bottom surface) of an overhang may have a surface roughness at or below a prescribed roughness measurement, e.g., as described herein.

In some cases, the 3D object includes a skin. The skin can correspond to a portion of the 3D object that includes an exterior surface of the 3D object. The skin may be referred to herein as an “outer portion,” or “exterior portion” of the 3D object. In some embodiments, the skin is a “bottom” skin, which can correspond to a skin on a bottom of overhang with respect to a platform surface during a printing operation. In some cases, the bottom skin of an overhang has a different surface quality than other portions of the 3D object. The surface quality can include a surface roughness, appearance, reflectivity, specularity, and/or shininess. Techniques for controlling the surface quality of the bottom skin of an overhang are described herein.

In some cases, the overhang is printed in the material bed in relation to the pre-transformed material, e.g., powder. FIG. 8 shows in example 850 of a first (e.g., top) surface 860 and a second (e.g., bottom) surface 862. At least a portion of the first and second surfaces are separated by a gap. At least a portion of the first surface is separated by at least a portion of the second surface, e.g., to constitute a gap. The gap may be filled with pre-transformed or transformed (e.g., and subsequently hardened) material, e.g., during the formation of the 3D object. The gap can comprise pre-transformed material during the printing. The gap may comprise a gas after the printing. The second surface may be a bottom skin layer. FIG. 8 shows an example of a vertical gap distance 868 that separates the first surface 860 from the second surface 862. The vertical gap distance may be equal to the vertical distance of the gap as disclosed herein. A point A (e.g., in FIG. 8, example 850) may reside on the top surface of the first portion. A point B (e.g., in FIG. 8, example 850) may reside on the bottom surface of the second portion. The second portion may be a cavity ceiling or hanging structure (e.g., ledge or overhang) as part of the 3D object. The point B may reside above point A. The gap may be the (e.g., shortest) distance (e.g., vertical distance) between points A and B. FIG. 8 shows an example of the gap 868 that constitutes the shortest distance dAB between points A and B. There may be a first normal to the bottom surface of the second portion at point B. FIG. 8 shows an example of a first normal 872 to the surface 862 at point B. The angle between the first normal 872 and the direction of the gravitational acceleration vector 870 (e.g., pointing towards the gravitational center of the ambient environment) may be any angle y. A point C (e.g., in FIG. 8, example 850) may reside on the bottom surface of the second portion. There may be a second normal to the bottom surface of the second portion at point C. FIG. 8 shows an example of the second normal 874 to the surface 862 at point C. The angle between the second normal 874 and the direction of the gravitational acceleration vector 870 may be any angle o. Vectors 880, and 881 are parallel to the gravitational acceleration vector 870. The angles y and o may be the same or different. The angle between the first normal 872 and/or the second normal 874 to the direction of the gravitational acceleration vector 870 may be any angle. The angle between the first normal 872 and/or the second normal 874 with respect to the normal to the substrate (e.g., platform) may be any angle. The angle between the first normal 872 and/or the second normal 874 with respect to the normal to the substrate (e.g., platform) may be any angle disclosed herein for the angled structure. The angles y and o may be any angle. The angles y and o may be any of any angled structure (e.g., acute, or obtuse). For example, the angle between the first normal (e.g., FIG. 8, 872) and the second normal (e.g., FIG. 8, 874) may be at most about 48 degrees (0), 40°, 30°, 20°, 10°, 5°, 3°, 2°, 1°, or 0.5°. The shortest distance between points B and C may be any value of the auxiliary support feature spacing distance mentioned herein. For example, the shortest distance BC (e.g., dBC) may be at least about 0.1 millimeters (mm), 0.5 mm, 1 mm, 1.5 mm, 2 mm, 3 mm, 4 mm, 5 mm, 10 mm, 15 mm, 20 mm, 25 mm, 30 mm 35 mm, 40 mm, 50 mm, 100 mm, 200 mm, 300 mm, 400 mm, or 500 mm. As another example, the shortest distance BC may be at most about 500 mm, 400 mm, 300 mm, 200 mm, 100 mm, 50 mm, 40 mm, 35 mm, 30 mm, 25 mm, 20 mm, 15 mm, 10 mm, 5 mm, 4 mm, 3 mm, 2 mm, 1.5 mm, 1 mm, 0.5 mm, or 0.1 mm. FIG. 8 shows an example of the shortest distance BC (e.g., 890, dBC). The bottom skin layer may be the first surface and/or the second surface. The bottom skin layer may be the first formed layer of the 3D object. The bottom skin layer may be the first formed hanging layer in the 3D object (e.g., that is separated by a gap from a previously transformed portion (e.g., previously transformed layer) of the 3D object). The vertical distance of the gap may be at least about 30 μm, 35 μm, 40 μm, 50 μm, 60 μm, 70 μm, 80 μm, 90 μm, 100 μm, 150 μm, 200 μm, 0.05 mm, 0.1 mm, 0.25 mm, 0.5 mm, 1 mm, 2 mm, 3 mm, 4 mm, 5 mm, 6 mm, 7 mm, 8 mm, 9 mm, or 10 mm. The vertical distance of the gap may be at most about 0.05 mm, 0.1 mm, 0.25 mm, 0.5 mm, 1 mm, 2 mm, 3 mm, 4 mm, 5 mm, 6 mm, 7 mm, 8 mm, 9 mm, 10 mm, or 20 mm. The vertical distance of the gap may be any value between the afore-mentioned values (e.g., from about 30 μm to about 200 μm, from about 100 μm to about 200 μm, from about 30 μm to about 100 mm, from about 80 mm to about 150 mm, from about 0.05 mm to about 20 mm, from about 0.05 mm to about 0.5 mm, from about 0.2 mm to about 3 mm, from about 0.1 mm to about 10 mm, or from about 3 mm to about 20 mm).

In some cases, the 3D object (e.g., once an object is removed from printer) comprises one or more characteristics that indicate the orientation of the object during printing. These characteristic(s) may be used to determine (e.g., infer) the location of overhangs of the object during its printing. For example, the object may comprise support marks, as described herein, that may indicate a “bottom” of the object during printing. In some cases, the object may include features (e.g., transition lines, surface steps, melt pools, grain boundaries, and/or layer markings) that indicate the orientation of one or more layers of the object during printing. In some instances, the “top” and “bottom” surfaces of the object, as oriented in the printer, will have different surface qualities (e.g., roughness). In some cases, the orientation of the object during printing can be determined (e.g., inferred) by hatch patterns indicative of changes in the direction of the energy beam(s) path(s). In some instances, the object includes lines corresponding to borders between tessellations, which may indicate the orientation of portions of the object. Examples of the calibration, control systems, controllers, and operation thereof, 3D printing systems and processes (e.g., including techniques for determining an orientation of an object), apparatus, methods, and computer programs, are disclosed in International Patent Application serial no. PCT/US18/20406, filed Mar. 1, 2018, which is entirely incorporated herein by reference.

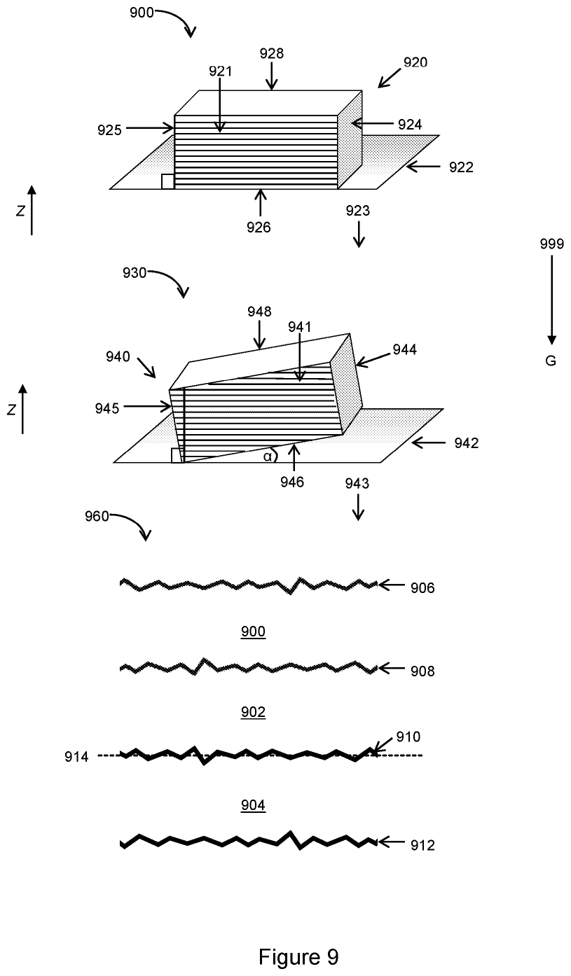

In some cases, characteristics of an object can be used to determine one or more layering planes. An average layering plane may correspond to a layer of transformed material that is deposited as part of the layerwise deposition process to print the 3D object. A layering plane can correspond to a (e.g., imaginary) plane that is (e.g., substantially) parallel to a layer of the 3D objects. A 3D object can have multiple layering planes. In some embodiments, a layering plane is (e.g., substantially) parallel to the support surface of the platform. The layering plane may be at an angle with respect to the surface of the 3D object. The angle may reveal the angle at which the object (or a portion of the object) was oriented with respect to the surface of the build platform and/or gravitational field vector. FIG. 9 shows in example 900 a 3D object 920 that is formed (e.g., substantially) horizontally on a support surface 922 of a platform. The layers of hardened material can be (e.g., substantially) parallel with respect to each other. Adjacent layers of hardened material may be integrally coupled with (e.g., chemically (e.g., metallically) bonded) with each other during the transformation (e.g., melting and/or sintering) process. A layering plane of the 3D object can be (e.g., substantially) parallel to one of the layers of hardened material (e.g., FIG. 9, 921) of the 3D object. The one or more layering planes can be (e.g., substantially) parallel with the platform support surface (e.g., FIG. 9, 922) and/or (e.g., substantially) orthogonal with respect to the gravity vector (e.g., FIG. 9, 923). In some cases, a layering plane is (e.g., substantially) parallel with respect to a bottom surface (e.g., FIG. 9, 926) and/or a top surface (e.g., FIG. 9, 928) of the 3D object. A layering plane may be oriented (e.g., substantially) orthogonal with respect to a side surface (e.g., 924 or 925) of the 3D object. FIG. 9 shows in example 930 a 3D object 940 having layers of hardened material 941 formed at an angle alpha (a) relative to the surface of a platform 942 and/or an angle of 90 degrees plus alpha (a) with respect to the gravity vector 943. A layering plane may be at the angle alpha (e.g., FIG. 9, a) with respect to the platform support surface (e.g., FIG. 9, 942) and/or (e.g., substantially) orthogonal with respect to the gravity vector (e.g., FIG. 9, 943). In some cases, a layering plane is non-parallel with respect to a bottom surface (e.g., FIG. 9, 946) and/or a top surface (e.g., FIG. 9, 948) of the 3D object. Objects 900 and 930 are depicted relative to gravitational vector 999 pointing towards the gravitational center of the ambient environment.

In some cases, a layering plane corresponds to an average layering plane. FIG. 9 shows in example 960 schematic vertical cross section of a portion of a 3D object having layers of hardened material 900, 902, and 904 sequentially formed during the 3D printing process. Boundaries (e.g., FIGS. 9, 906, 908, 910 and 912) between the layers may be visible (e.g., by human eye or by microscopy). The boundaries between the layers may be evident by a microstructure of the 3D object. The boundaries between the layers may be (e.g., substantially) planar. The boundaries between the layers may have some irregularity (e.g., roughness) due to the transformation (e.g., melting and or sintering) process (e.g., and formation of melt pools). An average layering plane (e.g., FIG. 9, 914) may correspond to a (e.g., imaginary) plane that is estimated or calculated average. A calculated average may correspond to an arithmetic mean of (e.g., of number of point locations on a boundary between layers). A calculated average may be calculated using, for example, a linear regression analysis. In some cases, the average layering plane consider deviations from a nominal planar shape.

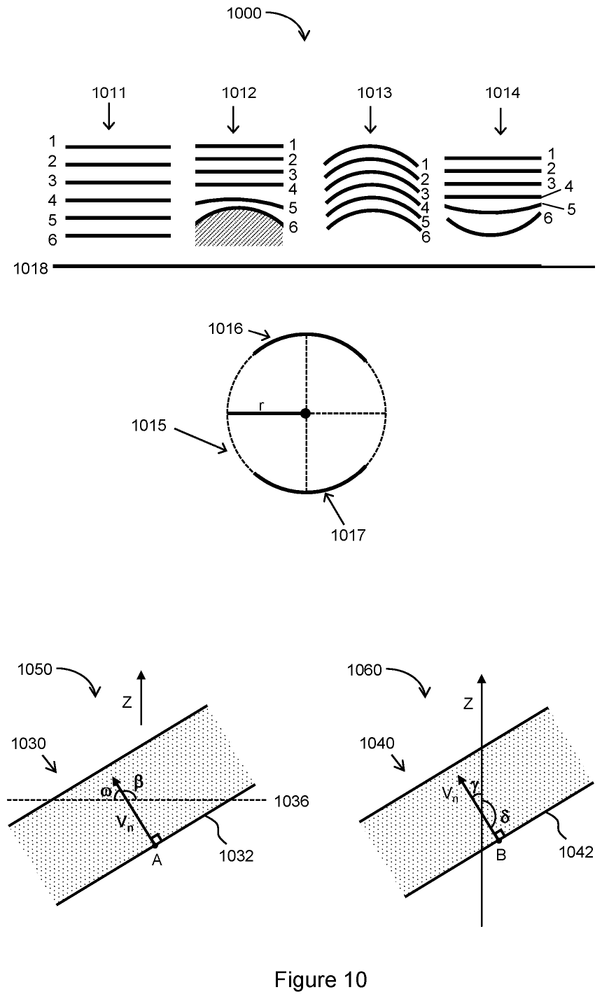

In some instances, a (e.g., average) layering plane determination considers a curvature of the one or more layers of hardened material. FIG. 10 shows in example 1000, schematic vertical cross sections of 3D objects 1011, 1012, 1013 and 1014, each having multiple layers 1-6 relative to a platform surface 1018. The 3D object may comprise (e.g., substantially) planar layers (e.g., FIG. 10, 1011 (layers 1-6), 1012 (layers 1-4) or 1014 (layers 1-3)). The 3D object may comprise (e.g., substantially) non-planar layers (e.g., FIG. 10, 1012 (layers 5-6), 1013 (layers 1-6) or 1014 (layers 4-6) (e.g., each having a radius of curvature). An average layering plane of layers that are non-planar may correspond to a plane that is calculated (e.g., by linear regression analysis) of the non-planar layer. FIG. 10 shows example super-positions 1016 and 1017 of a curved layer on a circle 1015 having a radius of curvature “r.” The one or more layers may have a radius of curvature equal to the radius of curvature of the layer surface. The radius of curvature may equal infinity (e.g., when the layer is (e.g., substantially) planar). The radius of curvature of at least one the layer of the 3D object (e.g., all the layers of the 3D object, the bottom skin layer, and/or the overhang) may have a value of at least about 1 cm, 3 cm, 5 cm, 10 cm, 20 cm, 40 cm, 60 cm, 80 cm, 1 meter (m), 2 m, 4 m, 5 m, 10 m, 20 m, 30 m, 50 m, or 100 m. The radius of curvature of at least one layer of the 3D object (e.g., all the layers of the 3D object) may have any value between any of the afore-mentioned values of the radius of curvature, e.g., from about 1 cm to 100 m. In some embodiments, a layer with an infinite radius of curvature is a layer that is planar. In some examples, the one or more layers may be included in a planar section of the 3D object, or may be a planar 3D object, e.g., a flat plane, or 3D plane. In some instances, part of at least one layer within the 3D object may have any of the radii of curvature mentioned herein, which will designate the radius of curvature of that layer portion.

In some cases, an overhang of a 3D object is at least partially defined with respect to a layering plane and/or a stacking vector (also referred to herein as a “build direction”) of the 3D object. A stacking vector (which may be indicated by directional vector “Z”), can indicate a direction in which the layers of the 3D object were bonded together (e.g., sequentially printed). When indicated with a vector “Z,” the direction of the vector may correspond to the (e.g., temporal) sequential bonding of the layers. In some embodiments, the stacking vector is opposite of a gravitational field vector. FIG. 10 shows in example 1050 a sectional view of an overhang portion 1030 of a 3D object. The bottom surface of an overhang can have an exterior surface (e.g., FIG. 10, 1032), where a vector normal (e.g., FIG. 10, Vn) to the exterior surface at a point (A) that is (i) directed into the object and (ii) has a positive projection onto the stacking vector (e.g., FIG. 10, “Z”), is at an acute angle (e.g., omega (w)) and/or an obtuse angle (beta (13)) with respect to a layering plane (or an average layering plane) (e.g., FIG. 10, 1036). The acute angle (e.g., FIG. 10, omega (w)) and the obtuse angle (e.g., FIG. 10, beta (13)) may be supplementary angles. The acute angle (e.g., FIG. 10, omega (w)) can be at least about 45 degrees (0), 50°, 55°, 60°, 70°, 80°, 85° or 89°. The acute angle (e.g., FIG. 10, omega (w)) can range between any of the aforementioned angles (e.g., from about 450 to about 1090, from about 45° to about 60°, from about 60° to about 109°, or from about 70° to about) 109°. The acute angle (e.g., FIG. 10, omega (w)) can be at most about 90 degrees. Example 1060 of FIG. 10 shows an example of a section view of an overhang portion 1040 of a 3D object. In some embodiments, a bottom surface of an overhang can have an exterior surface (e.g., FIG. 10, 1042), where a vector normal (e.g., FIG. 10, Vn) to the exterior surface at a point (B) that is (i) directed into the object and (ii) has a positive projection onto the stacking vector (e.g., FIG. 10, “Z”) that is at an acute angle (e.g., FIG. 10, gamma (γ)) and/or an obtuse angle (e.g., FIG. 10, delta (8)) with respect to the stacking vector. The acute angle (e.g., FIG. 10, gamma (γ)) and the obtuse angle (e.g., FIG. 10, delta (8)) may be supplementary angles. The acute angle (e.g., FIG. 10, gamma (γ)) can be at most about 45°, 40°, 35°, 30°, 25°, 20°, 15°, 10°, 5°, 10 or 0°. The acute angle (e.g., FIG. 10, gamma (γ)) can range between any of the afore-mentioned angles (e.g., from about 0° to 45°, from about 30° to about 45°, from about 0° to about 30°, or from about 0° to about) 40°. The acute angle (e.g., FIG. 10, gamma (γ)) can be at most about 90 degrees.

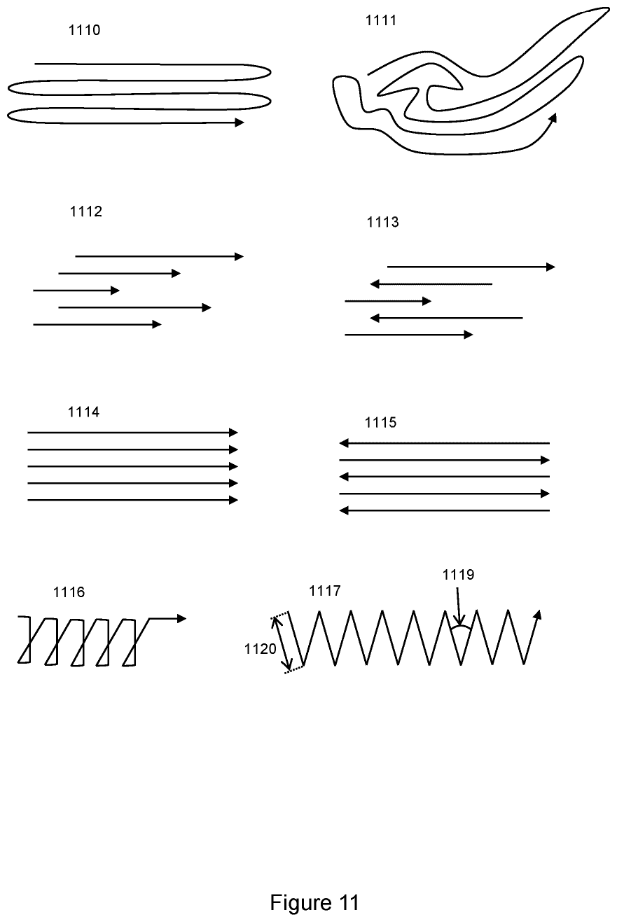

In some cases, a characteristic of the energy beam relates to the path of the energy beam. The path can correspond to a route in which the energy beam travels along the target surface (e.g., material bed). FIG. 1 shows an example of an aerial view of a path 101. The path may resemble sowing stitch (e.g., straight, lock, zigzag, overcasting, blind, shell fluck, or darning stitch). The zigzag stitch may comprise a single point zigzag or a multiple point (e.g., 2, or 3) point zigzag stitch. In cases, the path can be separated into sub-paths. FIG. 1 shows an example sub-path 102, which is a magnification of a portion of the path 101. The sub-path can have deviations (e.g., oscillations) with respect to the path. The path can have any shape. FIG. 11 shows example aerial views of various paths. The path may be continuous (e.g., FIG. 11, 1110, 1111, 1116, or 1117) or discontinuous (e.g., FIG. 11, 1112, 1113, 1114, or 1115). A continuous path may form a path of transformed material in the material bed. A discontinuous path may comprise intervals at which the energy beam is (e.g., substantially) stationary. A (e.g., substantially) stationary energy beam may form a tile of transformed material in the material bed.

In some embodiments, the energy beam follows a path during printing. The path may be a hatch, path of tiles, or elongated melt pool. The energy may follow the path that comprises parallel lines or non-parallel lines. The distance between the parallel lines may be substantially the same in a layer of transformed material of a 3D object. The distance between the parallel lines may be substantially the same in at least two layers of transformed material of a 3D object. The distance between the parallel lines in one layer (e.g., plane) of transformed material may be different than the distance between the parallel lines in another layer (e.g., plane) of transformed material within the 3D object. The distance between the parallel lines portions within a layer (e.g., plane) of transformed material may be substantially constant. The distance between the parallel lines within a layer (e.g., plane) of transformed material may be varied. The distance between a first pair of parallel lines or hatch lines within a layer (e.g., plane) of transformed material may be different than the distance between a second pair of parallel lines or hatch lines within a layer (e.g., plane) of transformed material, respectively. The first energy beam may follow a path comprising two lines that contact in at least one point. The path may comprise one or more straight lines. The path may be along a vector. The path may comprise vectors in a direction, e.g., FIG. 11, 1112 or 1114. The path may alternate in a back and forth pattern, e.g., along alternating vectors. The path may be unidirectional, e.g., vectors propagating a direction such as parallel vectors pointing in a direction, e.g., FIG. 11, 1112 or 1114. The path may be bidirectional, e.g., vectors propagating opposing directions such as parallel vectors pointing in opposing directions, e.g., FIG. 11, 1113, or 1115. The path may comprise alternating vectors in opposing directions, e.g., FIG. 11, 1113, or 1115. The path may alternate in a back and forth pattern, e.g., alternating vectors in different directions such as non-parallel vectors. Each pair of contacting non-parallel vectors may relate to each other via a mirror plane intersecting the contact point, e.g., to generate a zigzag pattern such as in FIG. 11, 1117.

At times, the printing of a (e.g., complex) 3D object comprises a combination of printing methodologies, e.g., having respective process parameters. Two of the printing methodologies differ by at least one process parameter. In an example, two of the printing methodologies differ by at least one energy beam characteristic. In some cases, different printing methodologies may be used to print different portions of the 3D object. Printing the portion of the 3D object may comprise transforming a starting material to the transformed material or transforming (e.g., curing) a first transformed material to become a second transformed material. There may be at least 2, 3, 4, 5, or more printing methodologies. In an example, there are five printing methodologies utilized to print the 3D object. The printing methodologies may comprise alternating core hatching, non-alternating core hatching, LPM, HARMP, or stitch coupling such as stitch closure. In some embodiments, the alternating core hatching methodology is utilized to print a first portion (e.g., core) of the 3D object devoid of hanging structure(s), e.g., cavities and/or ledges. The alternate core hatching may be utilized to generate the bulk core. The bulk core may be directly vertically coupled with the build platform, e.g., by itself and/or through auxiliary supports. The alternate core hatching methodologies may be utilized to generate an interior portion of the 3D object. The alternating core hatching methodology may be utilized to generate a directly vertically supported portion of the 3D object, e.g., supported by the platform with or without auxiliary supports. The alternating core hatching methodology may utilize an energy beam path comprising parallel vectors that successively alter in their direction, e.g., leading the energy beam to propagate in a progressive back and form movement. In some embodiments, the non-alternating core hatching methodology is utilized to print a second portion (e.g., shallow core portion) coupling the first portion of the 3D object with a hanging structure. The non-alternating core hatching methodology may utilize an energy beam path comprising parallel vectors that propagate in the same direction, e.g., leading the energy beam to propagate in the same direction. The non-alternative core hatching method may generate hatches that are (e.g., substantially) parallel to the edge (e.g., rim) of the structure during its printing. The non-alternating core hatching may be slower than the alternating core hatching method, e.g., since in the non-alternating core hatching the returning beam in a back and forth movement of the beam is not utilized for the printing. The non-alternative core hatching method may generate hatches that are (e.g., substantially) parallel to the edge (e.g., rim) of the structure during its printing. In some embodiments, the methodologies comprise “liquid phase manipulation” (abbreviated as “LPM”). In some embodiments, the LPM methodology is utilized to print a third portion coupling being of the hanging structure. In some embodiments, the LPM methodology is utilized to print a third portion, e.g., extending from the shallow core portion. The LPM methodology may utilize a tiling printing strategy, the tiles propagating along a path of tiles. In some embodiments, the HARMP methodology is utilized to print (e.g., cure such as densify) a previously printed portion of the 3D object to generate a fourth portion of the printed 3D object, e.g., to densify a shallow core portion and/or an LPM portion. The shallow core methodology may facilitate reducing structural defects in the printed 3D object, e.g., reducing warping of portion(s) of the 3D object during and/or after the printing. Since the shallow core methodology utilizes uni-directional hatching, it can be slower (e.g., if using the same beam propagation speed) as compared to the bulk core methodology using the bidirectional hatching. The shallow core methodology may utilize an energy beam generated by a lower energy as compared to the energy beam generating the bulk core. The lower energy can be at least about 2.5*3*, 4*or 5* lower as compared to the energy used to generate the bulk core energy beam. The shallow core methodology may utilize an energy beam moving at a lower speed as compared to the energy beam generating the bulk core. The lower speed can be at least about 20%, 30%, 50%, 60%, or 75% slower as compared to the speed of the energy beam used to generate the bulk core. The bulk core and the shallow core may be generated by a focused beam, e.g., having a gaussian beam profile or any other beam profile disclosed herein. The bulk core and the shallow core may be generated by a (e.g., slightly) defocused beam, e.g., having a gaussian beam profile or any other beam profile disclosed herein. The FLS of the footprint of the beam generating the shallow core may be different (e.g., smaller) than the FLS of the footprint of the beam generating the bulk core. The smaller footprint can be at least about 1.5*2* or 3* smaller. At times, the distance between two parallel hatches are (e.g., substantially) the same in the shallow core and in the bulk core, e.g., in at least one printed layer and/or in the 3D object. At times, the distance between two parallel hatches are different (e.g., smaller) in the shallow core as compared to those in the bulk core, e.g., in at least one printed layer and/or in the 3D object. The melt pools of the shallow core may be more organized as compared to the melt pools forming the bulk core. The melt pools of the shallow core may be smaller in surface area (e.g., and in FLS) as compared to the melt pools forming the bulk core. In some embodiments, the stitch coupling methodology is utilized to print a fourth portion coupling a first LPM portion with a second LPM portion. The stitch coupling may include (a) curing a previously printed portion(s) of the 3D object and/or (b) transform a starting material to a transformed material as part of the 3D object. Each of the different printing methodologies may comprise at least one process parameter that is different. The process parameter(s) may comprise at least one beam parameter. Each of the different printing methodologies may comprise at least one energy beam characteristic that is different. The energy beam characteristic(s) may comprise (a) energy source power, (b) FLS of beam cross section (e.g., at the target surface and/or normal to its projection path), (c) power per unit area (e.g., intensity) at the target surface, (d) translation speed along the path, (e) focus/dispersion, (f) path type, (g) wavelength, (h) angle of impingement on the target surface, or (i) direction of path propagation relative to a horizontal edge of the printed layer portion. The path type may comprise unidirectional vectors, non-unidirectional vectors. The path may comprise hatching, or a path of tiles. The path may comprise generated melt pools. The generated melt pool may be hatching, HARMP, LPM, or elongated melt pool such as used in the stitching coupling methodology. The non-unidirectional hatching may comprise alternating opposing directional hatching, or alternating mirroring vectors such as in a zigzag pattern. The aspect ratio of the generate melt pool can be one of an elongated shallow melt pool, (e.g., substantially) round and deep melt pool, or globular melt pool. In an example, the tile may comprise a (e.g., substantially) globular melt pool. In an example, the HARMP melt pool may comprise a deep melt pool having a diameter smaller than its depth. In an example, the hatch may comprise an elongated melt pool having a shallow depth as compared to the longer axis of the surface of the melt pool (e.g., bounding ellipse thereof). In an example, the stitch coupling may comprise an elongated melt pool having a shallow depth as compared to the longer axis of the surface of the melt pool (e.g., bounding ellipse thereof). In an example, the hatching melt pool may comprise a first elongated melt pool having a first long axis of the surface of the melt pool (e.g., bounding ellipse thereof), and a first short axis; the stitch coupling may comprise a second elongated melt pool having a second long axis of the surface of the melt pool (e.g., bounding ellipse thereof), and a second short axis; where (a) the first short axis is shorter than the second short axis and/or (b) the first long axis is longer than the second long axis. Examples of 3D printing systems, apparatuses, devices, components, controllers, software, and 3D printing processes can be found in International Patent Application serial no. PCT/US19/24402, filed Mar. 27, 2019, and in International Patent Application serial no. PCT/US18/20406, filed Mar. 1, 2018, each of which is entirely incorporated herein by reference.

In some embodiments, several energy beams are utilized to generate the 3D object. Each of the energy beams may be utilized to process a different portion of the 3D object, e.g., simultaneously. Each of the energy beams may be utilized to process a different portion of a layer of the 3D object, e.g., simultaneously. At least two of the energy beams are directed to execute different printing methodologies, e.g., as disclosed herein. At least two of the energy beams are directed under different process parameters, e.g., having at least one process parameter that is different. At least two of the energy beams are directed under different energy beam characteristics, e.g., having at least one energy beam characteristic that is different. Various apparatuses (e.g., controllers), systems (e.g., 3D printers), software, methods related to types of energy beam and formation of 3D objects (e.g., generated using type-2 (tiling) and/or type-1 (hatching)), as well as various control schemes are described in U.S. patent application Ser. No. 15/435,128; international patent application number PCT/US17/18191; European patent application number EP17156707.6; and international patent application number PCT/US18/20406, each of which is entirely incorporated herein by reference.

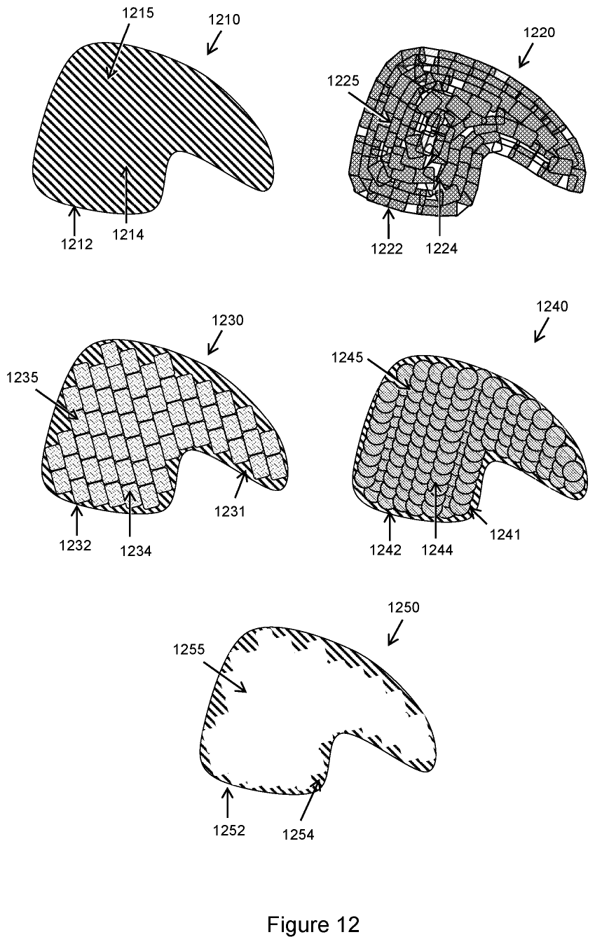

In some embodiments, an object has hatches and/or tiles. FIG. 12 show examples of aerial views of various layers of hardened material. Each of layers in the examples of FIG. 12 can correspond to one of a number of stacked layers of one or more 3D objects. Each layer may have an exterior portion (which can correspond to a portion of a skin of the 3D object) that surrounds an interior portion (also referred to as “core” or “internal portion”) of the layer. The exterior portion may be a skin or a portion of the skin. The exterior and interior portion may be generated using the same type of energy beam, or different types of energy beams. In some embodiments, the exterior portion (or parts of the exterior portion) is formed prior to forming the interior portion. In some embodiments, the interior portion (or parts of the interior portion) is formed prior to forming the exterior portion. In some embodiments, the exterior and interior portion are formed (e.g., substantially) simultaneously. The exterior portion and/or the interior portion can comprise hatches and/or tiles. FIG. 12 shows an example of a layer 1210 having an exterior portion 1212 and an interior portion 1214 comprising hatches 1215 (e.g., formed using a hatching energy beam). FIG. 12 shows an example of a layer 1220 having an exterior portion 1222 and interior portion 1224 comprising tiles 1225 (e.g., formed using a tiling energy beam). FIG. 12 shows an example of a layer 1230 having an exterior portion 1232 comprising hatches 1231 (e.g., formed using a hatching energy beam) and an interior portion 1234 comprising tiles 1235 (e.g., formed using a tiling energy beam). FIG. 12 shows an example of a layer 1240 having an exterior portion 1242 comprising hatches 1241 (e.g., formed using a hatching energy beam), and an interior portion 1244 comprising tiles 1245 (e.g., formed using a tiling energy beam). FIG. 12 shows an example of a layer 1250 having a rim 1252 comprising hatches 1254 (e.g., formed using a hatching energy beam) and an interior portion 1255 that is free of hardened material. For example, the tiles may have elliptical (e.g., round) cross-sections (e.g., 1244). For example, the tiles may be rectangular (e.g., square) cross-sections (e.g., 1225; or 1235). In some cases, the tiles appear crescent-shaped or scallop-shaped, as described herein. In some embodiments, at least two sequential tiles overlap with each other at least in part. The overlapped area may be at least about 10%, 20%, 30%, 40%, 50%, 60%, 70%, 80% or 90% of the average or mean tile area. The overlapped area may be at most about 10%, 20%, 30%, 40%, 50%, 60%, 70%, 80% or 90% of the average or mean tile area. The overlapped area may be between any of the afore-mentioned values (e.g., from about 10% to about 90%, from about 10% to about 50%, or from about 40% to about 90%) of the average or mean tile area. The percentage of overlapped area may be (e.g., substantially) identical along the path of the energy beam forming the tiles.

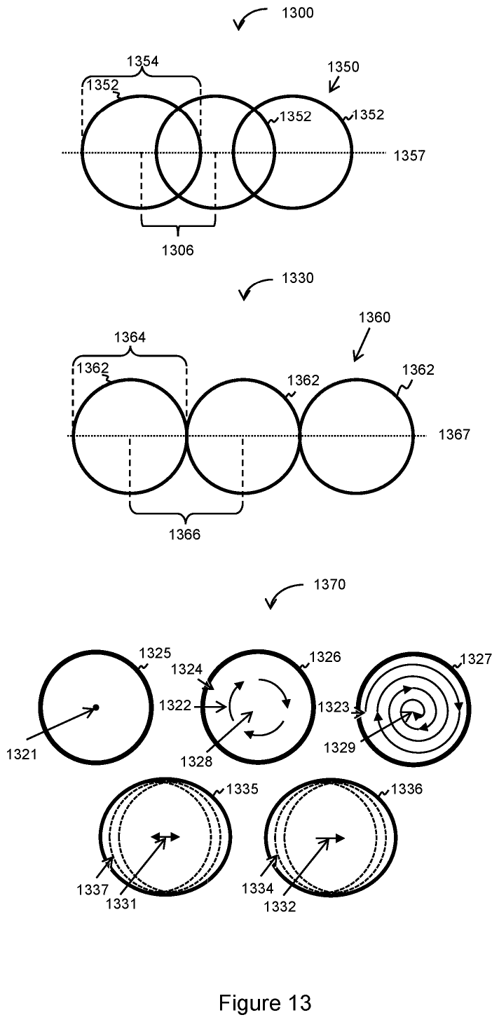

In some embodiments, the size (e.g., FLS and/or volume) of a tile corresponds with a respective size of a melt pool forming the tile. FIG. 13 shows in examples 1300 and 1330 schematic cross-section views of overlapping tiles and non-overlapping tiles. FIG. 13 shows in example 1300, a horizontal cross-sectional view of a portion of a plurality of overlapping tiles (e.g., 1352) disposed along a path 1357 that collectively form a row-of-tiles 1350. The tiles along the row-of-tiles may have (e.g., substantially) the same FLS (e.g., same cross section or footprint (e.g., FIG. 13, 1354)) on the target surface. The overlapping tiles may be spaced apart from each other by a (e.g., substantially) uniform distance (e.g., FIG. 13, 1306) (e.g., as measured from centers of directly adjacent tiles, e.g., successive tiles). The overlapping tiles may be spaced apart from each other by a non-uniform distance (as measured from centers of directly adjacent tiles). The overlapping tiles may be spaced apart by distance that is less than a FLS (e.g., diameter (e.g., FIG. 13, 1354)) of the tiles. In some embodiments, a distance between the tile centers of overlapping tiles is at least about 0.99, 0.9, 0.75, 0.6, 0.5, 0.25, or 0.01 times a FLS (e.g., diameter) of a horizontal cross section of the exposed surface of the tiles. In some embodiments, the distance between the tile centers of overlapping tiles ranges between any suitable ranges described above, e.g., from about 0.5 to about 0.75, from about 0.25 to about 0.75, or from about 0.5 to about 0.6 times a FLS (e.g., diameter) of a horizontal cross section of the exposed surface of the tiles. FIG. 13 shows in example 1330, a horizontal cross-sectional view of a portion of tile collection 1360 comprising non-overlapping tiles (e.g., 1362) that are arranged along a path of tiles to form a row of tiles 1367. The non-overlapping tiles may be spaced apart from each other by a (e.g., substantially) uniform distance (e.g., FIG. 13, 1366), e.g., as measured from centers of directly adjacent tiles. The non-overlapping tiles may be spaced apart from each other by a non-uniform distance, e.g., as measured from centers of directly adjacent tiles. The non-overlapping tiles may be spaced apart by distance that is greater than a FLS (e.g., diameter, e.g., FIG. 13, 1364) of the tiles. In some embodiments, a distance between the tile centers of non-overlapping tiles is at least about 1.1, 1.25, 1.5, 1.75, 2 or 5 times a FLS (e.g., diameter) of a horizontal cross section of the exposed surface of the tiles. In some embodiments, the distance between the tile centers of non-overlapping tiles ranges between any suitable ranges described above, e.g., from about 1.1 to about 5, from about 1.1 to about 1.5, or from about 1.5 to about 5 times a FLS of a horizontal cross section of the exposed surface of the tiles. In some embodiments, a distance between tile centers of at least two of successive (overlapping or non-overlapping) tiles is at least about 10 micrometers (μm), 15 μm, 20 μm, 25 μm, 30 μm, or 35 μm, 50 μm, 70 μm, 80 μm, 100 μm, 200 μm, 250 μm, 300 μm, 350 μm, 400 μm, 450 μm or 500 μm. In some embodiments, the distance between the tile centers is at most about 50 millimeters (mm), 100 mm, 150 mm, 200 mm, 300 mm, 400 mm, or 500 mm. In some embodiments, the distance between the tile centers at least two of successive (overlapping or non-overlapping) tiles ranges between any of the aforementioned values, e.g., from about 10 μm to about 500 mm, from about 10 μm to about 500 μm, from about 500 μm to about 500 mm, or from about 15 μm to about 30 μm.

In some embodiments, a melt pool (e.g., tile) is formed by irradiating a target surface. A melt pool (e.g., tile) may be formed using a (e.g., substantially) stationary energy beam. FIG. 13 shows in example 1370, a melt pool (e.g., tile) having a circumference 1325 formed by an energy beam irradiation spot (also referred to herein as “footprint”) that is centered at position 1321 during formation of the melt pool (e.g., tile). In some embodiments, the irradiation spot (e.g., forming a melt pool, e.g., forming a tile) is formed at the exposed surface of a material bed. Substantially stationary may be relative to the speed and/or propagation direction of the energy beam along the path. For example, a substantially stationary energy beam may move slightly (e.g., move in a direction (e.g., back, forth, or a combination thereof), oscillate, move back and forth, e.g., like a pendulum movement about a point), and/or dither. The movement may be a directional movement (e.g., move backwards, move forward, or move at any combination thereof). The directional movement may be with respect to a path of successive melt pools and/or tiles. The movement can be with respect to (e.g., around) a point. The point may correspond to the center of the tile formed at the target surface. The length of the movement may be less than a FLS of the irradiation spot on the target surface. The length of the movement may be less than the FLS of the melt pool and/or tile (e.g., a horizontal cross section of the melt pool and/or tile, e.g., at the target surface). The movement may not include a spatial (e.g., lateral) movement greater than a FLS of the energy beam (e.g., cross section and/or irradiation spot on the target surface). The movement may not include a spatial (e.g., lateral) movement greater than a FLS of the melt pool and/or tile generated by the energy beam. FIG. 13 shows an example of a shape resembling oval 1335. The oval shape may be a tile, a melt pool, and/or a footprint of the energy beam on the target surface. The energy beam irradiation spot may center on a linear path (e.g., FIG. 13, 1331) and move in a back and forth movement along the path (e.g., FIG. 13, 1331) during formation of the tile. The path may be part of the path-of-tiles. The back and forth movement of the energy beam may cause the tile to have an FLS (e.g., FIG. 13, FLS of 1335) that is larger than a circumference (e.g., FIG. 13, 1337) of the irradiation spot of the energy beam at the target surface. The manner of tile formation may cause different temperature gradient profile at least along the horizontal cross section of the tile (e.g., also along the vertical direction and/or any combination of the horizontal and vertical direction). For example, when a melt pool (e.g., tile) is formed by one irradiation spot using a gaussian beam, the center of the melt pool (e.g., tile) may be hotter than its edges. A melt pool (e.g., tile) may be formed using an energy beam that propagates along a circling or spiraling path, to form a tile having a (e.g., substantially) circular cross section. FIG. 13 shows in example 1370, a melt pool (e.g., tile) having circumference 1326 formed by an energy beam that irradiates a portion of a target surface, which energy beam irradiation spot centers on an internal circular path having an arch 1322 and moves along the circular path during formation of the melt pool (e.g., tile). During its formation, the center of the melt pool (e.g., tile) (e.g., FIG. 13, 1326) may be hotter than an area close to a circumference (e.g., FIG. 13, 1324) of the melt pool (e.g., tile). FIG. 13 shows an example of a melt pool (e.g., tile) having a circumference 1327 formed by an energy beam that irradiates a portion of a target surface, which irradiation spot centers on a spiraling path that begins in position 1323 and ends in position 1329, and moves along the spiraling path during formation of the melt pool (e.g., tile) (e.g., an inward spiraling path). The center (e.g., FIG. 13, 1329) of the melt pool (e.g., tile) (e.g., FIG. 13, 1327) may be hotter than an area close to the circumference (e.g., FIG. 13, 1327) of the tile during its formation. The path may be an outward spiraling path. A melt pool (e.g., tile) may be formed using a slow-moving energy beam (e.g., moving in slow speed, e.g., 1332), for example, to form a melt pool (e.g., tile) having a horizontally elongated cross section (e.g., that is different from a horizontally circular cross-sectional tile). At times, the energy beam moves during tile formation along the path-of-tiles at a slow speed. The slow speed may be of at most about 5000 micrometers per second (μm/s), 1000 μm/s, 500 μm/s, 250 μm/s, 100 μm/s, 50 μm/s, 25 μm/s, 10 μm/s, or 5 μm/s. The slow speed may be of any value between the afore-mentioned values (e.g., from about 5000 μm/s to about 5 μm/s, from about 5000 μm/s to about 100 μm/s, or from about 500 μm/s to about 5 μm/s. FIG. 13 shows an example of a tile having a circumference resembling oval 1336 formed by an energy beam that irradiates a portion of a target surface, which irradiation spot centers on line 1332 and moves in a direction along line 1332 during formation of the melt pool (e.g., tile); circumference 1334 shows an example of the energy beam circumference at a point on the line 1331. The movement of the energy beam (e.g., along the circular, dithering, slow moving, and/or spiraling path) may be during a dwell time on the target surface (e.g., during a period of melt pool formation) to form the melt pool (e.g., tile).

In some instances, a high aspect ratio melt pool (HARMP) energy beam is used to modify (e.g., densify) a transformed material. The HARMP energy beam may be configured to generate a high aspect ratio melt pool. The high aspect ratio may be an aspect ratio greater than a 1:1.5, 1:2, 1:5, or 1:10 aspect ratio of diameter to melt pool depth. Such energy beam may be referred to as a high aspect ratio melt pool (abbreviated as “HARMP”) energy beam. The HARMP melt pool may be utilized to cure a previously printed portion of transformed material, e.g., to densify the previously formed portion of the transformed material, e.g., at least in part by releasing any trapped gas therefrom.

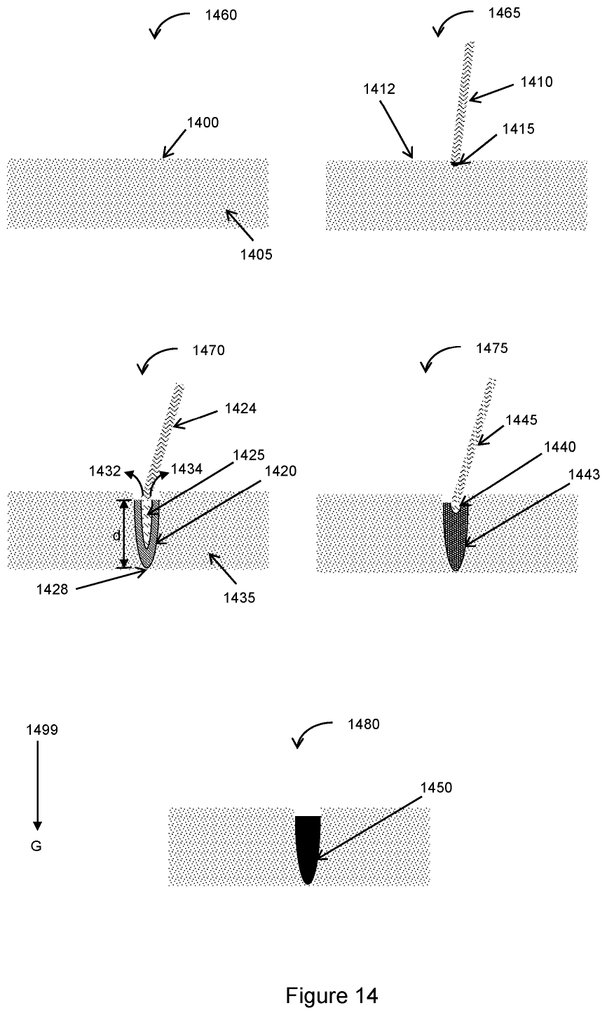

The energy beam (e.g., FIG. 13A, 1301) may be a tiling or hatching energy beam. The material beds shown in FIG. 14 are depicted relative to gravitational vector 1499 pointing towards the gravitational center of the ambient environment, e.g., Earth. FIG. 14 shows in examples 1460, 1465, 1470, 1475, and 1480, respective vertical cross sections of a portion of a 3D object being modified using a HARMP energy beam. Example 1460 shows an example of a target surface 1400 of one or more layers of material 1405 (e.g., a pre-transformed material (e.g., powder) or of a previously transformed. Example 1465 shows an example of irradiating a portion of the target surface 1412 using an energy beam 1410. In some cases, the energy beam irradiates a position (e.g., 1415) on the target surface in a (e.g., substantially) stationary manner (e.g., tiling). FIG. 14C shows an example of forming a HARMP 1420 having a depth of “d.” The HARMP may extend to a requested depth (e.g., 1470, up to a depth “d”). The requested depth may be to the bottom (e.g., 1428) of the one or more layers of material (e.g., 1435). The energy beam (e.g., 1424) may cause a portion (e.g., 1432 and/or 1434) of the one or more layers of material to exit the HARMP volume during its formation. The exiting material may comprise vapor, plasma, and/or other forms of sputtered (e.g., liquid (e.g., molten)) material. The exiting material may form a HARMP well (e.g., 1425), which can correspond to an open cavity. The HARMP well may be formed within at least a portion of the HARMP. At times, the energy beam (e.g., 1424) may be moved in a lateral direction to elongate the HARMP well in the lateral direction, for example, to increase the amount of transformed material in the lateral direction. In some cases, the opening of the HARMP well closes to form a pore (e.g., void) in the HARMP. The HARMP may comprise one or more pores. The position and/or number of pores may be controlled (e.g., in real time (e.g., using one or more controllers)). The controller(s) may control at least one characteristic of the energy beam and/or the energy source that generates it. In some instances, the HARMP comprises (e.g., on average) a low porosity percentage. In some instances, the HARMP comprises (e.g., substantially) no (e.g., detectable) pores. Example 1475 shows an example of closing of a HARMP well 1440 to form the HARMP 1443. The closing may comprise reducing (e.g., gradually) an intensity of the energy beam (e.g., 1445). The intensity reduction may include reducing the power per unit area of the energy beam. Reducing the intensity of the energy beam may include adjusting one or more optical elements of an optical system (e.g., an astigmatism system). Reducing the intensity of the energy beam may include adjusting one or more characteristics of the energy beam comprising its power profile over time, or its pulsation scheme. Reducing the intensity of the energy beam may include adjusting one or more characteristics of the energy source (e.g., its power). At times, the gradual intensity reduction of the energy beam may alter (e.g., reduce) its degree of penetration into the HARMP. A reduction of the energy beam penetration into the HARMP may allow liquid material to settle at the bottom of the HARMP well and close the opening of the HARMP well. A reduction of the energy beam penetration into the HARMP may reduce the amount of material that exits the HARMP during the irradiation of the energy beam, and thus reduce the size of the HARMP well. Example 1480 shows an example of the HARMP 1450 that has hardened (e.g., solidified). In some embodiments, the hardened HARMP comprises a lower (e.g., diminished) number of pores compared to the material before the HARMP is formed.

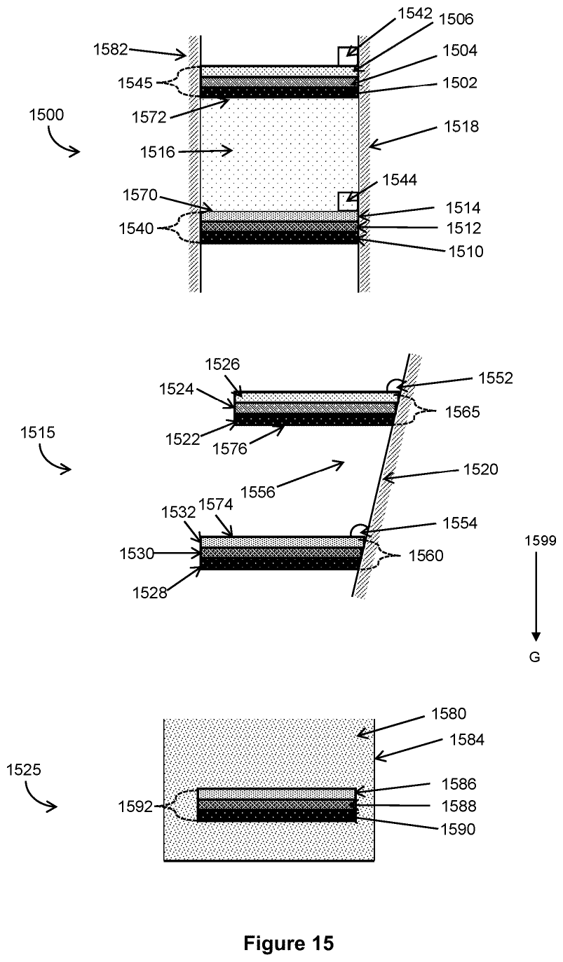

In some cases, a 3D object comprises a plurality of bottom skin layers (e.g., bottoms of turbine blades). A 3D object may comprise one or more structures such as cavities, gaps, wires, ledges, or 3D planes. A 3D plane may have a relatively small width compared to a relatively large surface area. A 3D plane may have a relatively small height relative to its width and length. For example, the 3D plane may have a small height relative to a large horizontal plane. The 3D plane may be planar, curved, or assume an amorphous 3D shape. The 3D plane may be a strip, a blade, or a ledge. The 3D plane may comprise a curvature. The 3D plane may be curved. The 3D plane may be planar (e.g., flat). The 3D plane may have the shape of a curving scarf. The term “3D plane” is understood herein to be a generic (e.g., curved) 3D surface. For example, the 3D plane may be a curved 3D surface. A structure within a forming 3D object may comprise a bottom skin layer (e.g., that is formed above a pre-transformed material without auxiliary support, or with spaced apart auxiliary supports). At times, at least two of the structures may have similar geometry. At times, at least two of the structures may have a different geometry. At times, the one of the structures may connect portions of the 3D object. At times, the structures may be separated by a gap. For example, multiple blades of a turbine may be (e.g., vertically) separated by a gap between a first blade portion and a second blade portion. For example, a first portion (e.g., a blade structure) of the 3D object (e.g., a turbine) may comprise a first bottom skin layer followed by one or more layers that form the first portion, and a second portion (e.g., a second blade structure) of the 3D object (e.g., a turbine) may comprise a second bottom skin layer followed by one or more layers that form the second portion of the 3D object. At times, the first portion and the second portion of the 3D object may be connected by a third portion (e.g., a ledge) to form the 3D object. FIG. 15 shows vertical cross-sectional examples 1500, 1515, and 1525 of a first portion and/or a second portion of a 3D object that are connected to one or more rigid portions. The object portions shown in FIG. 15 are depicted relative to gravitational vector 1599 pointing towards the gravitational center of the ambient environment. Example 1525 shows a first portion of a 3D object, which first portion comprises a bottom skin layer, which is not connected to a rigid portion, and that is suspended anchorlessly in the material bed (e.g., at least during its formation). Example 1500 shows an example of a first portion 1540 and a second portion 1545 of a 3D object disposed at an angle perpendicular (e.g., 90 degrees, 1542, 1544) to at least one rigid portion of the 3D object (e.g., FIG. 15, two rigid portions 1518, and 1582). Example 1515 shows an example of a first portion 1560 and a second portion 1565 of a 3D object (e.g., two blades of a propeller) forming angles 1552 and 1554 that are not perpendicular to the rigid portion 1520 of the 3D object. At times, the first portion and the second portion may not be connected to a portion of the 3D object (e.g., to a rigid portion). The first portion may comprise one or more layers (e.g. 1510, 1512, 1514, 1528, 1530, and 1532). The second portion may comprise one or more layers (e.g., 1502, 1504, 1506, 1522, 1524, and 1526). The layer may include pre-transformed material (e.g., particulate material). The layer may include transformed (e.g., hardened) material. The first layer for the first and/or second portions of the 3D object may be a bottom skin layer (e.g., 1502, 1510, 1522, and 1528). The bottom skin layer (e.g., 1590, 1528, 1576, 1510, and 1502) may be a transformed material layer. At times, the bottom skin layer may be parallel to the target surface (e.g., exposed surface of the material bed). At times, the bottom skin layer may be at an angle (e.g., a shallow angle, steep angle, or an intermediate angle) relative to the target surface (e.g., an exposed surface of the material bed and/or the support surface of the platform) and/or a (e.g., average) layering plane of the object. The angle may be an acute angle. Shallow angle may be at most about 0°, 1°, 2°, 5°, 10°, 15°, 20°, 25°, 30°, or 35°. Shallow angle may be any angle between the afore-mentioned values (e.g., from about 0° to about 35°, from about 0° to about 10°, from about 10° to about 25°, or from about 25° to about) 35° relative to the target surface and/or a (e.g., average) layering plane of the object. Intermediate angle may be at least about 25°, 30°, 35°, 40°, 45°, 50°, 55°, or 60° relative to the target surface and/or a (e.g., average) layering plane of the object. Intermediate angle may be at most about 25°, 30°, 35°, 40°, 45°, 50°, 55°, or 60° relative to the target surface and/or a (e.g., average) layering plane of the object. Intermediate angle may be any angle between the afore-mentioned values (e.g., from about 25° to about 60°, from about 25° to about 35°, from about 35° to about 50°, or from about 50° to about) 60° relative to the target surface and/or a (e.g., average) layering plane of the object. Steep angle may be at least about 45°, 50°, 55°, 60°, 65°, 70°, 75°, 80°, 85°, or 90° relative to the target surface and/or a (e.g., average) layering plane of the object. Steep angle may be any angle between the afore-mentioned values (e.g., from about 45° to about 90°, from about 45° to about 60°, from about 60° to about 75°, or from about 75° to about) 90° relative to the target surface and/or a (e.g., average) layering plane of the object. The bottom skin layer may comprise a top surface and a bottom surface. The bottom skin layer may be a wire or a ledge or have a planar surface. At least a fraction of the first portion (e.g., the top surface of the top layer, 1570) and a fraction of the second portion (e.g., the bottom surface of the bottom skin layer, 1572) may be separated by pre-transformed material (e.g., 1516), e.g., during their formation. At least a fraction of the first portion (e.g., the top surface of the top layer, 1574) and a portion of the second portion (e.g., the bottom surface of the bottom skin layer, 1576) may be separated by a gap (e.g., 1556), e.g., during their formation. The gap may be filled with pre-transformed material and may be transformed (e.g., subsequently hardened) during the formation of the 3D object. Example 1525 shows a portion 1592 of a 3D object, which portion comprises a bottom skin layer 1590, that is not connected to a rigid portion. The portion of the 3D object may be formed in a material bed (e.g., 1580) within an enclosure (e.g., 1584). The portion of the 3D object may comprise one or more layers formed adjacent to (e.g., above) the bottom skin layer (e.g., 1586 or 1588). The bottom skin layer may be floating (e.g., suspended) anchorlessly within the material bed. The bottom skin layer and/or the one or more layers adjacent to the bottom skin layer may be unconnected to a rigid portion. The bottom skin layer may be formed using any 3D printing methodologies described herein.

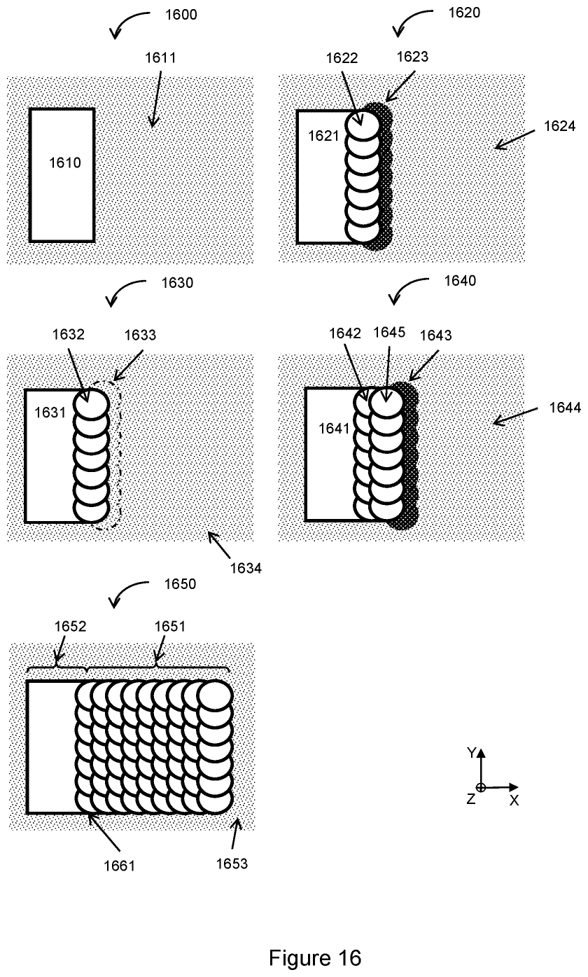

FIG. 16 show top view examples 1600, 1620, 1630, 1640, and 1650, various stages in formation of a (e.g., requested) ledge 1651 that is connected to an initial portion 1652 in a material bed 1653. An initial portion may be a rigid portion (e.g., a core). Example 1600 shows an example of an initial portion 1610 in a material 1611. Example 1620 shows an example of a first row of tiles along the Y direction, which first row of tiles comprises contacting and overlapping tiles including tile 1622 arranged in a single file, which row of tiles contacts initial portion 1621 and extends beyond the initial portion in the X direction, to form a 3D object comprising a ledge in a material bed 1624 having an exposed surface, and a depression 1623 in the material bed that extends below the exposed surface. The depression (e.g., indentation) may be formed due to generation of the first row of tiles. The depression may be filled up with additional pre-transformed material, e.g., using a recoater, e.g., as part of a layer dispensing mechanism.

The material bed may be replenished between formation of rows of tiles. For example, a recoater and/or layer dispenser may replenish the material bed, e.g., without detectable alteration of a vertical position of the platform. The replenishment may result in a material bed having a planar exposed surface. Detectable alteration may be detected in the position of the platform and/or in the planarity of the formed ledge extension. For example, an absence of a detectible vertical difference between the first row and the second row in the ledge. For example, a plurality of rows (e.g., the first row and the second row) may appear to have been generated from the same pre-transformed material layer. Example 1630 shows an example of a 3D object including a first row of tiles (that including tile 1632) that contacts an initial portion 1631, which 3D object is disposed in a material bed 1634 having an exposed surface without (or with a non-detectable) any depression in the material bed that extends below the exposed surface, wherein the area 1633 surrounded by dashes represents a previously present depression (e.g., as in FIG. 16B, 1623). Example 1640 shows an example of: (a) a first row of tiles extending in the Y direction, which first row of tiles comprises contacting and overlapping tiles (including tile 1642) arranged in a single file, which row of tiles contacts initial portion 1641 and extends beyond the initial portion in the X direction, and (b) a second row of tiles along the Y direction, which second row of tiles comprises contacting and overlapping tiles (including tile 1645) arranged in a single file, which second row of tiles contacts the first row of tiles and extends in the X direction beyond the initial portion and beyond the first row of tiles to form a 3D object comprising a ledge, which 3D object is disposed in a material bed 1644 having an exposed surface and a depression 1643 that extends below the exposed surface. The ledge may be formed by one or more rows of tiles. The plurality of rows of tiles may be formed one at a time. The formation of two successive rows of tiles may be intervened by deposition of pre-transformed material, e.g., (i) to supplement pre-transformed material to any depression in the exposed surface of the material bed, (ii) to elevate the exposed surface of the material bed with respect to the platform and/or to the bottom of the initial portion, or (iii) any combination thereof. Example 1650 shows an example of: a plurality of rows of tiles extending in the Y direction, wherein each row of tiles comprises contacting and overlapping tiles (including tile 1661) arranged in a single file, wherein the first row of tiles contacts initial portion 1652 and extends beyond the initial portion in the X direction, and (b) each successive row of tiles along the Y direction is similarly generated as a single file, wherein each row of tiles contacts a previously formed row of tiles and extends in the X direction beyond the initial portion and beyond the previously formed row of tiles, to form a 3D object comprising a ledge (e.g., FIG. 15, a ledge having a bottom skin layer 1576), which 3D object is disposed in a material bed 1653.

In some embodiments, the tiles in a row of tiles may be formed in a sequence. The sequence may be forming a single file of tiles (e.g., example 1620, showing an example of tiles 1622 as part of a row of tiles along the Y direction). The sequence may comprise forming a first tile in a first position, forming a second tile in a second position, and forming a third tile in a third position. The first tile may contact the second tile. The second tile may contact the third tile. The third tile may or may not contact the first tile. The first tile may contact the second tile. The first tile and the second tile may be formed such that there is a gap between them. The tile may be a melt pool. The gap may have an FLS of a tile and/or a melt pool.

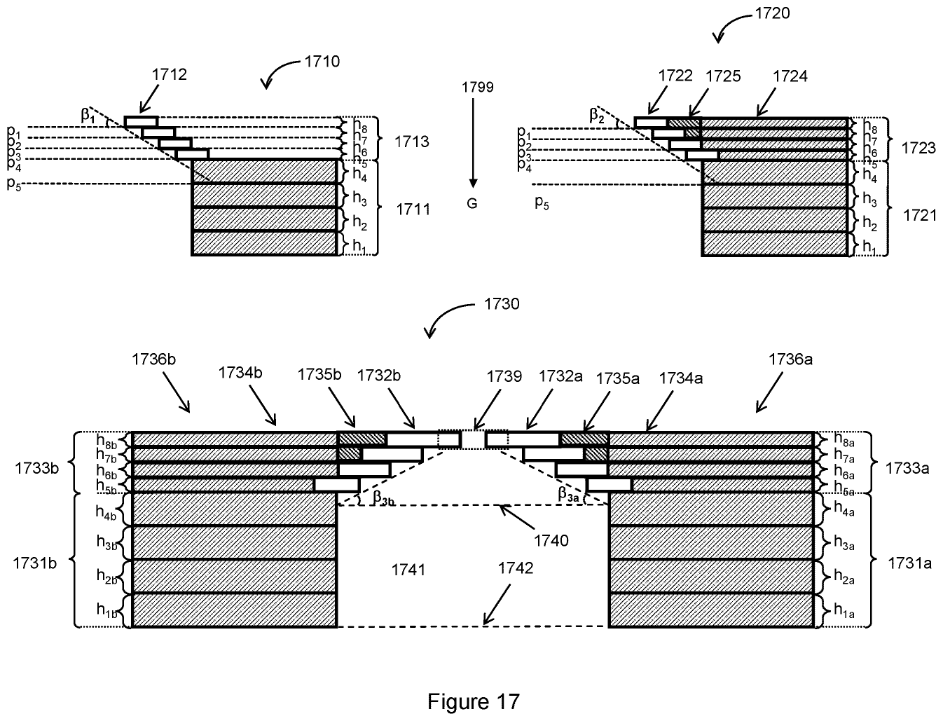

FIG. 17 shows schematic vertical cross-sectional examples of various 3D objects, each printed using several printing methodologies. The 3D object may represent different stages of forming a hanging structure comprising a bridge. 3D object 1710 includes a plurality of layers that comprises (a) a rigid (e.g., bulk core) portion 1711 that includes layers having height h1-h4 and an average layering plane such as p5; and (b) a bottom skin of a ledge 1713 comprising layers having height h5-h8 and an average plane p1-p4. The ledge bottom skin forms an angle beta1 (111) with the average plane (e.g., p5). The ledge bottom skin can be formed by one or more paths of tiles. A vertical cross section of the path of tiles is schematically represented by a rectangle (e.g., 1712). The 3D object example shown in 1710, the bulk core portion 1711 can be printed by a bidirectional hatching methodology, and the bottom skin ledge portion 1712 can be printed using a tiling methodology such as LPM. In the example of 3D object 1710, the layers of the ledge 1713 have a smaller height (each of h8-h5) as compared to each of the layers of the bulk core 1711 h1-h4. In other embodiments, the layers of the ledge may have a height that is (e.g., substantially) the same as that of the bulk core. FIG. 17 shows an example of a 3D object 1720 having a plurality of layers that comprises (a) a rigid (e.g., bulk core) portion 1721 that includes layers having height h1-h4 and an average layering plane, e.g., p5; and (b) a ledge portion 1723 including layers having height h5-h8 and an average plane p1-p4, which portion 1723 includes three sub-portions printed by different printing methodologies: (a) a bottom skin portion including layer 1722 printed using tiling such as LPM, a shallow core portion including layer 1725, and a bulk core portion including layer 1724. 3D object 1720 can be a 3D object in which the bottom skin is being thickened, e.g., by the shallow core portion. The ledge forms an angle beta2 (112) with the average plane (e.g., p5). In the example of 3D object 1720, the layers of the ledge 1723 have a smaller height (each of h8-h5) as compared to each of the layers of the bulk core 1721, h1-h4. In other embodiments, the layers of the ledge may have a height that is (e.g., substantially) the same as that of the bulk core. The 3D object portions shown in FIG. 17 are depicted relative to gravitational vector 1799 pointing towards the gravitational center of the ambient environment.

In some embodiments, the 3D object comprises an open or closed cavity, the cavity having a portion that is vertically directly unsupported during printing. The vertically directly unsupported portion may be of a bridge, or of a ledge. Closure of the cavity may necessitate connecting ledges (e.g., two ledges) that are vertically directly unsupported. The ledges may comprise (e.g., extensive) portions that float anchorlessly in the material bed. Such closure may necessity generation of melt pools that become increasingly extended. In some cases, the starting material, when converted to a molten material, generates melt pools that are unstable and/or become large balls. To reduce (e.g., planarize) the balling effect and/or other unstable melt pool effects, stitch coupling methodology is employed. The stitch coupling methodology may comprise re-melting previously generated hardened material (e.g., during a LMP procedure) and/or fusing (e.g., melting) starting material. The energy beam utilized for the stitch coupling methodology may have a diameter of at least about 25 micrometers (μm), 50 μm, 75 μm, or 100 μm. The energy beam utilized for the stitch coupling methodology may have a diameter of at most about 200 μm, 150 μm, 100 μm, or 50 μm. The energy beam utilized for the stitch coupling methodology may have a diameter between any of the aforementioned values, e.g., from about 25 μm to about 200 μm, from about 25 μm to about 100 μm, or from about 75 μm to about 200 μm. The energy beam utilized for the stitch coupling methodology may be generated by a laser source having a power of at least about 50 Watt (W), 100 W, 200 W or 300 W. The energy beam utilized for the stitch coupling methodology may be generated by a laser source having a power of at most about 500 W, 300 W, 200 W or 100 W. The energy beam utilized for the stitch coupling methodology may be generated by a laser source having a power between the aforementioned values, e.g., from about 50 W to about 500 W, or from about 100 W to about 200 W. The energy beam may traverse at a speed of at least about 5 millimeters per second (mm/sec), 10 mm/sec, 15 mm/sec, 25 mm/sec, 50 mm/sec, 75 mm/sec, 100 mm/sec, 150 mm/sec, or 200 mm/sec. The energy beam may traverse at a speed of at most about 500 mm/sec, 250 mm/sec, 200 mm/sec, 150 mm/sec, 100 mm/sec, or 50 mm/sec. The energy beam may traverse at a speed having a value between any of the aforementioned values, e.g., from about 5 mm/sec to about 500 mm/sec, from about 10 mm/sec to about 100 mm/sec, or from about 25 mm/sec to about 250 mm/sec. The length of each hatch in the stitch coupling (e.g., each zig or zag segment such as FIG. 11, 1120) may have a length of at least about 0.25 millimeters (mm), 0.5 mm, 1 mm, 1.5 mm, 2 mm, or 3 mm. The length of each hatch in the stitch coupling may have a length of at most about 6 mm, 5 mm, 3 mm, 2 mm, or 1 mm. The length of each hatch in the stitch coupling may have a length between the aforementioned lengths, e.g., from about 0.25 mm to about 3 mm, or from about 0.5 mm to about 1.5 mm. The angle formed by two adjacent hatches (e.g., FIG. 11, angle 1119) can be at least about 3 degrees (0), 5°, SO, 10°, 15°, 20°, or 30°. The angle formed by two adjacent hatches can be at most about 40°, 30°, 20°, 15°, 10°, SO, or 5°. The angle formed by two adjacent hatches can be any angle between the aforementioned angles, e.g., from about 3° to about 40°, from about SO to about 20°, or from about 5 to about 30°. The stitch coupling methodology may be configured to close an existing gap between two portions of the 3D object separated by a gap in a previously formed layer. The stitch coupling hatch can bridge a gap having the shortest length of at most about 0.05 millimeters (mm), 0.1 mm, 0.15 mm, 0.2 mm, 0.25 mm, 0.45 mm, 0.5 mm, 1 mm, 1.5 mm, 2 mm, or 3 mm. The stitch coupling hatch can bridge a gap having the shortest length between the aforementioned shortest lengths, e.g., from about 0.05 mm to about 3 mm, or from about 0.1 mm to about 1.5 mm. The stitch coupling methodology may re-transform (e.g., cure) one or more sections of rims of two portions of the 3D object that may or may not be separated by a gap in a previously formed layer. For example, at the closure area of a bridge, there may be defects such as large globular defects (e.g., arising from destabilized melt pools). Usage of the stitch coupling methodology may alleviate such defect formation, e.g., by planarizing such balling defects. At the onset of stitching two portion of 3D object that are separated by a gap, the first hatch of the stitch coupling may (e.g., only) supported by the two portion. However, as the stitch coupling progresses, it may be supported by the two portions as well as by the previous stitches if they harden during progression of the stitch. In some embodiments, the stitch coupling methodology (a) re-transformed (e.g., re-melts) previously generated melt pools (e.g., previously generated using LPM methodology), (b) transforms starting material to a transformed material, or (c) any combination thereof. For example, starting material may reside in the gap, and previously transformed material may reside at the rim of the two portions to be stitched by the stitch coupling methodology. The energy beam may translate between previously formed melt pools of the two 3D object portions, e.g., through the gap that includes a starting material, e.g., as part of the material bed. At times, the energy beam characteristics utilized for generation of the bottom skin surface of the hanging ledge (e.g., tiling methodology), are used during the stitch coupling methodology. At times, at least one of the energy beam characteristics utilized for generation of the LPM melt pools (e.g. using tiling) are used during the stitch coupling methodology. For example, the FLS of the tiling energy beam may be (e.g., substantially) the same as that of the stitch coupling methodology. However, the bottom skin surface is generated by using a tiling methodology, whereas the stitch coupling is utilizing a hatching methodology. The tiling methodology is utilizing a step and repeat process, whereas the hatching methodology is using a continuously moving energy beam during generation of a hatch. The hatching methodology results in elongated melt pools, whereas the tiling methodology results in a sting of melt pools, e.g., arranged along the energy beam propagation path to generate the path of tiles. The stitching energy beam may propagate at a higher velocity as compared to the tiling energy beam. Higher velocity may be higher by at least about 1.5*, 2*, 3*, or 4* as compared to the tiling energy beam, with the symbol “*” designating the mathematical operation of multiplication. The stitch coupling methodology may comprise patterned (e.g., and localized) curing of transformed material conducted during the printing of the 3D object. As part of the stitch coupling methodology, the layer dispensing mechanism may be utilized to dispense additional powder that (a) fills any voids in the exposed surface of the material bed (e.g., due to material starvation of the material bed occurring during transformation) with starting material, and/or (b) does not increase the height of the powder bed. Examples of 3D printers, their components, and associated methods (e.g., dispensing starting material with lack of vertical positional change of the target surface, e.g., top surface of the material bed), software, systems, devices, and apparatuses, can be found in International Patent Application Serial No PCT/US21/35350, filed Jun. 2, 2021, which is entirely incorporated herein by reference.

FIG. 17 shows an example of 3D object 1730 connecting two portions 1736a and 1736b by a bridge portion. Portion 1736a of 3D object 1730 comprises a plurality of layers that comprising (a) a first rigid (e.g., bulk core) portion 1731a that includes layers having height h1a-h4a and an average layering plane (e.g., substantially) at or parallel to 1740; (b) a ledge portion 1733a including layers having height h5a-h8a and an average plane (e.g., substantially) parallel to 1740, which portion 1733a includes three sub-portions printed by different printing methodologies: (a) a bottom skin portion comprising layer 1732a printed using tiling such as LPM, a shallow core portion including layer 1735a, and a bulk core portion including layer 1734a. The ledge forms an angle beta3a (113a) with the average plane (e.g., substantially) parallel to 1740. Portion 1736b of 3D object 1730 comprises a plurality of layers that comprising (a) a first rigid (e.g., bulk core) portion 1731b that includes layers having height h1b-h4b and an average layering plane (e.g., substantially) at or parallel to 1740; (b) a ledge portion 1733b including layers having height h5b-h8b and an average plane (e.g., substantially) parallel to 1740, which portion 1733b includes three sub-portions printed by different printing methodologies: (a) a bottom skin portion comprising layer 1732b printed using tiling such as LPM, a shallow core portion including layer 1735b, and a bulk core portion including layer 1734b. The ledge forms an angle beta3b (113b) with the average plane (e.g., substantially) parallel to 1740. Portions 1736a and 1736b are coupled together by bridging portion 1739 that can be generated by the stitch coupling printing methodology. In the example of 3D object 1730, the layers of the ledge 1723 have a smaller height (each of h8-h5) as compared to each of the layers of the bulk core 1721, h1-h4. In other embodiments, the layers of the ledge may have a height that is (e.g., substantially) the same as that of the bulk core. The 3D object 1730 comprises a cavity having interior 1741 enclosed by the bridge (comprising portion 1739) and the two bulk core portions 1731a and 1731b, the cavity being open at opening 1742.

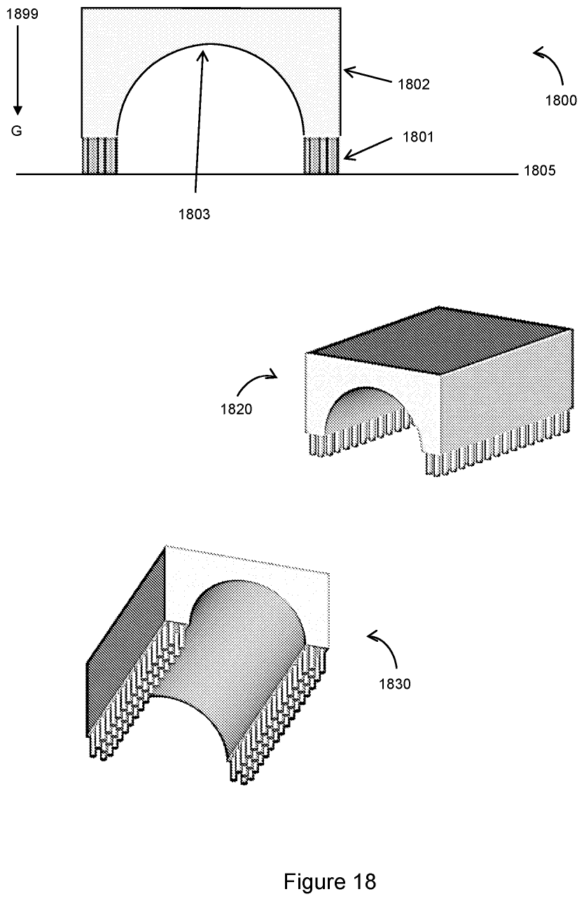

FIG. 18 shows various schematic views of a 3D object. Example 1800 shows a front or back view of the 3D object 1802. During printing, the 3D object is tethered to the build platform (e.g., base) 1805 using auxiliary supports such as 1801. The 3D object comprises a bridge having portion 1803 that is vertically directly unsupported during printing. Example 1820 shows a top perspective view of the 3D object. Example 1830 shows a bottom perspective view of the 3D object. 3D objects views 1800 and 1820 are depicted relative to gravitational vector 1899 pointing towards the gravitational center of the ambient environment.

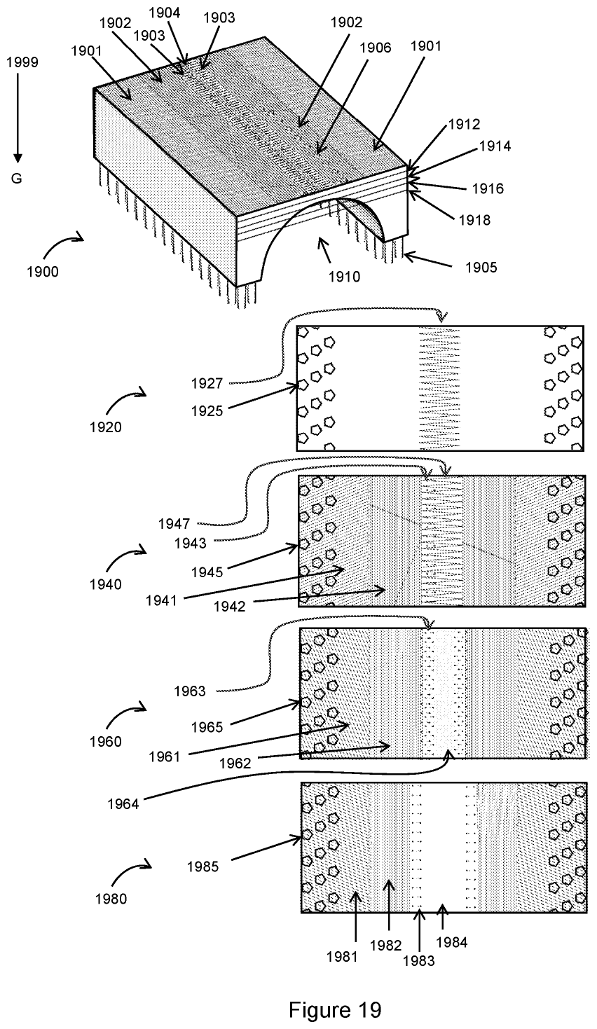

FIG. 19 shows various schematic views of a 3D object and layers thereof including propagation paths of energy beam(s) utilized for its printing. Example 1900 shows a perspective view of the 3D object depicted in FIG. 18. showing different paths utilized for its printing, e.g., 1901 bulk core, 1902 shallow core, 1903 ledge, 1904 stitch closure, and 1905 auxiliary supports depicted as silhouette 1906. During printing, the 3D object is tethered to the build platform (e.g., base) using auxiliary supports such as 1905. The 3D object comprises a bridge having portion 1910 that is vertically directly unsupported during printing. The 3D object is formed layerwise, e.g., including layers 1912, 1914, 1916, and 1918. Paths of energy beam(s) forming each of the layers are depicted, with example 1920 corresponding to a portion of layer 1912, example 1940 corresponding to a portion of layer 1914, example 1960 corresponding to a portion of layer 1916, and example 1980 corresponding to a portion of layer 1918. Each of portions 1920, 1940, 1960, and 1980, is shown as a top schematic view of the layer portion that includes various paths for energy beam(s) to follow during the printing.

Example 1980 shows paths of: core portion 1981, of shallow core portion 1982, and of ledge portion 1983. Example 1980 shows gap 1984, and silhouettes such as 1985 representing underlying auxiliary supports, e.g., for alignment. Example 1960 shows paths of: core portion 1961, of shallow core portion 1962, and of ledge portion 1963. Example 1960 shows gap 1964, and silhouettes such as 1965 representing underlying auxiliary supports, e.g., for alignment. Example 1940 shows paths of: core portion 1941, of shallow core portion 1942, of ledge portion 1943, and of stitch closure 1947. Example 1940 shows silhouettes such as 1945 representing underlying auxiliary supports, e.g., for alignment. Example 1920 shows paths of stitch portion 1927. Example 1920 shows silhouettes such as 1925 representing underlying auxiliary supports, e.g., for alignment. 3D object in example 1900 is depicted relative to gravitational vector 1999 pointing towards the gravitational center of the ambient environment.

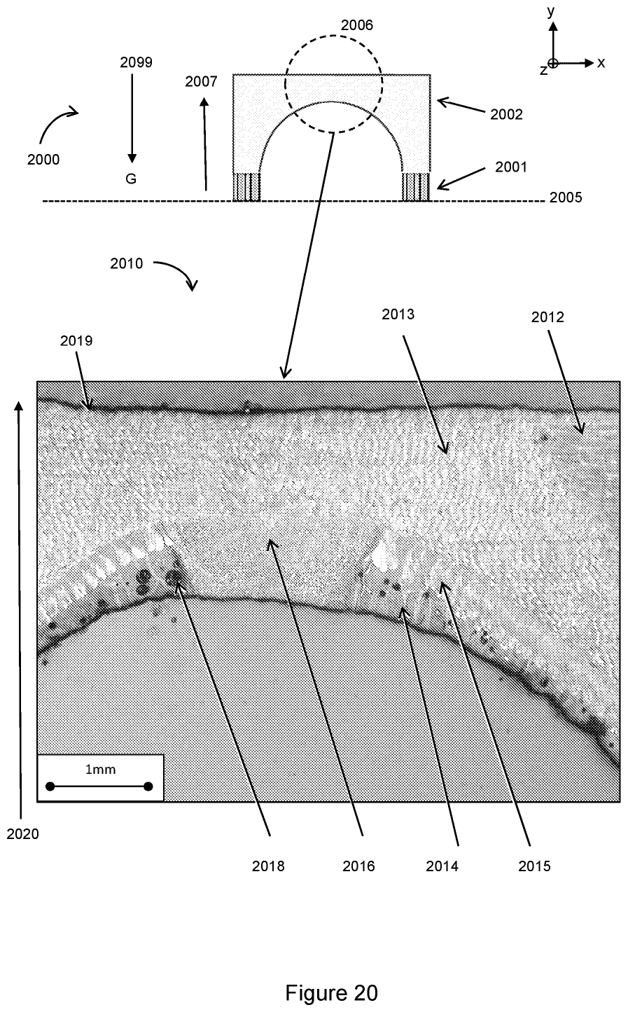

FIG. 20 shows a schematic view of a 3D object and layers thereof including microstructures generated during its printing, the 3D object being printed of Inconel-718 powder as disclosed in Example 2 herein. Example 2000 shows a front or back view of 3D object 2002 depicted in FIGS. 18 and 19. 3D object 2002 is tethered to platform 2005 during its printing by auxiliary supports such as 2001. 3D object 2002 includes portion 2006 that is vertically directly unsupported, e.g., by auxiliary supports. 3D object 2002 was printed layerwise in direction 2007. Photograph 2010 depicts portion 2006 of printed 3D object 2002, showing bulk core 2012 having larger and less organized melt pools as compared to the melt pools of the shallow core 2013; HARMP 2015 melt pool having high aspect ratio of depth to width (e.g., diameter), LMP melt pools such as 2014 forming the bottom skin of portion 2006, rim portion 2019, and stitch closure melt pools 2016 having distinct metallurgical microstructure that are larger than the microstructure generated by any of the aforementioned methodologies, e.g., generating the melt pools of HARMP, shallow core, and bulk core. 3D object portion 2006 was printed by layerwise deposition in direction 2020. The printed 3D object portion shown in FIG. 20 includes pores such as pore 2018. The portions undergoing the HARMP procedure are devoid of such pores. In the example shown in FIG. 20, the stitch coupling methodology generated melt pools that extend from the shallow core region to the exposed surface of the hanging structure (e.g., bridge portion 2006) of the 3D object, the hanging structure being devoid of direct vertical support structures. 3D object in example 2000 is depicted relative to gravitational vector 2099 pointing towards the gravitational center of the ambient environment.

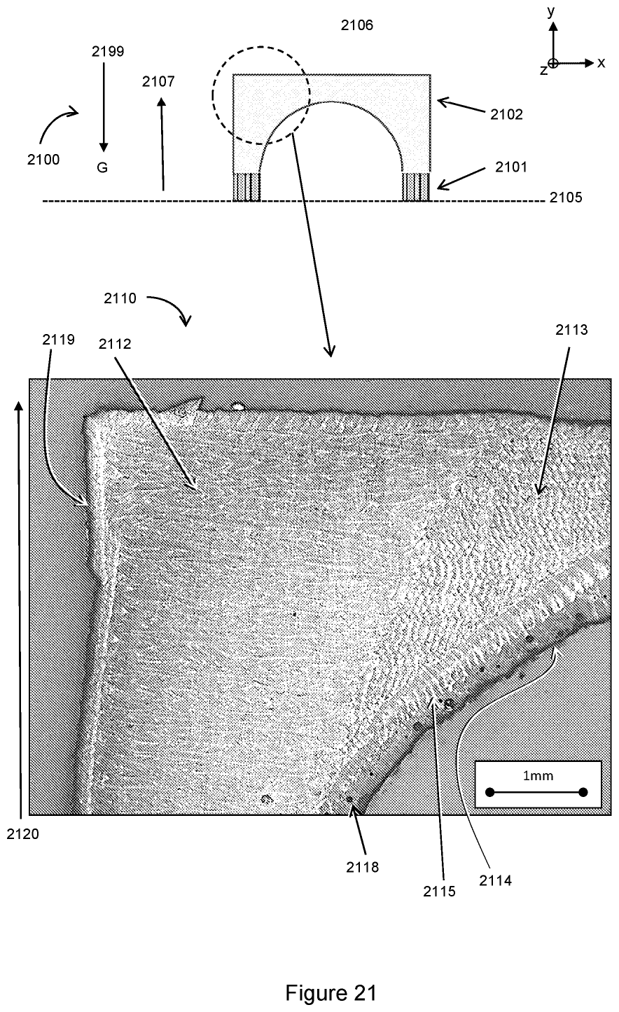

FIG. 21 shows a schematic view of the 3D object of FIG. 20 and layers thereof including microstructures generated during its printing, the 3D object being printed of Inconel-718 powder as disclosed in Example 2 herein. Example 2100 shows a front or back view of 3D object 2102 depicted in FIGS. 18 and 19. 3D object 2102 is tethered to platform 2105 during its printing by auxiliary supports such as 2101. 3D object 2102 includes portion 2106 that is vertically directly unsupported, e.g., by auxiliary supports. 3D object 2102 was printed layerwise in direction 2107. Photograph 2110 depicts portion 2106 of printed 3D object 2102, showing bulk core 2112 having larger and less organized melt pools as compared to the melt pools of the shallow core 2113; HARMP 2115 melt pool having high aspect ratio of depth to width (e.g., diameter), LMP melt pools such as 2114 forming the bottom skin of portion 2106, and rim 2119, with each of the printing methodologies having distinct metallurgical microstructure. 3D object portion 2110 was printed by layerwise deposition in direction 2120. The printed 3D object portion shown in FIG. 21 includes pores such as pore 2118. The portions undergoing the HARMP procedure are devoid of such pores. 3D object in example 2100 is depicted relative to gravitational vector 2199 pointing towards the gravitational center of the ambient environment.

In some embodiments, characteristics of the 3D object (or any portion thereof) is measured by a measurement methodology (e.g., also referred to herein as “detection methodologies”). For example, the FLS values (e.g., width), height uniformity, auxiliary support space, and/or radius of curvature of the layer of the 3D object and any of its components (e.g., layer of hardened material) may be measured by any of the following measuring methodologies. The measurement methodologies may comprise a microscopy method (e.g., any microscopy method described herein). The measurement methodologies may comprise a coordinate measuring machine (CMM), measuring projector, vision measuring system, and/or a gauge. The gauge can be a gauge distometer (e.g., caliper). The gauge can be a go-no-go gauge. The measurement methodologies may comprise a caliper (e.g., vernier caliper), positive lens, interferometer, or laser (e.g., tracker). The measurement methodologies may comprise a contact method or by a non-contact method. The measurement methodologies may comprise one or more sensors (e.g., optical sensors and/or metrological sensors). The measurement methodologies may comprise a metrological measurement device (e.g., using metrological sensor(s)). The measurements may comprise a motor encoder (e.g., rotary and/or linear). The measurement methodologies may comprise using an electromagnetic beam (e.g., visible or IR). The microscopy method may comprise ultrasound or nuclear magnetic resonance. The microscopy method may comprise optical microscopy. The microscopy method may comprise electromagnetic, electron, or proximal probe microscopy. The electron microscopy may comprise scanning, tunneling, X-ray photo-, or Auger electron microscopy. The electromagnetic microscopy may comprise confocal, stereoscope, or compound microscopy. The microscopy method may comprise an inverted and/or non-inverted microscope. The proximal probe microscopy may comprise atomic force microscopy, scanning tunneling microscopy, or any other microscopy described herein. The microscopy measurements may comprise using an image analysis system. The measurements may be conducted at ambient temperatures (e.g., R.T.). For example, the microstructures (e.g., of melt pools) of the 3D object may be measured by a microscopy method (e.g., any microscopy method described herein). The microstructures may be measured by a contact or by a non-contact method. The microstructures may be measured by using an electromagnetic beam (e.g., visible or IR). The microstructure measurements may comprise evaluating the dendritic arm spacing and/or the secondary dendritic arm spacing (e.g., using microscopy). The microscopy measurements may comprise using an image analysis system. The measurements may be conducted at ambient temperatures (e.g., R.T.).

Various distances relating to the printer can be measured using any of the following measurement techniques. Various distances within the printer (e.g., the vertical displacement of the platform) can be measured using any of the following measurement techniques. The measurements techniques may comprise interferometry and/or confocal chromatic measurements. The measurements techniques may comprise at least one motor encoder (rotary, linear). The measurement techniques may comprise one or more sensors (e.g., optical sensors and/or metrological sensors). The measurement techniques may comprise at least one inductive sensor. The measurement techniques may include an electromagnetic beam (e.g., visible or IR). The measurements may be conducted at ambient temperature (e.g., R.T.).

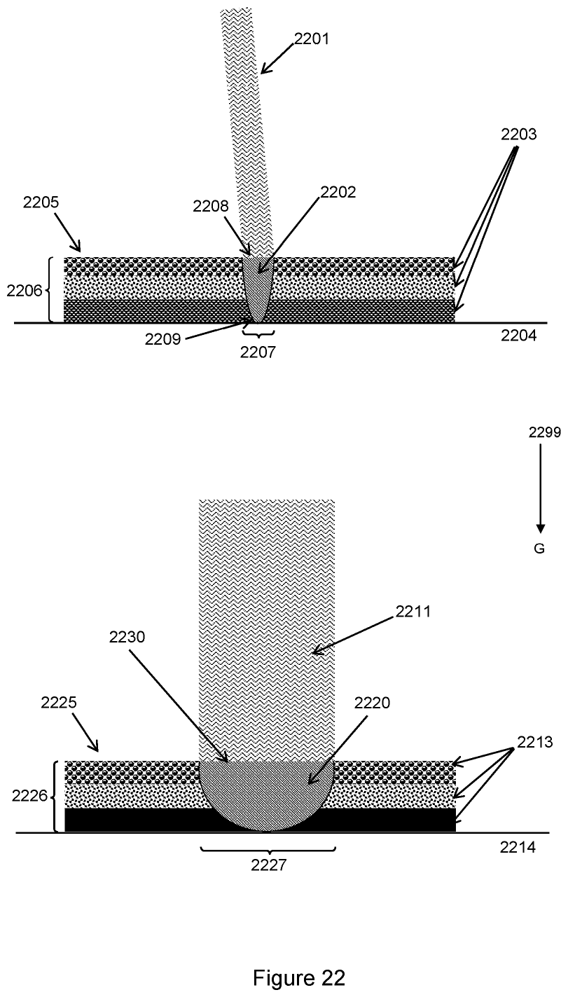

In some embodiments, the one or more energy beams used to form the 3D object forms melt pools. The melt pools can have any shape and size, e.g., as disclosed herein FIG. 22 shows schematic examples of vertical cross sections of portions of material beds and/or 3D object having melt pools with different shapes, e.g., different aspect ratios. FIG. 22 shows an example of irradiating a layer material 2205 supported by platform 2204 using an energy beam 2201 that forms a high aspect ratio melt pool 2202. The layers of material may be pre-transformed or transformed material, e.g., powder, molten material, or hardened material such as solidified material that has been previously transformed. The energy beam generating the high aspect ratio melt pool may be referred to as a high aspect ratio melt pool (abbreviated as “HARMP”) energy beam. In some embodiments, the material (e.g., 2206) comprises multiple layers (e.g., 2203). At least two of the multiple layers may be comprised of (e.g., substantially) the same material composition (e.g., metal composition), state (e.g., pre-transformed (e.g., powder) or transformed (e.g., melted then hardened) and/or a porosity. The multiple layers may be comprised of different material compositions (e.g., metal composition), state (e.g., pre-transformed (e.g., powder) or transformed (e.g., melted then hardened) and/or a porosity. The high aspect ratio melt pool (e.g., 2202) can have a depth (e.g., 2206) (also referred as height) that is greater than its width (e.g., 2207). The depth of a melt pool may be measured from an exposed (e.g., top) surface (e.g., 2208) to its terminus (e.g., bottom) surface (e.g., 2209). The width of a melt pool may correspond to a horizontal cross section (e.g., diameter) of the exposed (e.g., top) surface (e.g., 2208) of the melt pool. In some embodiments, a high aspect ratio melt pool has a depth that is at least about 1.5, 2.0, 2.5, 3.0, 5.0, 8.0, or 10.0 times its width. FIG. 22 shows an example of irradiating a material 2225 supported by platform 2214 using an energy beam 2211 that forms a low aspect ratio melt pool 2202. The energy beam (e.g., 2211) may be a tiling or hatching energy beam. In some embodiments, the irradiated material (e.g., 2225) comprises multiple layers (e.g., 2221). The multiple layers may be comprised of the same material composition (e.g., metal composition), state (e.g., pre-transformed (e.g., powder) or transformed (e.g., melted then hardened) and/or a porosity. The multiple layers may be comprised of different material composition (e.g., metal composition), state (e.g., pre-transformed (e.g., powder) or transformed (e.g., molten then hardened) and/or a porosity. The low aspect ratio melt pool can have a depth (e.g., 2226) (also referred to as height) that is less than its width (e.g., 2227). In some embodiments, a low aspect ratio melt pool has a depth that is at most about 0.5, 0.6, 0.7, 0.8, or 0.9 times its width. A melt pool (e.g., high aspect ratio or low aspect ratio) may be referred to as “deep” or “shallow.” A deep melt pool can refer to a melt pool that spans two or more layers of (e.g., of pre-transformed and/or transformed) material. A shallow melt pool can refer to a melt pool that spans less than two layers of (e.g., of pre-transformed and/or transformed) material. The melt pool may be globular, e.g., having an aspect ratio that is substantially 1:1. The material beds in FIG. 22 are depicted relative to gravitational vector 2299 pointing towards the gravitational center of the ambient environment.

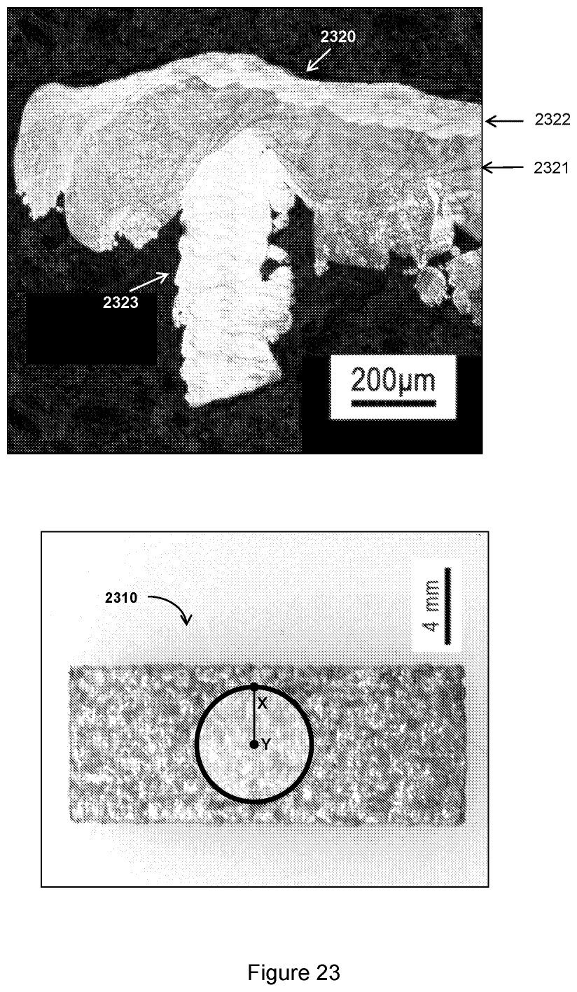

In some instances, the 3D object is supported by one or more supports (also referred to herein as “auxiliary supports”) during printing. The auxiliary supports may (e.g., directly) couple the 3D object to the platform (e.g., to the base). The 3D object may have any number of supports. The supports may have any shape and size. In some examples, the auxiliary supports comprise a rod, plate, wing, tube, shaft, pillar, or any combination thereof. In some cases, the auxiliary supports support certain portions of the 3D object and does not support other portions of the 3D object. In some cases, the supports are (e.g., directly) coupled with a bottom surface the 3D object (e.g., relative to the platform). In some embodiments, the supports are anchored to the platform. In some examples, the supports are used to support portions of the 3D object having a certain (e.g., complex, or simple) geometry. In some cases, the supports (or a portion thereof) are removed from the 3D object after printing. Removal can comprise machining (e.g., cutting, sawing and/or milling), polishing (e.g., sanding) and/or etching. Removal can comprise beam (e.g., laser) etching or chemical etching. In some cases, the supports (or a portion thereof) remain in and/or on the 3D object after printing. In some cases, the one or more supports leave respective one or more support marks on the 3D object that are indicative of a presence or removal of the one or more supports. FIG. 23 shows an example of a vertical cross section of a 3D object that includes a first portion 2320 coupled with an auxiliary support 2323. In some cases, the first portion comprises multiple layers (e.g., 2321 and 2322) that were sequentially added (e.g., after formation of the support) during a printing operation. In some cases, the auxiliary support causes one or more layers of the portion of the 3D object to deform during printing. The auxiliary support 2323 shown in the example of FIG. 23, is directly vertically supporting 3D object portion 2320 during printing, with portion 2320 including layers 2321 and 2322. Sometimes, the deformed layers form a detectable (e.g., visible) mark. The mark may be a region of discontinuity in the layer, such as a microstructure discontinuity and/or an abrupt microstructural variation (e.g., FIG. 23). The discontinuity in the microstructure may be explained by inclusion of a foreign object, e.g., the auxiliary support. The microstructural variation may include (e.g., abruptly) altered melt pools and/or grain structure (e.g., crystals, e.g., dendrites) at or near the attachment point of the support. The microstructure variation may be due to differential thermal gradients due to the presence of the support. The microstructure variation may be due to a forced melt pool and/or layer geometry due to the presence of the support. The discontinuity may be at an external surface of the 3D object. The discontinuity may arise from inclusion of the support to the surface of the 3D object, e.g. and may be visible as a breakage of the support when removed from the 3D object such as after printing. In some instances, the 3D object includes two or more auxiliary support and/or auxiliary support marks. If more than one support is used, the supports may be spaced apart by a (e.g., pre-determined) distance. FIG. 23 shows an example 3D object having points X and Yon an exposed surface of the 3D object. In some embodiments, X is spaced apart from Y by a support spacing distance. For example, a sphere of radius XY that is centered at X may lack one or more auxiliary supports or one or more auxiliary support marks.

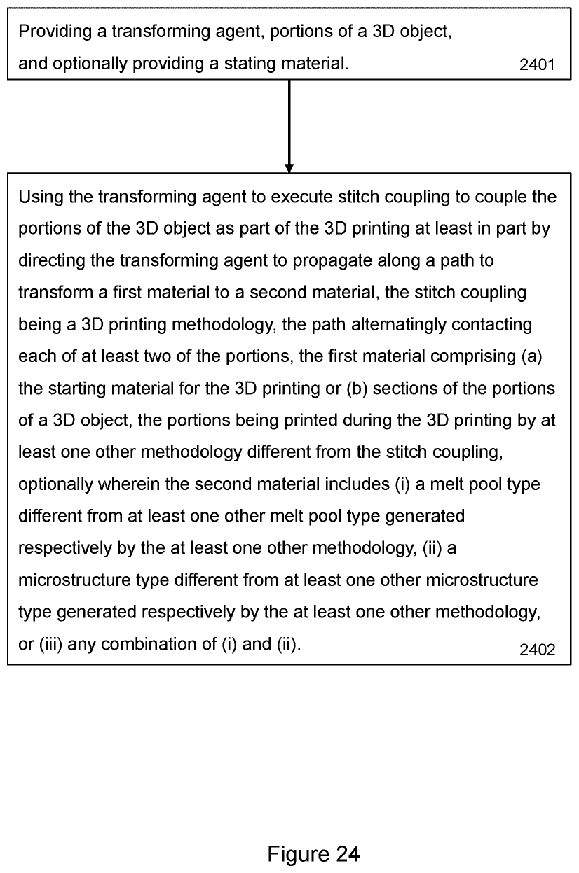

FIG. 24 shows an example of a method of 3D printing comprising the stitch coupling printing methodology. In block 2401, providing a transforming agent, portions of a 3D object, and optionally providing a stating material; and in block 2402, using the transforming agent to execute stitch coupling to couple the portions of the 3D object as part of the 3D printing at least in part by directing the transforming agent to propagate along a path to transform a first material to a second material, the stitch coupling being a 3D printing methodology, the path alternatingly contacting each of at least two of the portions, the first material comprising (a) the starting material for the 3D printing or (b) sections of the portions of a 3D object, the portions being printed during the 3D printing by at least one other methodology different from the stitch coupling; and optionally wherein the second material includes (i) a melt pool type different from at least one other melt pool type generated respectively by the at least one other methodology, (ii) a microstructure type different from at least one other microstructure type generated respectively by the at least one other methodology, or (iii) any combination of (i) and (ii).

Examples. The following are illustrative and non-limiting examples of methods of the present disclosure.

Example 1: In a processing chamber, Inconel-718 powder having a diameter distribution of from about 15 micrometers to about 45 micrometers was dispensed by a layer dispensing mechanism (e.g., recoater), the powder being dispensed above a build plate having a diameter of about 315 mm to form a powder bed. A layer dispensing mechanism was used to form a powder bed. When idle, a layer dispensing mechanism is parked in an ancillary chamber (e.g., garage) coupled with the processing chamber in which the build plate was disposed, the ancillary chamber separated from the processing chamber by a door. The layer dispensing mechanism comprised a powder dispenser and a powder remover. The powder remover was configured to attract a portion of the dispensed powder to form a planar exposed surface of the powder bed using vacuum. The attracted powder was conveyed using a material (e.g., powder) conveyance system for recycling and reuse in by the layer dispensing mechanism. The atmosphere in the material conveyance system was similar to the one used in the processing chamber. The processing chamber was under an atmosphere that is less reactive with the powder than the ambient atmosphere external to the processing chamber. The internal processing chamber atmosphere comprised argon, oxygen, and humidity. The oxygen was at a concentration of at most about 1000 ppm, and the humidity had a dew point from about −55° C. to about −15° C. The internal processing chamber atmosphere had a pressure of about 16 KPa above atmospheric pressure (e.g., above about 101 KPa), and was at ambient temperature. The processing chamber was equipped with two optical windows made of sapphire. Each laser beam was guided by an optical setup in an optical system enclosure, the optical system enclosure disposed above the processing chamber, the optical system enclosure comprising a galvanometer scanner. Each of the laser beams originated from a fiber laser and traversed its respective optical window into the processing chamber to impinge on an exposed surface of the powder bed to print layerwise a 3D object. Each of the laser beam had a maximum power of about one (1) Kilo Watt, and a wavelength of about 1060 nanometers. The object depicted in FIG. 18 was printing using the printing methodologies disclosed in FIG. 19. The power of the laser beam varied depending on the printing methodology utilized for the printing, e.g., as disclosed herein. A user was able to view the laser beams during printing using three circular viewing window assemblies that were tilted with respect to the floor of the processing chamber. The viewing assembly comprises a reflective coating (as disclosed herein) facing the interior of the processing chamber. The layer dispensing mechanism formed a powder bed by sequential layerwise deposition, the powder bed being disposed in a build module above the build plate. The build plate was disposed above a piston. The build plate traversed down at increments of about 50 μm at a precision of +/−2 micrometers using an optical encoder. The powder bed was used for layerwise printing the 3D object using the lasers. The removed powder was recycled using a recycling system as part of the powder recycling system that is part of the material conveyance system. The recycled powder was reused by the layer dispensing mechanism, e.g., recoater.

Example 2: In a processing chamber, Inconel-718 powder having a diameter distribution of from about 15 micrometers to about 45 micrometers was dispensed by a layer dispensing mechanism (e.g., recoater), the powder being dispensed above a build plate having a diameter of about 600 mm to form a powder bed. A layer dispensing mechanism was used to form a powder bed. When idle, a layer dispensing mechanism is parked in an ancillary chamber (e.g., garage) coupled with the processing chamber in which the build plate was disposed, the ancillary chamber separated from the processing chamber by a door. The layer dispensing mechanism comprised a powder dispenser and a powder remover. The powder remover was configured to attract a portion of the dispensed powder to form a planar exposed surface of the powder bed using vacuum. The attracted powder was conveyed using a material (e.g., powder) conveyance system for recycling and reuse in by the layer dispensing mechanism. The atmosphere in the material conveyance system was similar to the one used in the processing chamber. The processing chamber was under an atmosphere that is less reactive with the powder than the ambient atmosphere external to the processing chamber. The internal processing chamber atmosphere comprised argon, oxygen, and humidity. The oxygen was at a concentration of at most about 1000 ppm, and the humidity had a dew point from about −55° C. to about −15° C. The internal processing chamber atmosphere had a pressure of about 16 KPa above atmospheric pressure (e.g., above about 101 KPa), and was at ambient temperature. The processing chamber was equipped with eight optical windows made of sapphire in a configuration similar to the one depicted in FIG. 5, e.g., 580. Each laser beam was guided by an optical setup in an optical system enclosure, the optical system enclosure disposed above the processing chamber, the optical system enclosure comprising a galvanometer scanner. Each of the laser beams originated from a fiber laser and traversed its respective optical window into the processing chamber to impinge on an exposed surface of the powder bed to print layerwise a 3D object, a photograph of a portion thereof is depicted in example 2010 of FIG. 20 and in example 2110 of FIG. 21. Each of the laser beam had a maximum power of about one (1) Kilo Watt, and a wavelength of about 1060 nanometers. The object depicted in FIG. 18 was printing using the printing methodologies disclosed in FIG. 19. The power of the laser beam varied depending on the printing methodology utilized for the printing, e.g., as disclosed herein. A user was able to view the laser beams during printing using a viewing window assembly that was tilted with respect to the floor of the processing chamber. The viewing assembly comprises a reflective coating (as disclosed herein) facing the interior of the processing chamber. The layer dispensing mechanism formed a powder bed by sequential layerwise deposition, the powder bed being disposed in a build module above the build plate. The build plate was disposed above a piston. The build plate traversed down at increments of about 50 μm at a precision of +/−2 micrometers using an optical encoder. The powder bed was used for layerwise printing the 3D object using the lasers. The removed powder was recycled using a recycling system as part of the powder recycling system that is part of the material conveyance system. The recycled powder was reused by the layer dispensing mechanism, e.g., recoater.

Example 3: In a processing chamber, Maraging steel M300 powder having a diameter distribution of from about 15 micrometers to about 45 micrometers was dispensed by a layer dispensing mechanism (e.g., recoater), the powder being dispensed above a build plate having a diameter of about 315 mm to form a powder bed. A layer dispensing mechanism was used to form a powder bed. When idle, a layer dispensing mechanism is parked in an ancillary chamber (e.g., garage) coupled with the processing chamber in which the build plate was disposed, the ancillary chamber separated from the processing chamber by a door. The layer dispensing mechanism comprised a powder dispenser and a powder remover. The powder remover was configured to attract a portion of the dispensed powder to form a planar exposed surface of the powder bed using vacuum. The attracted powder was conveyed using a material (e.g., powder) conveyance system for recycling and reuse in by the layer dispensing mechanism. The atmosphere in the material conveyance system was similar to the one used in the processing chamber. The processing chamber was under an atmosphere that is less reactive with the powder than the ambient atmosphere external to the processing chamber. The internal processing chamber atmosphere comprised argon, oxygen, and humidity. The oxygen was at a concentration of at most about 1000 ppm, and the humidity had a dew point from about −55° C. to about −15° C. The internal processing chamber atmosphere had a pressure of about 16 KPa above atmospheric pressure (e.g., above about 101 KPa), and was at ambient temperature. The processing chamber was equipped with two optical windows made of sapphire. Each laser beam was guided by an optical setup in an optical system enclosure, the optical system enclosure disposed above the processing chamber, the optical system enclosure comprising a galvanometer scanner. Each of the laser beams originated from a fiber laser and traversed its respective optical window into the processing chamber to impinge on an exposed surface of the powder bed to print layerwise a 3D object. Each of the laser beam had a maximum power of about one (1) Kilo Watt, and a wavelength of about 1060 nanometers. The object depicted in FIG. 18 was printing using the printing methodologies disclosed in FIG. 19. The power of the laser beam varied depending on the printing methodology utilized for the printing, e.g., as disclosed herein. A user was able to view the laser beams during printing using three circular viewing window assemblies that were tilted with respect to the floor of the processing chamber. The viewing assembly comprises a reflective coating (as disclosed herein) facing the interior of the processing chamber. The layer dispensing mechanism formed a powder bed by sequential layerwise deposition, the powder bed being disposed in a build module above the build plate. The build plate was disposed above a piston. The build plate traversed down at increments of about 50 μm at a precision of +/−2 micrometers using an optical encoder. The powder bed was used for layerwise printing the 3D object using the lasers. The removed powder was recycled using a recycling system as part of the powder recycling system that is part of the material conveyance system. The recycled powder was reused by the layer dispensing mechanism, e.g., recoater.

While preferred embodiments of the present invention have been shown, and described herein, it will be obvious to those skilled in the art that such embodiments are provided by way of example only. It is not intended that the present disclosure be limited by the specific examples provided within the specification. While the present disclosure has been described with reference to the afore-mentioned specification, the descriptions and illustrations of the embodiments herein are not meant to be construed in a limiting sense. Numerous variations, changes, and substitutions will now occur to those skilled in the art without departing from the present disclosure. Furthermore, it shall be understood that all aspects of the present disclosure are not limited to the specific depictions, configurations, or relative proportions set forth herein which depend upon a variety of conditions and variables. It should be understood that various alternatives to the embodiments described herein might be employed in practicing the present disclosure. It is therefore contemplated that the present disclosure shall also cover any such alternatives, modifications, variations, or equivalents. It is intended that the following claims define the scope of the present disclosure and that methods and structures within the scope of these claims and their equivalents be covered thereby.

What is claimed is:

1. An apparatus for three-dimensional (3D) printing of a 3D object, the apparatus comprising: at least one controller configured to:
operatively couple to a transforming agent; and
direct the transforming agent to execute stitch coupling to couple at least two portions of the 3D object to one another, the at least one controller being configured to direct the transforming agent to propagate along a path to transform a first material to a second material, the path alternatingly contacting the at least two portions, the first material comprising (a) a starting material for the 3D printing or (b) sections of the portions of a 3D object, the at least two portions being printed during the 3D printing by at least one other methodology different from the stitch coupling.

2. The apparatus of claim 1, wherein the second material includes (i) a melt pool type different from at least one other melt pool type generated respectively by the at least one other methodology, (ii) a microstructure type different from at least one other microstructure type generated respectively by the at least one other methodology, or (iii) any combination of (i) and (ii).

3. The apparatus of claim 1, wherein the at least two portions stitched by the stitch coupling are horizontally disconnected from each other by a gap.

4. The apparatus of claim 1, wherein the at least two portions stitched by the stitch coupling comprise melt pool deformations cured by the stitch coupling.

5. The apparatus of claim 4, wherein the melt pool deformations comprise a non-requested melt pool that is an enlarged melt pool.

6. The apparatus of claim 1, wherein the stitch coupling comprises reducing a porosity level in the at least two portions.

7. The apparatus of claim 1, wherein the path propagates along a direction, the path having two sides that alternatingly contact each of the at least two portions, and wherein each side of the path is disposed on a different portion of the at least two portions, the side of the path being normal to the direction of propagation of the path.

8. The apparatus of claim 1, wherein the path comprises a zigzag path or a sinusoidal path.

9. A method of 3D printing of a 3D object, the method comprising:
providing a transforming agent and at least one controller operatively coupled with the transforming agent; and
directing, via the at least one controller, the transforming agent to execute stitch coupling to couple at least two portions of the 3D object to one another, the stitch coupling being a 3D printing methodology, the at least one controller directing the transforming agent to propagate along a path to transform a first material to a second material, the path alternatingly contacting each of the at least two portions, the first material comprising (a) a starting material for the 3D printing or (b) sections of the at least two portions of a 3D object, the at least two portions being printed during the 3D printing by a methodology different from the stitch coupling.

10. The method of claim 9, wherein the at least two portions stitched by the stitch coupling are horizontally disconnected from each other by a gap.

11. The method of claim 9, wherein the at least two portions stitched by the stitch coupling comprise melt pool deformations cured by the stitch coupling.

12. The method of claim 11, wherein the melt pool deformations comprise a non-requested melt pool that is an enlarged melt pool.

13. The method of claim 9, wherein the stitch coupling comprises reducing a porosity level in the at least two portions.

14. The method of claim 9, wherein the path propagates along a direction, the path having two sides that alternatingly contact each of the at least two portions, and wherein each side of the path is disposed on a different portion of the at least two portions, the side of the path being normal to the direction of propagation of the path.

15. A system for 3D printing of a 3D object, the system comprising:
a transforming agent; and
at least one controller operatively coupled to the transforming agent, the at least one controller configured to direct the transforming agent to execute stitch coupling to couple at least two portions of the 3D object as part of the 3D printing, the stitch coupling being a 3D printing methodology, the at least one controller also configured to direct the transforming agent to propagate along a path to transform a first material to a second material, the path alternatingly contacting each of the at least two portions, the first material comprising (a) a starting material for the 3D printing or (b) sections of the portions of a 3D object, the portions being printed during the 3D printing by at least one other methodology different from the stitch coupling.

16. The system of claim 15, wherein the at least two portions stitched by the stitch coupling are horizontally disconnected from each other by a gap.

17. The system of claim 15, wherein the at least two portions stitched by the stitch coupling comprise melt pool deformations cured by the stitch coupling.

18. The system of claim 17, wherein the melt pool deformations comprise a non-requested melt pool that is an enlarged melt pool.

19. The system of claim 15, wherein the stitch coupling comprises reducing a porosity level in the at least two portions.

20. The system of claim 15, wherein the path propagates along a direction, the path having two sides that alternatingly contact each of the at least two portions, and wherein each side of the path is disposed on a different portion of the at least two portions, the side of the path being normal to the direction of propagation of the path.
